(19) United States
(12) Patent Application Publication
(10) Pub. No.: US 2026/0176423 A1
(43) Pub. Date: Jun. 25, 2026

(54) POLYSULFATE AND POLYSULFONATE POLYMERS

(71) Applicant: THE SCRIPPS RESEARCH INSTITUTE, La Jolla, CA (US)

(72) Inventors: K. Barry SHARPLESS, La Jolla, CA (US); Peng WU, San Diego, CA (US); Hongbo ZHENG, San Diego, CA (US)

(73) Assignee: THE SCRIPPS RESEARCH INSTITUTE, La Jolla, CA (US)

(21) Appl. No.: 19/124,663

(22) PCT Filed: Oct. 27, 2023
(86) PCT No.: PCT/US2023/036154

§ 371 Date: Apr. 25, 2025

Related U.S. Application Data
(60) Provisional application No. 63/420,383, filed on Oct. 28, 2022.

(51) Int. Cl. C08G 75/24

(52) U.S. Cl. CPC C08G 75/24

(57) ABSTRACT

Polymers of Formula (1), as described herein: [—O-A₁-Z(R₁)(R²)-A¹-O—S(O)₂—X₁-A²-X₁—S(O)₂—]ₙ, such as aromatic polysulfates of Formula (2): [—O-A₁-Z(R₁)(R²)-A₁-O—S(O)₂—O-A²-Z(R³)(R⁴)-A²-O—S(O)₂—]ₙ, and polysulfonates of Formula (3): [—O-A₁-Z(R₁)(R²)-A₁-O—S(O)₂-A₂-Z(R³)(R⁴)-A₂-S(O)₂—]ₙ (3), are useful, e.g., as dielectric materials in electrostatic energy storage devices such as polymer film capacitors, under harsh electrification conditions, e.g., high electric field and elevated temperatures, and in other applications where relatively high glass transition temperature polymers may be useful.

### CROSS-REFERENCE TO RELATED APPLICATIONS

This application claims the benefit of U.S. Provisional Application No. 63/420,383 filed on Oct. 28, 2022, which is incorporated herein by reference in its entirety.

### STATEMENT OF GOVERNMENT LICENSE RIGHTS

This invention was made with government support from the National Institutes of Health, Grant No. R35GM139643, and the National Science Foundation, Grant No. CHE-1610987. The government has certain rights in this invention.

### FIELD OF INVENTION

This invention relates to polymers and to polymeric films.

### BACKGROUND

Condensation polymers are utilized in a variety of products and industries, including, for example, packaging, high performance engineering materials, medical prostheses and implants, optics, electronic components, batteries, and consumer plastic goods. There is an ongoing need for new polymeric materials, particularly thermoplastic polymers, including materials for high value, specialty applications (e.g., electronic components, engineering materials, or optics).

One area of particular need are dielectric polymers for use in film capacitors and like devices, particularly at high temperatures. While polymer-based dielectrics exhibit intrinsic characteristics of lightweight, greater processability, flexibility, and voltage tolerance capability compared to inorganic dielectric ceramics, achieving simultaneous electrical and thermal endurance has been a yet-to-be-solved bottleneck for their industrial applications in electric vehicles (EVs), avionics, space, underground oil and gas explorations, and certain military applications. For high capacity electrostatic energy storage, polymer dielectrics with suitable dielectric constant, k (e.g., k of at least 3), and high dielectric breakdown strength (E_{b}) are desired, as the stored energy density of a linear dielectric material is proportional to the k and the square of E_{b}.

In addition to energy density, charge-discharge efficiency (η) is another important performance factor for practical electrostatic energy storage. At elevated temperatures, both E_{b} and η are adversely impacted and may drop precipitously. Such temperature-limited performance dependence is exemplified by the electrostatic film capacitors used in power inverters of hybrid EVs. The benchmark dielectric polymer, biaxially oriented polypropylene (BOPP), which has a reported dielectric constant of about 2.2, reportedly is limited to operating temperatures below 105° C.

In evaluating polymers for dielectric applications optical bandgap (E_{g}) is another useful tool. The bandgap of a material refers to the energy difference between its valence band (where electrons normally reside) and its conduction band (where electrons are free to move and conduct electricity). A wide bandgap implies a larger energy barrier between the valence and conduction bands. Electrons require a certain amount of energy to move from the valence band to the conduction band and participate in electrical conduction. For dielectric polymer materials, the higher the E_{g}, the better. This is because wide bandgap polymers generally exhibit higher electrical insulating strength compared to polymers with narrower bandgaps. In wide bandgap polymers, this energy barrier is higher, making it more difficult for electrons to gain the necessary energy and move freely. In addition, wide bandgap polymers can withstand higher electric fields before reaching this breakdown voltage. The ability to withstand higher voltages is very important for electrical insulating materials, as they must prevent unintended electrical conduction. For most electrically insulating polymers (dielectrics), their optical bandgap is inversely proportional to their glass transition temperature T_{g}. For dielectric polymers with T_{g} of about 150° C., an E_{g}>4.5 eV is desirable, T_{g} of about 200° C., an E_{g}>4 eV is desirable, and for polymers with a T_{g} of 250° C. or greater, an E_{g}>3.5 eV is desirable.

For its use in hybrid EVs, an accompanying cooling system is necessary to lower the working temperature from about 140° C. down to about 70° C. in order to deliver a reliable energy storage performance, which adds extra mass and volume that compromise the energy efficiency of hybrid EVs. Thus, there is a need for new polymers with useful dielectric properties, particularly polymers that will perform in capacitor applications at these relatively high operating temperatures.

The polymers described herein address these needs.

### SUMMARY

High capacity polymer dielectrics that operate with high efficiencies under harsh electrification conditions, i.e., high electric fields and elevated temperatures, are important components for advanced electronics and power systems. It is, however, fundamentally challenging to design polymer dielectrics that can reliably withstand demanding temperatures and electric fields, which necessitate the balance of key electronic, electrical and thermal parameters. As described herein, polysulfate- and polysulfonate-type polymers comprising pendant aryl groups, synthesized by the highly efficient sulfur(VI) fluoride exchange (SuFEx) click chemistry method, serve as high-performing dielectric polymers that overcome such bottlenecks. Free-standing thin films of these polysulfates exhibit superior insulating properties and dielectric stability at elevated temperatures. Electrostatic film capacitors comprising the polysulfate and polysulfonate polymers described herein produce free-standing films that display unexpectedly high breakdown strength and discharged energy density at 150° C. compared to state-of-the-art commercial and synthetic dielectric polymers and nanocomposites at such high temperatures.

Described herein are polymers represented by Formula (1):

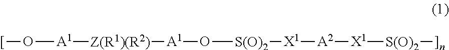

wherein:
A¹, A² and A³ independently are divalent aryl groups;
Z is C or Si (preferably C);
optionally, A² is A³-Z(R³)(R⁴)-A³;
optionally, both A₁ divalent aryl groups are bound together by a covalent bond, —CH₂—, —CH(R⁷)—, —C(R⁷)₂—, —O—, —S—, —SO₂—, —(C═O)—, —NH—, or —N(R⁷)—;
optionally, both A³ divalent aryl groups are bound together by a covalent bond, —CH₂—, —CH(R⁷)—, —C(R⁷)₂—, —O—, —S—, —SO₂—, —(C═O)—, —NH—, or —N(R⁷)—;
optionally, when Z is C, Z(R¹)(R²) and/or Z(R³)(R⁴) constitute an unsaturated moiety of formula:

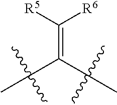

X¹ is O or a covalent bond (in some embodiments, X¹ preferably is O);
R¹ is selected from the group consisting of alkyl (e.g., alkyl comprising at least four carbons), aryl, arylalkyl, and alkylaryl; R² is selected from the group consisting of H, halogen, alkyl, aryl, arylalkyl, and alkylaryl; or R¹ and R² together constitute a first divalent substituent which together with Z constitutes a hydrocarbon ring or heterocyclic ring (preferably a 5 to 12 membered hydrocarbon or heterocyclic ring; e.g., a 5-, 6-, or 7-membered hydrocarbon or heterocyclic ring;
R³ is selected from the group consisting of alkyl (e.g., alkyl comprising at least four carbons), aryl, arylalkyl, and alkylaryl; R⁴ is selected from the group consisting of H, halogen, alkyl, aryl, arylalkyl, and alkylaryl; or R³ and R⁴ together constitute a second divalent substituent which together with Z constitutes a hydrocarbon or heterocyclic ring (preferably a 5 to 12 membered hydrocarbon or heterocyclic ring; e.g., a 5-, 6-, or 7-membered hydrocarbon or heterocyclic ring);
R⁵, R⁶ and R⁷ are selected from the group consisting of alkyl, aryl, arylalkyl, and alkylaryl;
n is the average number of repeating units within the brackets of the formula and has a value sufficient to provide a number average molecular weight (Mₙ) of at least about 7,000 g/mol; as determined by size exclusion chromatography (SEC) using styrene-divinyl benzene columns, DMF/0.2% LiBr elution solvent, and polystyrene molecular weight standards; and
each divalent aryl group and divalent substituent independently is unsubstituted or is substituted by one or more substituent selected from the group consisting of halogen (e.g., F, Cl, Br or I), alkyl, aryl, arylalkyl, alkylaryl, alkoxy, and aryloxy;
excluding homopolymers of formula:

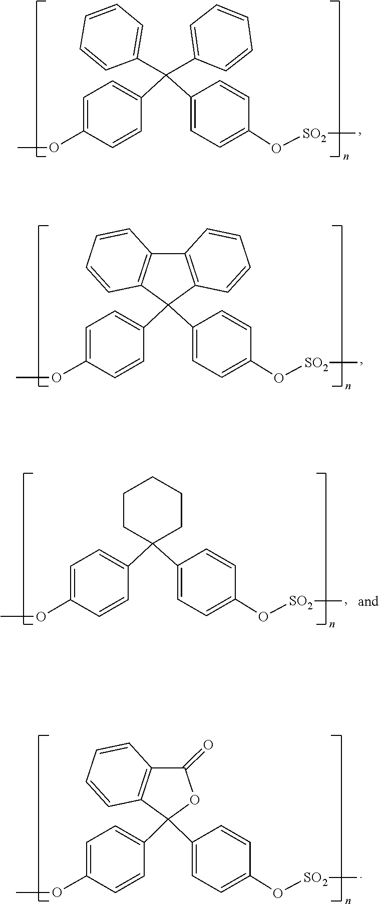

In some preferred embodiments, at least one of R¹ and R² is aryl.

In some other preferred embodiments, at least one of R³ and R⁴ is aryl.

In some embodiments, A¹-Z(R¹)(R²)-A₁ and A² are identical, in which case, the polymers of Formula (1), (2), or (3) are homopolymers. When A¹-Z(R¹)(R²)-A¹ and A² differ, the polymers of Formula (1), (2) and (3) are AB-alternating copolymers.

Preferably, the polydispersity index (PDI) of the polymer of Formula (1) is less than about 2.5, more preferably about 2.2 or less (e.g., 2 or less; or 1.8 or less). Preferably, the polymer of Formula (1) has a T_{g} of >150° C., and an optical bandgap (E_{g}) of about 3.5 to about 4.5.

In some preferred embodiments of the polymer of Formula (1), R¹ and R² together constitute a first divalent substituent that comprises at least one aromatic moiety (i.e., an aromatic hydrocarbon or aromatic heterocycle moiety) directly bonded to Z; the first divalent substituent and Z together constitute a 5-, 6-, or 7-membered hydrocarbon ring with at least one aromatic moiety fused to the ring (such as hydrocarbon divalent substituents shown in Scheme 2), or the first divalent substituent and Z together constitute a 5-, 6-, or 7-membered heterocyclic ring with an aromatic moiety fused to the ring (such as heterocyclic divalent substituents shown in Scheme 2). In some preferred embodiments, A² is A³-Z(R³)(R⁴)-A³, and R³ and R⁴ together constitute a second divalent substituent that comprises at least one aromatic moiety directly bonded to Z; the second divalent substituent and Z together constitute a 5-, 6-, or 7-membered hydrocarbon ring with at least one aromatic moiety fused to the ring (e.g., as shown in Scheme 2), or the first divalent substituent and Z together constitute a 5-, 6-, or 7-membered heterocyclic ring with an aromatic moiety fused to the ring (e.g., as shown in Scheme 2).

In some preferred embodiments, both A¹ divalent aryl groups are bound together by a covalent bond, —CH₂—, —CH(R⁷)—, —C(R⁷)₂—, —O—, —S, —SO₂—, —(C═O)—, —NH—, or —N(R⁷)—; and/or both A³ divalent aryl groups are bound together by a covalent bond, —CH₂—, —CH(R⁷)—, —C(R⁷)₂—, —O—, —S, —SO₂—, —(C═O)—, —NH—, or —N(R⁷)— see e.g., polymers ______, and monomers with a Y group shown in Scheme 10.

In some embodiments, A¹, A², and A³ are independently selected from the group consisting of divalent phenyl (—C₆H₄—), divalent naphthyl (—C₁₀H₆—), divalent anthracenyl (—C₁₄H₁₀—) divalent biphenyl (—C₆H₄—C₆H₄—), divalent binaphthyl (—C₁₀H₆—C₁₀H₆—), divalent heteroaryl (e.g., divalent bi(2-pyridyl)), and variants thereof that are substituted by one or mor alkyl, halogen, or alkoxy substituent.

Polymers of Formula (1) encompass a number of subgroups of polymers, including those represented by Formulas (2) and (3):
[—O-A¹-Z(R¹)(R²)-A¹-O—S(O)₂—O-A²-O—S(O)₂—]ₙ (2) (i.e., the polysulfate polymer of Formula (1) wherein X¹ is O); and
[—O-A¹-Z(R¹)(R²)-A¹-O—S(O)₂-A²-S(O)₂—]ₙ (3) (i.e., the polysulfonate polymer of Formula (1) wherein X¹ is a covalent bond);
wherein each A¹, A², R¹, R², R³, R⁴, R⁵, R⁶, R⁷, Z, n, optional limitations, and excluded polymers are as defined in Formula (1).

In some embodiments of the polymer of Formula (1) “n” has a value sufficient to provide a number average molecular weight (Mₙ) of at least about 10,000 g/mol (e.g., at least about 20,000 g/mol; at least about 30,000 g/mol; at least about 50,000 g/mol; at least about 60,000 g/mol; or at least about 70,000 g/mol; for example an Mₙ of about 7,000 g/mol to about 100,000 g/mol; about 15,000 g/mol to about 80,000 g/mol; about 20,000 g/mol to about 80,000 g/mol; or about 25,000 g/mol to about 80,000 g/mol).

In some embodiments of the polymers of Formula (1), the first divalent substituent and the second divalent substituent are independently selected from the divalent substituents shown in Scheme 1, described herein, below.

In some embodiments of the polymer of Formula (1), the hydrocarbon rings or heterocyclic rings are a cyclic group selected from the group consisting of an anthrone group, a 2,3-benzofluorene group, a chroman group, a 2-coumarone group, a 4,5-diazafluorene group, a dibenzosuberane group, a dibenzosuberene group, a 9,10-dihydroanthracene group, a 2,7-dihydro-3,4-benzofuran group, a 9,10-dihydro-9,10-difluoroanthracene group, a 2,3-dihydrobenzofuran group, a 9,10-dihydrophenanthrene group, a fluorene group, an indan group, an indene group, a 3-isochromanone group, a phthalide group, a thioxanthene group, and a xanthene group.

In some embodiments, the polymers of Formula (1) and (2) can be prepared by polymerization of a bis-silylated monomer selected from the bis-silylated monomers shown in Scheme 6, Scheme 9, and Scheme 10 (described herein, below) with a bis-fluorosulfate monomer selected from the bis-fluorosulfate monomers shown in Scheme 7, Scheme 9, and Scheme 10 (described herein, below) in the presence of a catalyst selected from an amidine, a guanidine, a phosphazene, a nitrogen-heterocyclic (N-heterocyclic) carbene, a tertiary alkoxide, a fluoride salt, a bifluoride salt, and an HF-fluoride salt of formula (R⁺)(F(HF)_{w}⁻), wherein R⁺ is an organic cation or a chelated metal cation, and w is 1 or greater.

In some embodiments, the polymers of Formulas (1) and (3) can be prepared by polymerization of a bis-silylated monomer selected from the bis-silylated monomers shown in Scheme 6, Scheme 9, and Scheme 10 with a bis-fluorosulfonyl monomer selected from the monomers shown in Scheme 8 and Scheme 10 in the presence of a catalyst selected from an amidine, a guanidine, a phosphazene, a nitrogen-heterocyclic (N-heterocyclic) carbene, a tertiary alkoxide, a fluoride salt, a bifluoride salt, and an HF-fluoride salt of formula (R⁺)(F(HF)_{w}⁻), wherein R⁺ is an organic cation or a chelated metal cation, and w is 1 or greater.

In some embodiments, the polymers of Formula (1) are selected from the polymers shown in Table 1, described herein, below.

In some preferred embodiments the polymer has a glass transition temperature (T_{g}) in the range of about 120 to about 330° C. (e.g., about 170 to about 320° C., or about 190 to about 310° C.). In some preferred embodiments, the polymer has an optical bandgap, E_{g}, of about 3.5 to about 4.5.

Also described herein is a polymer film free from residual metal catalysts, which comprises a polymer Formula (1), as described above. In some embodiments, the polymer film has a thickness in the range of about 1 to about 15 μm.

The polymers of Formulas (1), (2), and (3) are thermoplastic materials with excellent thermal properties. Many of the polymers have a high T_{g} of at least about 130° C. (preferably at least about 190° C.), and decomposition temperature of greater than 250° C., preferably greater than about 300° C.) making them useful as packaging materials, structural materials, and the like. In addition, the polymers of Formulas (1), (2), and (3) have excellent dielectric properties, including high electric constant, k, of at least about 3, unexpectedly high discharge energy densities, and very low dielectric loss tangent values (tan δ of 0.05 and lower) even at high temperatures (e.g., 150° C.), high electric field strengths, and high electric frequency (e.g., 10⁵ Hz), which combined with the excellent thermal properties makes the polymers of Formula (1), (2) and (3) particularly useful as dielectric materials in film capacitors used at high operating temperatures.

### DETAILED DESCRIPTION

The terms “alkyl” and “aryl” refer to unsubstituted and substituted aliphatic and aromatic organic groups, respectively comprising an open valence on a carbon atom thereof. As used herein, the term “alkyl” encompasses cyclic and linear saturated organic groups which comprise carbon and hydrogen. Non-limiting examples of alkyl groups include, e.g., methyl, ethyl, propyl, butyl, isopropyl, cyclohexyl, and the like. As used herein, the term “aryl” encompasses organic groups which comprise an aromatic hydrocarbon or an aromatic heterocyclic ring (i.e., a heteroaromatic or “heteroaryl” group) comprising a 5 or 6-membered aromatic ring with one or more nitrogen, oxygen or sulfur heteroatoms in the aromatic ring. Non-limiting examples of hydrocarbon-type aryl groups include, e.g., phenyl, naphthyl, anthracenyl, pyrenyl, and the like. Non-limiting examples of heterocyclic aryl groups include, e.g., pyridyl, imidazolyl, oxazolyl, indolyl, carbazolyl, thiophenyl, furanyl, and the like.

The term “arylalkyl” refers to an alkyl group, as described above, bearing one or more aryl substituent. Non-limiting examples of arylalkyl groups include, e.g., phenylmethyl (i.e., benzyl), 1-phenylethyl, 2-phenylethyl, (4-pyridyl)methyl, 2-(2-furanyl)ethyl, and the like.

The term “alkylaryl” refers to an aryl group, as described above, bearing one or more alkyl substituent on an aryl portion thereof. Non-limiting examples of alkylaryl groups include, e.g., 4-methylphenyl (i.e., tolyl), 2-methylphenyl, 4-ethylphenyl, 4-methylnaphthyl, 2,3,6-trimethylphenyl, 4-methylpyridyl, 2-methylfuranyl, 2-ethylthiophenyl, 2-(t-butyl)-1,3-oxazolyl, 2-methyl-imidazolyl, 2,6-dimethylphenyl, and the like.

The terms “alkoxy” and “aryloxy” refer to unsubstituted or substituted alkyl and aryl groups, respectively, as described above, attached to oxygen, such as methoxy (CH₃O), trifluoromethoxy, ethoxy (CH₃CH₂O), phenoxy (C₆H₅O), 2-pyridyloxy, and the like.

The term “divalent” refers to a substituent, moiety or group with two open valences. For example, a divalent aliphatic substituent, moiety, or group includes, e.g., methylene (—CH₂—), ethylene (—CH₂CH₂—), and the like. Similarly, a divalent substituent, moiety, or group has two open aromatic valences, such as, e.g., a 1,4-phenylene group (i.e., having open valences at carbons 1 and 4), a 2,6-naphthylene (i.e., having open valences at carbons 2 and 6), and the like.

In the polymers described herein, any alkyl, aryl, arylalkyl, alkylaryl, alkoxy, and aryloxy group or portion of the polymer, including divalent portions) can be unsubstituted (i.e., comprise only carbon and hydrogen) or can be substituted by one or more halogen, alkoxy, or aryloxy substituent (such as e.g., an aromatic hydrocarbon group or an aromatic heterocyclic group) on a carbon atom thereof. In addition, the terms “alkyl”, “arylalkyl”, “alkylaryl”, or “alkoxy”, including divalent versions thereof, encompass such groups in which a tertiary aliphatic carbon atom has been replaced by a silicon atom, e.g., as in polymers PS6 and PS7 shown in Table 1 herein, below.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As described above, polymers described herein are useful in a number of applications, including electronics, packaging, structural polymers, optical polymers, and the like, and are represented by Formula (1):

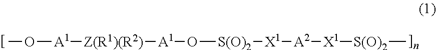

wherein:
A¹, A² and A³ independently are divalent aryl groups;
Z is C or Si (preferably C);
optionally, A² is A³-Z(R³)(R⁴)-A³;
optionally, both A¹ divalent aryl groups are bound together by a covalent bond, —CH₂—, —CH(R⁷)—, —C(R⁷)₂—, —O—, —S—, —SO₂—, —(C═O)—, —NH—, or —N(R⁷)—;
optionally, both A³ divalent aryl groups are bound together by a covalent bond, —CH₂—, —CH(R⁷)—, —C(R⁷)₂—, —O—, —S—, —SO₂—, —(C═O)—, —NH—, or —N(R⁷)—;
optionally, when Z is C, Z(R¹)(R²) and/or Z(R³)(R⁴) constitute an unsaturated moiety of formula:

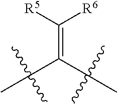

X¹ is O or a covalent bond (in some embodiments, X¹ preferably is O);
R¹ is selected from the group consisting of alkyl (e.g., alkyl comprising at least four carbons), aryl, arylalkyl, and alkylaryl; R² is selected from the group consisting of H, halogen, alkyl, aryl, arylalkyl, and alkylaryl; or R¹ and R² together constitute a first divalent substituent which together with Z constitutes a hydrocarbon ring or heterocyclic ring (preferably a 5 to 12 membered hydrocarbon or heterocyclic ring; e.g., a 5-, 6-, or 7-membered hydrocarbon or heterocyclic ring;
R³ is selected from the group consisting of alkyl (e.g., alkyl comprising at least four carbons), aryl, arylalkyl, and alkylaryl; R⁴ is selected from the group consisting of H, halogen, alkyl, aryl, arylalkyl, and alkylaryl; or R³ and R; together constitute a second divalent substituent which together with Z constitutes a hydrocarbon or heterocyclic ring (preferably a 5 to 12 membered hydrocarbon or heterocyclic ring; e.g., a 5-, 6-, or 7-membered hydrocarbon or heterocyclic ring);
R⁵, R⁶ and R⁷ are selected from the group consisting of alkyl, aryl, arylalkyl, and alkylaryl;
n is the average number of repeating units within the brackets of the formula and has a value sufficient to provide a number average molecular weight (Mₙ) of at least about 7,000 g/mol (Daltons); as determined by size exclusion chromatography (SEC) using styrene-divinyl benzene columns, DMF/0.2% LiBr elution solvent, and polystyrene molecular weight standards; and
each divalent aryl group and divalent substituent independently is unsubstituted or is substituted by one or more substituent selected from the group consisting of halogen (e.g., F, Cl, Br or I), alkyl, aryl, arylalkyl, alkylaryl, alkoxy, and aryloxy;
excluding homopolymers of formula:

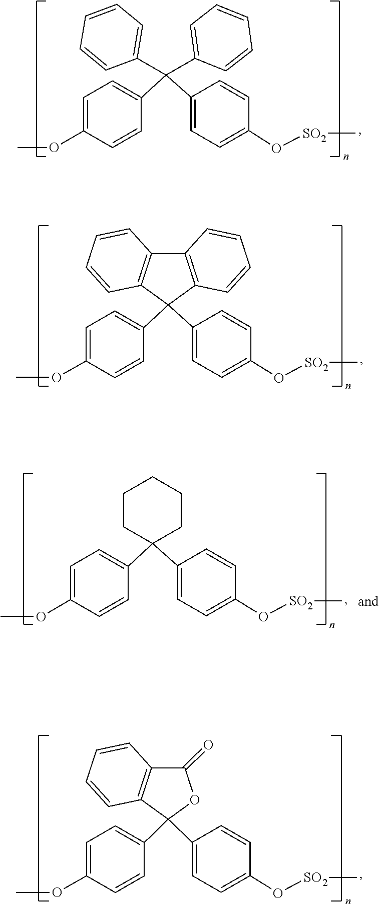

Preferably, the polydispersity index (PDI) of the polymer of Formula (1) is less than about 2.5, more preferably less than about 2.2 (e.g., 2 or less; or 1.8 or less).

In some preferred embodiments of Formula (1), Z is C.

In some preferred embodiments of Formula (1), both A¹ divalent aryl groups are bound together by a covalent bond, a methylene (—CH₂—), an alkyl-substituted methylene (i.e., —CH(alkyl)- or —C(alkyl)₂-), an aryl-substituted methylene (i.e., —CH(aryl)- or —C(aryl)₂-), —O—, —S, —NH, —N(alkyl)-; —N(aryl)-, —N(alkylaryl)-, or —N(arylalkyl)-; and/or both A³ divalent aryl groups are bound together by a covalent bond, a methylene (—CH₂—), an alkyl-substituted methylene (i.e., —CH(alkyl)- or —C(alkyl)₂-), an aryl-substituted methylene (i.e., —CH(aryl)- or —C(aryl)₂-), —O—, —S—, a carbonyl (—(C═O)—), —NH—, —N(alkyl)-; —N(aryl)-, —N(alkylaryl)-, or —N(arylalkyl)-.

In some embodiments or the polymer of Formula (1):
R¹ and R² together constitute a first divalent substituent that comprises at least one aromatic moiety directly bonded to Z; the first divalent substituent and Z together constitute a 5-, 6-, or 7-membered hydrocarbon ring bearing at least one aromatic moiety fused to the ring (e.g., as in Scheme 2), or the first divalent substituent and Z together constitute a 5-, 6-, or 7-membered heterocyclic ring bearing at least one aromatic moiety fused to the ring (e.g., as in Scheme 2); and/or
R³ and R⁴ together constitute a second divalent substituent that comprises at least one aromatic moiety directly bonded to Z; the second divalent substituent and Z together constitute a 5-, 6-, or 7-membered hydrocarbon ring bearing at least one aromatic moiety fused to the ring (e.g., as in Scheme 2), or the second divalent substituent and Z together constitute a 5-, 6-, or 7-membered heterocyclic ring bearing at least one aromatic moiety fused to the ring (e.g., as in Scheme 2).

Polymers of Formula (1) encompass subgroups of polymers represented by Formulas (2), and (3):

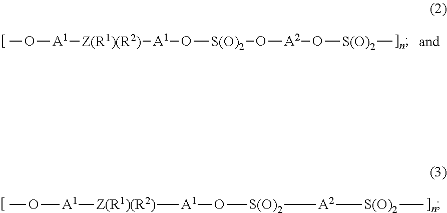

wherein each A¹, A¹, R¹, R², R³, R⁴, R₅, R⁶, R₇, Z, n, optional limitations, and excluded polymers are as defined in Formula (1).

Polymers of Formula (2) are aryl polysulfate polymers. Polymers of Formula (3) are aryl polysulfonate analogs of the polysulfate polymers.

Some non-limiting exemplary divalent aryl groups in Formula (1) include divalent phenyl (—C₆H₄—), divalent naphthyl (—C₁₀H₆—), divalent anthracenyl (—C₁₄H₁₀—), divalent biphenyl (—C₆H₄—C₆H₄—), divalent binaphthyl (—C₁₀H₆—C₁₀H₆—), and divalent heteroaryl groups such as divalent carbazole, divalent indole, divalent benzimidazole, divalent benzofuran, divalent benzothiophene, divalent benzoxazole, divalent benzothiazole, divalent pyridyl, divalent bi(2-pyridyl), and the like.

In some embodiments, A¹ and A² independently are selected from the group consisting of unsubstituted 1,4-phenylene (a divalent phenyl group) and 1,4-phenylene substituted by one or more substituent selected from the group consisting of alkyl (e.g., methyl, ethyl, isopropyl, and the like), aryl (e.g., phenyl, naphthyl, and the like), arylalkyl (e.g., benzyl, 2-phenylethyl, and the like), alkylaryl (e.g., methylphenyl, dimethylphenyl, methylnaphthyl, and the like), and halogen (e.g., F, Cl, Br, or I).

Scheme 1 provides some non-limiting examples of first and second divalent substituents useful in the polymers of Formula (1). Any of the divalent substituents described in Scheme 1 can optionally be substituted by one or more halogen (e.g., F, Cl, Br, and/or I), alkyl, aryl, arylalkyl, alkylaryl, alkoxy, and aryloxy as well as halogen-substituted alkyl, aryl, arylalkyl, alkylaryl alkoxy, and/or aryloxy.

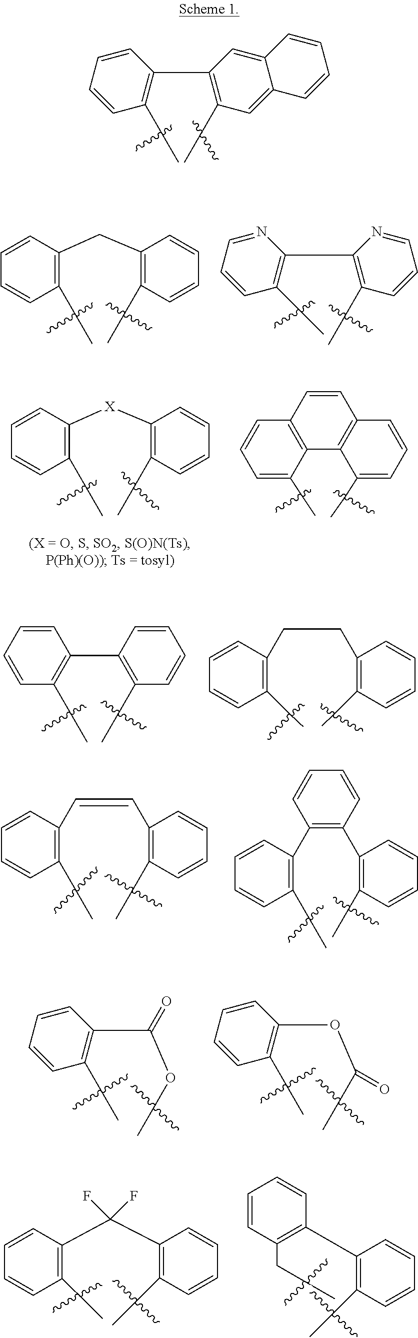

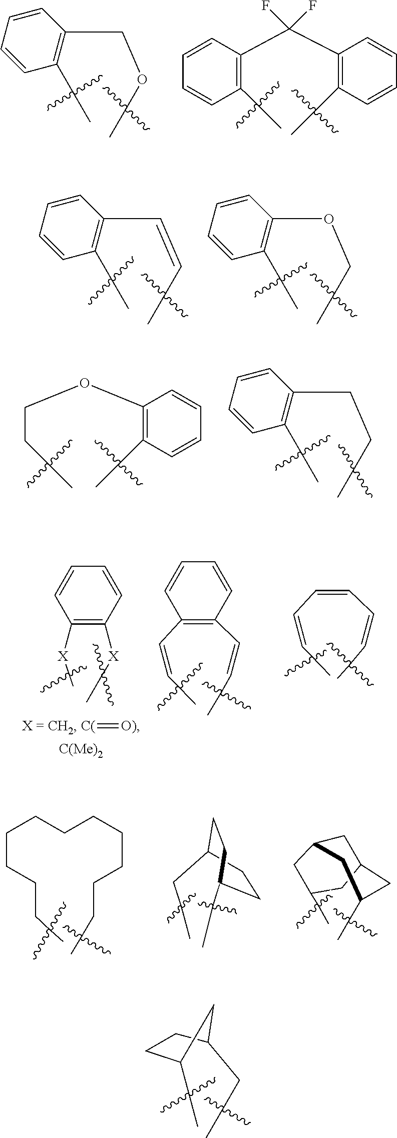

In some preferred embodiments of Formula (1), the first divalent substituent together with Z constitutes a 5-, 6-, or 7-membered hydrocarbon ring or heterocyclic ring selected from an anthrone group, a 2,3-benzofluorene group, a chroman group, a 2-coumarone group, a 4,5-diazafluorene group, a dibenzosuberane group, a dibenzosuberene group, a 9,10-dihydroanthracene group, a 2,7-dihydro-3,4-benzofuran group, a 9,10-dihydro-9,10-difluoroanthracene group, a 2,3-dihydrobenzofuran group, a 9,10-dihydrophenanthrene group, a fluorene group, an indan group, an indene group, a 3-isochromanone group, a phthalide group, a thioxanthene group, a xanthene group, and the like (see Scheme 2, which illustrates examples in which Z is C).

In some preferred embodiments of Formula (1), the second divalent substituent together with Z constitutes a 5-, 6-, or 7-membered hydrocarbon ring or heterocyclic ring selected from an anthrone group, a 2,3-benzofluorene group, a chroman group, a 2-coumarone group, a 4,5-diazafluorene group, a dibenzosuberane group, a dibenzosuberene group, a 9,10-dihydroanthracene group, a 2,7-dihydro-3,4-benzofuran group, a 9,10-dihydro-9,10-difluoroanthracene group, a 2,3-dihydrobenzofuran group, a 9,10-dihydrophenanthrene group, a fluorene group, an indan group, an indene group, a 3-isochromanone group, a phthalide group, a thioxanthene group, a xanthene group, and the like (see Scheme 2).

Any of the groups described in Scheme 2 can optionally be substituted by one or more halogen (e.g., F, Cl, Br, and/or I), alkyl, aryl, arylalkyl, alkylaryl, alkoxy, and aryloxy as well as halogen-substituted alkyl, aryl, arylalkyl, alkylaryl alkoxy, and/or aryloxy.

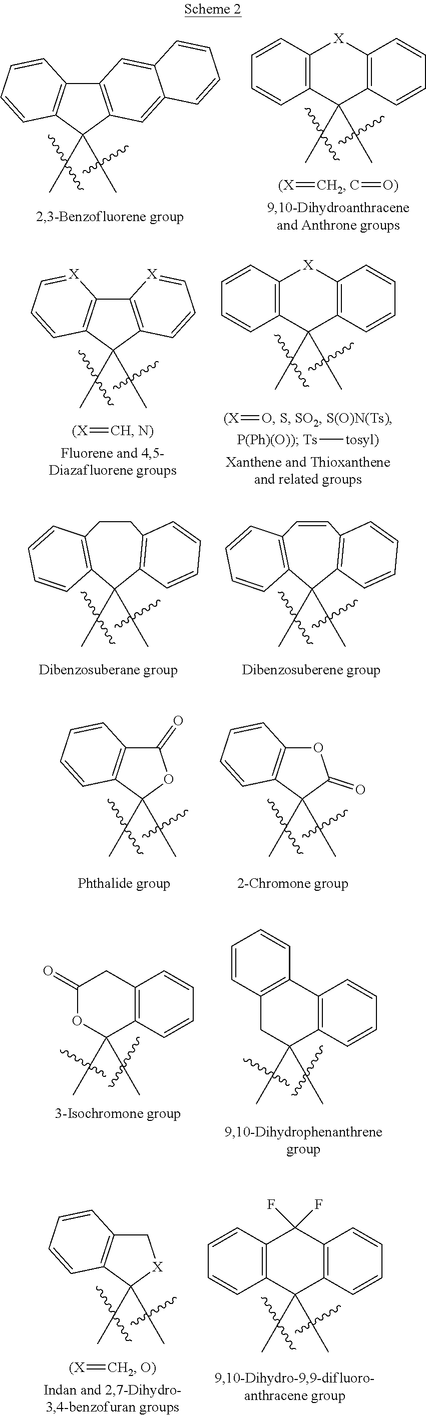

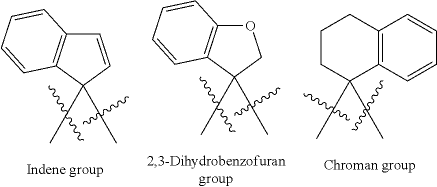 [SMILES: *C1(*)C=Cc2ccccc21 ; *C1(*)COc2ccccc21 ; *C1(*)CCCc2ccccc21]

Some exemplary polysulfate copolymers of Formula (1), in which X¹ is O, A² is A³-Z(R³)(R⁴)-A³ and in which A¹ and A³ both are divalent phenyl (1,4-phenylene) include polymers PS1, PS2, and PS3 shown in Scheme 3.

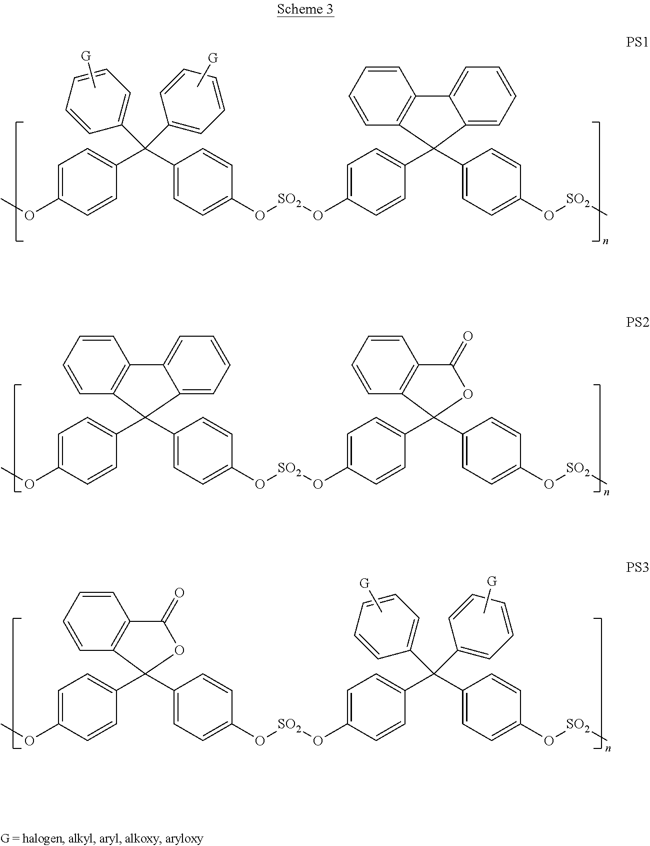

Polymers of Formula (1) in which X is O (i.e., polysulfates such as polymers of Formula (2) can be prepared by a SuFEx click chemistry method comprising adding a catalyst to a stirring solution comprising a bis-silylated monomer (e.g., a monomer of formula (R^{x})₃Si—O-A¹-Z(R¹)(R²)-A¹-O—Si(R^{x})₃) and a bis-fluorosulfate monomer (e.g., a monomer of formula FO₂S—O-A²-O—S(O)₂F), dissolved in a polar aprotic solvent; stirring the resulting mixture for a period of time sufficient to form the polymer; and isolating the polymer; wherein each R^{x} independently is an alkyl or aryl group; and the catalyst comprises at least one material selected from an amidine, a guanidine, a phosphazene, a nitrogen heterocyclic carbene, a tertiary alkoxide, a fluoride salt, and a salt of formula (R⁻)(F(HF)_{w}⁻), wherein R⁺ is an organic cation or a chelated metal cation, and w is 1 or greater.

An exemplary polysulfate polymer of Formula (2) is PS2, which can be made by the SuFEx procedure outlined in Scheme 4, below, in which R^{x} is alkyl or aryl.

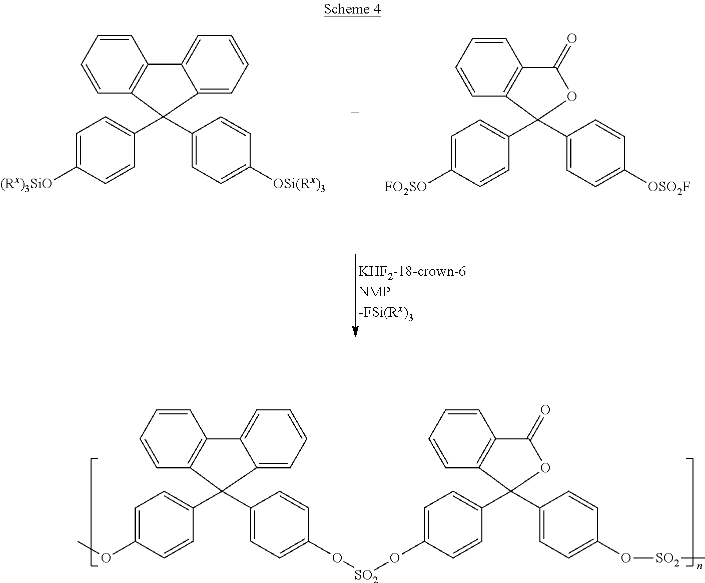

Polymers of Formula (1) in which X¹ is a covalent bond (i.e., polysulfonate polymers of Formula (3)) can be prepared by a SuFEx click chemistry method comprising adding a catalyst to a stirring solution comprising a bis-silylated monomer (e.g., a monomer of formula (R^{x})₃Si—O-A¹-Z(R¹)-A¹-O—Si(R^{x})₃) and a bis-fluorosulfonyl monomer (e.g., a monomer of formula F(O)₂S-A²-S(O)₂F) dissolved in a polar aprotic solvent; stirring the resulting mixture for a period of time sufficient to form the polymer, and isolating the polymer; wherein each R^{x} independently is an alkyl or aryl group and the catalyst comprises at least one material selected from an amidine, a guanidine, a phosphazene, a nitrogen heterocyclic carbene, a tertiary alkoxide, a fluoride salt, and a salt of formula (R⁻)(F(HF)_{w}⁻), wherein R⁺ is an organic cation or a chelated metal cation, and w is 1 or greater. An exemplary polysulfonate polymer of Formula (3) is PS4, which can be prepared aby the SuFEx procedure outlined in Scheme 5, below, in which R^{x} is alkyl or aryl.

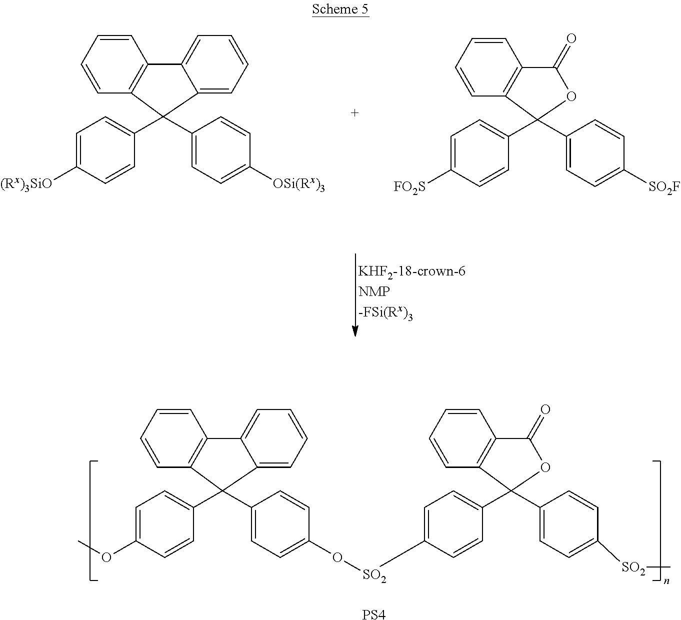

SuFEx methods for preparing polysulfate and polysulfonate polymers are described, e.g., in U.S. Pat. Nos. 9,447,243; 10,717,820; Dong, J., Krasnova, L., Finn, M. & Sharpless, K. B. Sulfur (VI) fluoride exchange (SuFEx): another good reaction for click chemistry. Angew. Chem. Int. Ed. 53, 9430-9448 (2014); and Gao, B. et al. Bifluoride-catalysed sulfur (VI) fluoride exchange reaction for the synthesis of polysulfates and polysulfonates. Nat. Chem. 9, 1083-1088 (2017), each of which is incorporated herein by reference.

In some embodiments, the catalyst for forming polymers of Formula (1), (2), and (3), comprises an amidine, a guanidine, a phosphazene, a nitrogen-heterocyclic (N-heterocyclic) carbene, a tertiary alkoxide, and a fluoride salt. For example, the basic catalyst can comprise an amidine base (e.g., 1,8-diazabicyclo[5.4.0]undec-7-ene (DBU), and the like), a guanidine (e.g., 1,1,3,3-tetramethylguanidine (TMG), 1,5,7-triazabicyclo[4.4.0]dec-5-ene (TBD), and 7-methyl-1,5,7-triazabicyclo-[4.4.0]dec-5-ene (MTBD), 2-tert-butyl 1,1,3,3-tetramethylguanidine (BTMG), and the like), a phosphazene base (e.g., 2-tert-butylimino-2-diethylamino-1,3-dimethylperhydro-1,3,2-diazaphosphorine (BEMP), 1-tert-butyl-4,4,4-tris-(dimethylamino)-2,2-bis[tris(dimethylamino)-phosphoranylidenamino]-2λ⁵,4λ⁵-catenadi(phosphazene) (P₄-t-Bu), and the like), a nitrogen-heterocyclic carbene (e.g., an imidazole-2-ylidene, a 1,2,4-triazole-5-ylidene, a thiazole-2-ylidene, an imidazolin-2-ylidene, and the like), a tertiary alkoxide (e.g., potassium tert-butoxide and the like), or a fluoride-containing salt (e.g., CsF, CsHF₂, KF, KHF₂, tetrabutylammonium fluoride (TBAF), tris(dimethylamino)sulfonium-difluorotrimethylsilicate (TASF), and the like), or a combination of two or more thereof.

In some embodiments, the catalyst for forming polymers of Formula (1), (2), and (3) comprises an HF-fluoride salt of formula (R⁺)(F(HF)_{w}⁻), wherein R₊ is an organic cation or a chelated metal cation as described herein above, and w is 1 or greater, as well as cationic polymers, including both insoluble and soluble polymers (e.g., cationic polystyrene beads with appended quaternary ammonium groups). Chelated metal cations preferably comprise a monovalent metal ion (e.g., an alkali metal such as potassium and the like, or a monovalent transition metal, etc.) complexed with a chelating ligand, preferably a neutral (non-charged) ligand such as a crown ether (e.g., 18-crown-6, 12-crown-4, 15-crown-5, dibenzo-18-crown-6, and the like) and/or an azacrown ether (e.g., diaza-18-crown-6, and the like).

Scheme 6, below, provides some non-limiting examples of bis-silylated type monomers, (Rx)₃Si—O-A¹-Z(R¹)(R²)-A¹-O—Si(Rx)₃/(Rx)₃Si—O-A²-O—Si(Rx)₃, useful in preparing the polysulfate and polysulfonate polymers of Formulas (1), (2), and (3). Scheme 7, below, provides some non-limiting examples of bis-fluorosulfate type monomers, F(O)₂S—O-A¹-Z(R¹)(R²)-A¹-O—S(O)₂F/F(O)₂S—O-A²-O—S(O)₂F, useful in preparing the polysulfate polymers of Formulas (1) and (2). Scheme 8, below, provides some non-limiting examples of bis-fluorosulfonyl monomers, F(O)₂S-A¹-Z(R¹)(R²)-A¹-S(O)₂F/F(O)₂S-A²-S(O)₂F useful in preparing the polysulfonate polymers of Formulas (1) and (3). The bis-silylated monomers can be readily obtained by silylation of the corresponding bisphenol with ClSi(R^{x})₃ in the presence of a base. Similarly, the bis-fluorosulfate monomers can be readily formed by reaction of the corresponding bisphenol with SO₂F₂; and bis-fluorosulfonyl monomers can be prepared by methods well known in the art.

Scheme 9 provides some additional bis-silylated bisphenol monomers and bis-fluorosulfate bisphenol monomers which are useful for preparing polymers of Formula (1) in combination with a second monomer.

Scheme 10 provides examples of bis-silylated, bis-fluorosulfonyl, and bis-fluorosulfate monomers useful for preparing the polymers described herein.

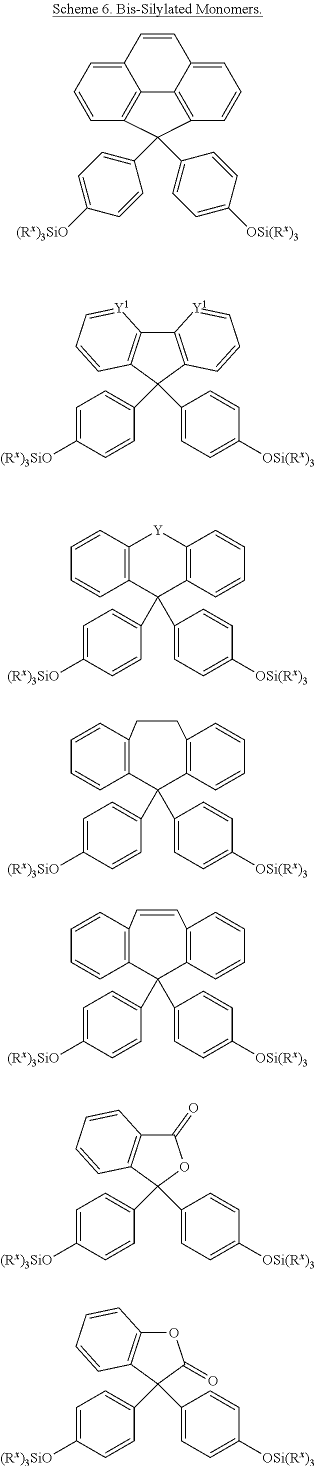

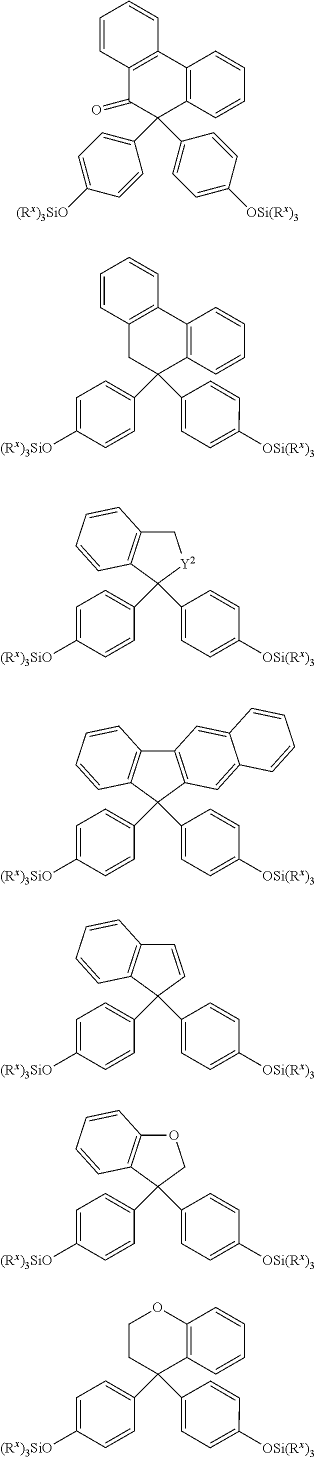

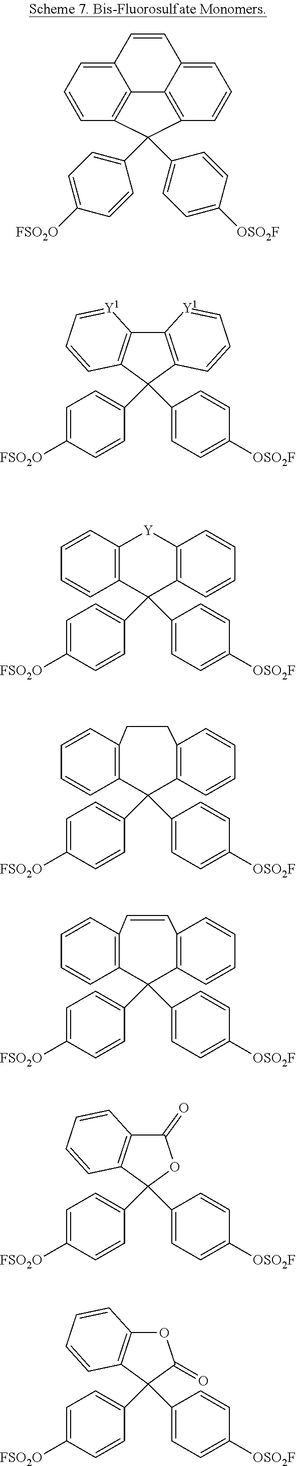

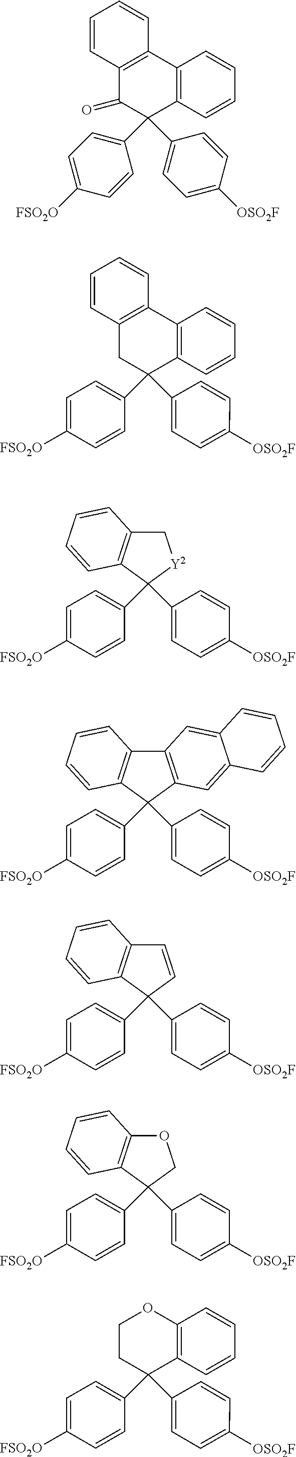

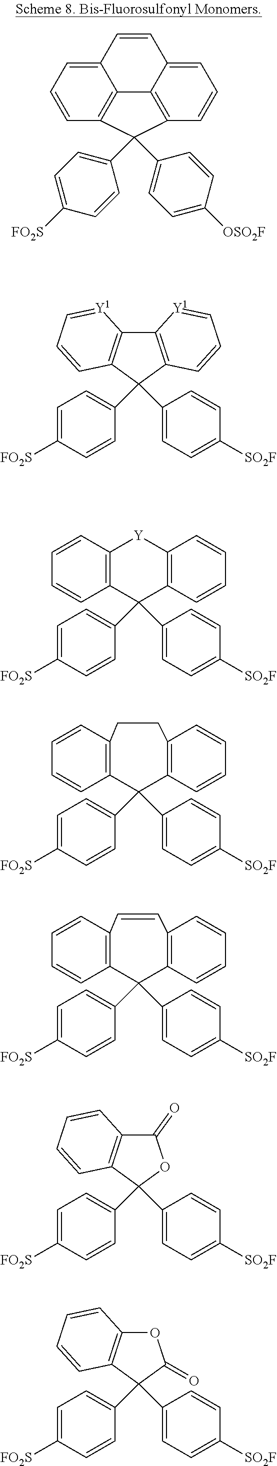

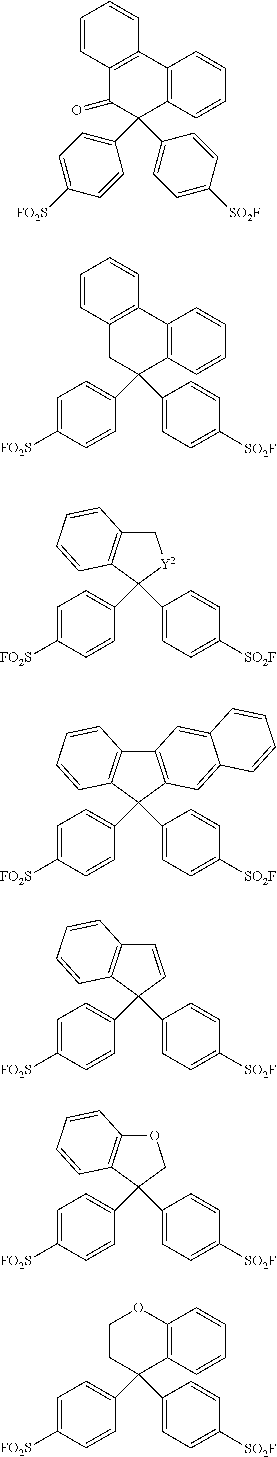

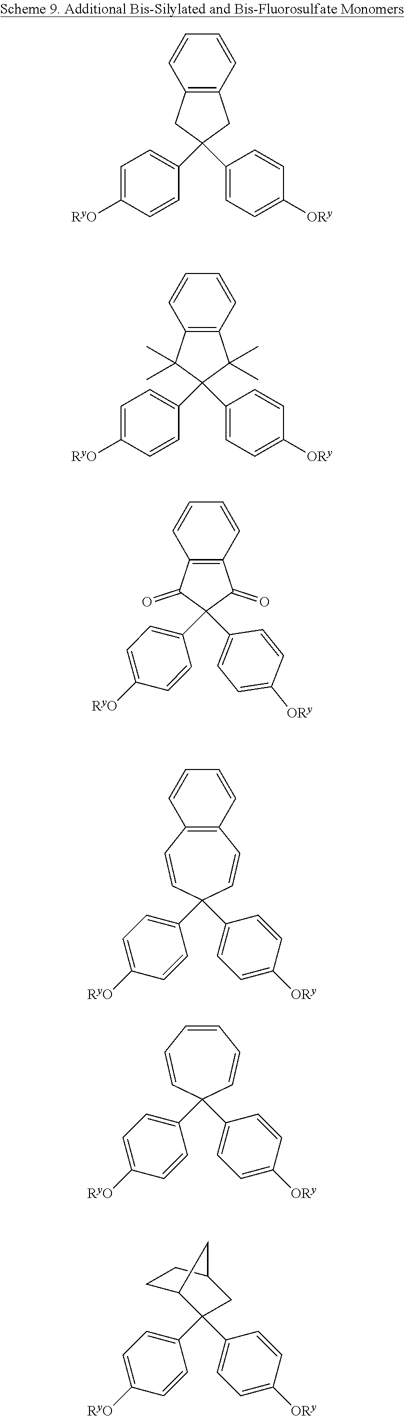

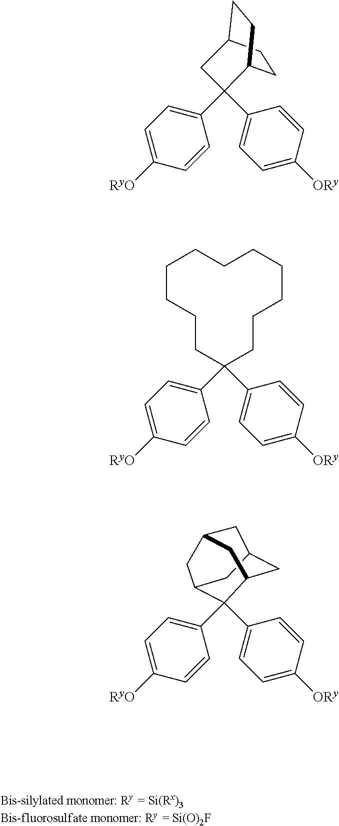

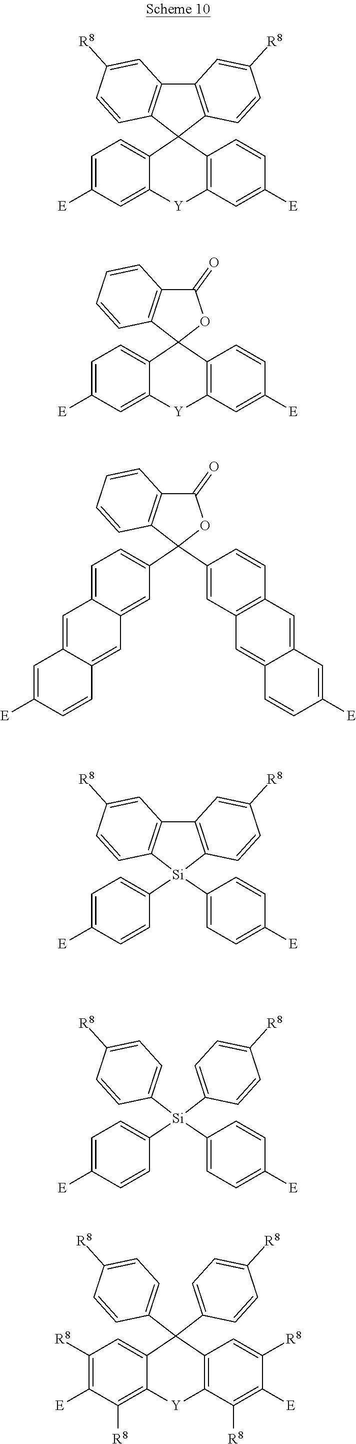

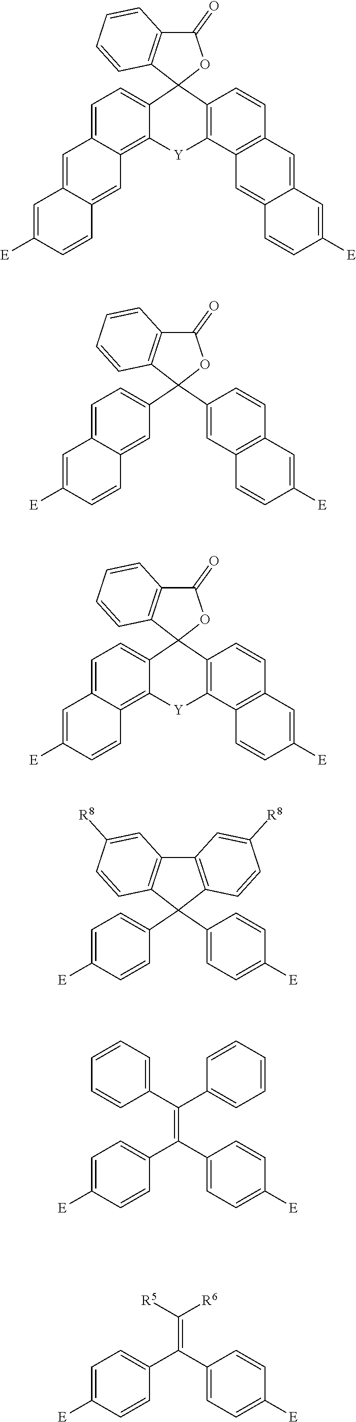

In Schemes 6, 7, and 8, Y is a covalent bond, —CH₂—, —CH(R⁷)—, —C(R⁷)₂—, —O—, —S—, —SO₂—, —(CO)—, —NH—, or —N(R⁷)—; Y¹ is CH or N, Y² is CH₂ or O, and R^{x} is alkyl or aryl;

In Scheme 9, R^{y} is trialkyl silyl (i.e., for bis-silyl monomers) or fluorosulfonyl (i.e., for bis-fluorosulfate monomers).

In Scheme 10, Y is a covalent bond, CH₂, CH(R⁷), C(R⁷)₂, CH(R⁷), C(R⁷)₂, O, S, SO₂, NH, or N(R⁷); each R⁸ independently is H, halogen (e.g., Br), alkyl, aryl, arylalkyl, or alkylaryl; and E is —OSi(R^{x})₃, —OSO₂F; or —SO₂F.

In some embodiments, the polysulfate polymers of polymer of Formula (1) are formed by SuFEx polymerization of a bis-silylated monomer selected from the bis-silylated monomers shown in Scheme 6, Scheme 9, and Scheme 10 with a bis-fluorosulfate monomer selected from the monomers shown in Scheme 7, Scheme 9, and Scheme 10, in the presence of a catalyst selected from an amidine, a guanidine, a phosphazene, a nitrogen-heterocyclic (N-heterocyclic) carbene, a tertiary alkoxide, a fluoride salt, a bifluoride salt, and an HF-fluoride salt of formula (R⁺)(F(HF)_{w}⁻), wherein R⁺ is an organic cation or a chelated metal cation, and w is 1 or greater.

In some other embodiments, the polysulfonate polymers Formula (1) are formed by SuFEx polymerization of a bis-silylated monomer selected from the bis-silylated monomers shown in Scheme 6, Scheme 9, Scheme 10 with a bis-fluorosulfonyl monomer selected from the monomers shown in Scheme 8 and Scheme 10 in the presence of a catalyst selected from an amidine, a guanidine, a phosphazene, a nitrogen-heterocyclic (N-heterocyclic) carbene, a tertiary alkoxide, a fluoride salt, a bifluoride salt, and an HF-fluoride salt of formula (R⁺)(F(HF)_{w}⁻), wherein R⁺ is an organic cation or a chelated metal cation, and w is 1 or greater.

Non-limiting examples of divalent aryl groups (A¹ and A²) include divalent phenyl (—C₆H₄—; e.g., 1,4-phenylene), divalent naphthyl (—C₁₀H₆—; e.g., 1,4-naphthylene, or 2,6 naphthylene), divalent anthracenyl (—C₁₄H₁₀—; e.g., 1,4-anthracenylene or 2,7-anthracenylene), a divalent biphenyl group (—C₆H₄—C₆H₄—), divalent binaphthyl (—C₁₀H₆—C₁₀H₆—), and divalent heteroaryl (e.g., divalent bi(2-pyridyl)), and the like.

In some preferred embodiments the polymer of Formula (1), (2) or (3) has a glass transition temperature (T_{g}) in the range of about 140 to about 330° C., e.g., a T_{g} in the range of about 190 to about 330° C. In some preferred embodiments, the polymer has a T_{g} greater than about 150° C. and E_{g} is about 3.5 to 4.5 eV.

Polymers of Formulas (1), (2) and (3) can form free standing films useful as dielectrics in polymer film capacitors. For example, films of the polymers can be formed by casting a solution of the polymer in a polar solvent onto a smooth surface. After evaporation of the solvent, the film can be peeled away from the surface to provide a thin free-standing film with good optical and dielectric properties. Preferably, the polymer films used in capacitors have a thickness in the range of about 1 to about 15 μm.

The co-presence of rigid aryl rings on the polymer backbone contributes to the high glass transition temperature (T_{g}) and high thermal decomposition temperatures of these polymers, which can withstand extreme operating conditions, such as those found in some high-temperature capacitor applications. The high polarizability of sulfate/sulfonate, and the inability of sulfur to pi-bond with carbon, nitrogen, or oxygen contribute to improved dielectric and thermal properties of the polysulfate and polysulfonate polymers. In addition, some polysulfonate polymers can form ordered structures with discernable helical repeats, which may also contribute to the dielectric and/or thermal properties of the polymers.

Moreover, in sharp contrast to conventional polymer composites in which the dielectric properties are mainly reliant on introduced high-dielectric-constant inorganic fillers, the polymers described herein perform unexpectedly well without such fillers. Compared to conventional polymer composites, in which defects can be easily found at the organic/inorganic interfaces, the molecular approach of introducing highly polarizable sulfate and sulfonate groups into backbone polymer chains effectively reduces physical interface defects, which are known to deteriorate dielectric properties, such as breakdown strength. The polysulfate and polysulfonate films show relatively high dielectric breakdown strength across a wide range of operation temperatures in capacitor applications.

From a utility perspective, the polymers of Formula (1) can be easily dissolved in polar solvents such as dimethylformamide (DMF), N, N-dimethylacetamide (DMAc) and N-methyl pyrrolidone (NMP), allowing for efficient cast film formation. In addition, the thermoplastic nature of the polymers described herein provides great opportunities for melt extrusion-processing by the most mainstream film capacitor manufacturing techniques in the industry. The presence of sulfate groups in the backbone not only improves the dielectric constant, but also introduces some conduction loss in the polymer films, particularly at higher temperatures, thereby reducing the charge-discharge efficiencies of the resulting film capacitors at high temperature.

### EXAMPLES

### Polymeric Film Preparation.

Polysulfate and polysulfonate polymers of Formula (1) are synthesized by SuFEx polymerization, such as a bifluoride-catalyzed SuFEx polycondensation (e.g., 2 mol % of KHF₂/1 mol % of 18-crown-6 catalysis in NMP at 130° C.), e.g., as described above. Polymer films are formed by dissolving polymer powders in NMP to yield a clear solution with a concentration of 20 mg mL⁻¹ under magnetic mechanical stirring overnight at temperatures of room temperature to 60° C. The obtained polymer/NMP solution is cast on clean glass slides at room temperature, and kept in an air-circulating oven at 65 to 95° C. for 12 hours (h) to evaporate the solvent. Afterward, the resultant polymer films are peeled off in deionized water and placed in a vacuum oven at 180° C. for 12 h to remove water and solvent residuals. The typical thickness of the free-standing polymer films is about 1 to about 15 μm, preferably about 2 to about 5 μm.

### Thermal Characterization

The differential scanning calorimetry (DSC) analysis is carried out on TA Q200 under nitrogen using aluminum pans with a heating rate of 10° C. min⁻¹. Thermal gravimetric analysis (TGA) is carried out on TGA-MS Q5000 (TA Instruments) under nitrogen using aluminum pans with a heating rate of 10° C. min⁻¹ from 25° C. to 600° C. All the polymer samples are treated in a vacuum oven at 105° C. for 30 min prior to DSC and TGA measurements.

### Structural Characterization.

The solution-based ¹H NMR spectra are recorded at room temperature to 100° C. on an AVANCE (2) 500 (Bruker, Germany) using the deuterated solvent dimethyl sulfoxide-d₆ (DMSO-d₆). As used herein, number average molecular weight Mₙ and polydispersity index (PDI) are determined via size exclusion chromatography (SEC) on a MALVERN OMNISEC equipped with refractive index detector, right-angle and low-angle light scattering detectors, and capillary viscometer. The polymer powder samples are dissolved in a pre-prepared solvent (DMF with 0.2% LiBr) with a concentration of 2 mg mL⁻¹, and filtered using 0.2 um NYLON filters. The measurements are performed in DMF at 1 mL min⁻¹ at 45° C. and on two VISCOTEK T6000M styrene-divinyl benzene columns in series.

Fourier transform infrared (FTIR) spectra are recorded in an attenuated total reflectance (ATR) mode equipped with a ZnSe crystal as a contact to the samples on a NICOLET IS50 FT-IR system (Thermo Fisher Scientific, USA). X-ray diffraction (XRD) patterns are recorded on a RIGAKU X-ray diffractometer using Cu-Kα radiation (λ=0.15418 nm) at 40 kV and 20 mA. X-ray photoelectron spectroscopy (XPS) and ultraviolet photoelectron spectroscopy (UPS) spectra are performed in a THERMO SCIENTIFIC K-ALPHAPLUS instrument equipped with monochromatic Al Kα radiation and 1486.7 eV source was used for XPS and 21.2 eV He(I) discharge source was used for UPS. The X-ray analysis area for measurement is set at 200×400 μm (ellipse shape) and a flood gun is used for charge compensation. The base pressure of the analysis chamber is less than about 1×10⁻⁹ mbar. The analysis chamber pressure is set at 1×10⁻⁷ mbar during data acquisition.

UV-vis absorption spectra of the polymer film samples are obtained on an AGILENT CARY 5000 UV-Vis-NIR spectrometer. The optical transmittance of the samples is measured in the wavelength range 200-700 nm. Atomic force microscopy (AFM) images are acquired with an ASYLUM RESEARCH CYPHER VES atomic force microscope in a nitrogen saturated atmosphere. In order to resolve the samples topography, AFM images are obtained using the Amplitude Modulation technique. Kelvin probe force microscopy (KPFM) images are acquired with an ASYLUM RESEARCH CYPHER VES atomic force microscope in a nitrogen saturated atmosphere.

Polymers PS1, PS2, PS3, PS4 are four non-limiting examples of the polymers of Formula (1) described herein. Table 1 provides additional non-limiting examples of the polymers of Formula (1) described herein, along with molecular weight information (Mn in kiloDaltons (kDa) and polydispersity index (PDI)) and optical bandgap (E_{g}) in eV, where available. The polymers have very good optical bandgap (E_{g}) properties for use in thin-film polymer capacitors, and glass transition temperatures (T_{g}) of greater than 100° C., many of greater than 200° C. or even higher. For the polymers with lower T_{g} increasing the molecular weight would likely increase the T_{g} significantly. High T_{g} is particularly useful for high temperature thin-film capacitor applications.

TABLE 1

| | | T_{g} | E_{g} |
|---|---|---|---|
| Polymer structure | Example | (° C.) | (eV) |
| 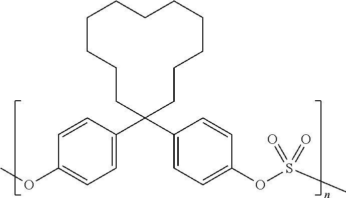 | PS5 | 172.2 | 4.44 |
| Mₙ = 19.2 kDa, PDI = 1.85 | | | |
| 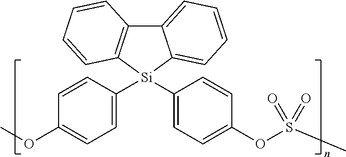 | PS6 | 176.4 | 3.68 |
| Mₙ = 7 kDa, PDI = 1.4 | | | |
| 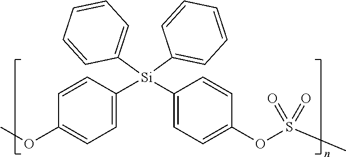 | PS7 | 113.1 | 4.42 |
| Mₙ = 7.2 kDa, PDI = 1.4 | | | |
| 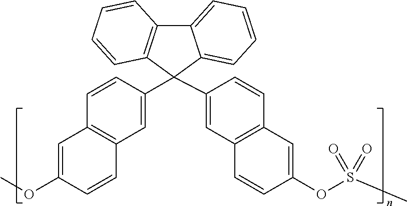 | PS8 | 298 | 3.71 |
| Mₙ = 21.1 kDa, PDI = 1.67 | | | |
| 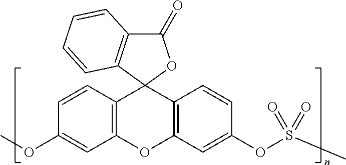 | PS9 | 238.9 | 4.1 |
| Mₙ = 15.2 kDa, PDI = 1.53 | | | |
| 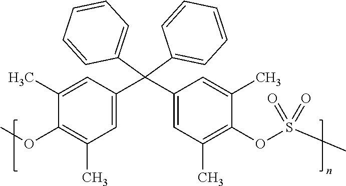 | PS10 | 102.5 | 4.3 |
| Mₙ = 14.1 kDa, PDI = 1.45 | | | |
| 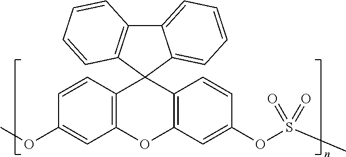 | PS11 | 241.6 | 3.9 |
| Mₙ = 22.8 kDa, PDI = 1.29 | | | |
| 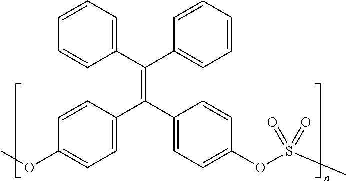 | PS12 | 153.2 | 3.27 |
| Mₙ = 22.3 kDa, PDI = 1.80 | | | |
| 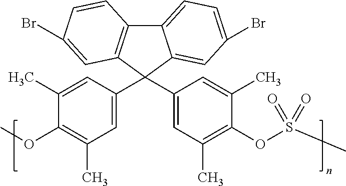 | PS13 | 176.6 | 3.77 |
| Mₙ = 9 kDa, PDI = 1.45 | | | |
| 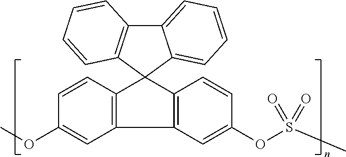 | PS14 | 253.2 | 3.7 |
| Mₙ = 19.2 kDa, PDI = 1.71 | | | |
| 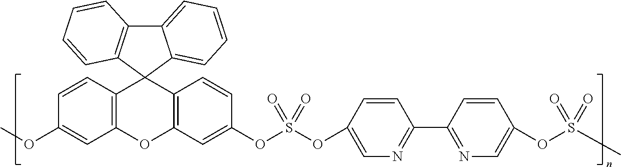 | PS15 | 191.3 | 3.73 |
| Mₙ = 15.7 kDa, PDI = 1.31 | | | |
| 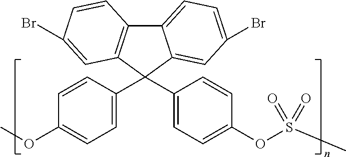 | PS16 | 256.9 | 3.76 |
| Mₙ = 20.4 kDa, PDI = 1.57 | | | |
| 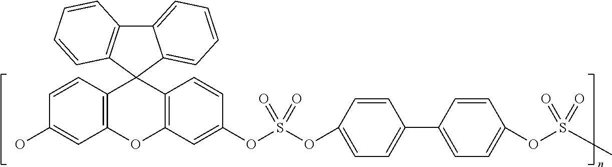 | PS17 | 191.3 | 3.91 |
| Mₙ = 42.9 kDa, PDI = 1.82 | | | |
| 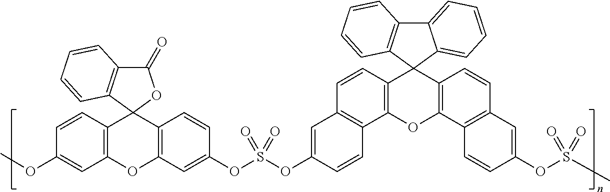 | PS18 | 301.9 | 3.59 |
| Mₙ = 24.3 kDa, PDI = 1.78 | | | |
| 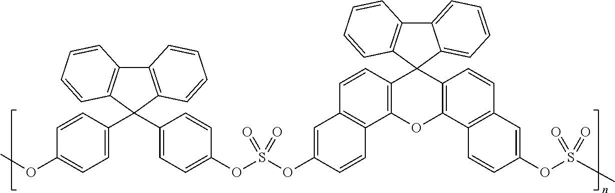 | PS19 | 271.6 | 3.58 |
| Mₙ = 11.6 kDa, PDI = 1.42 | | | |
| 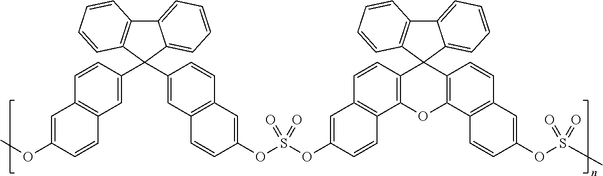 | PS20 | >310 | 3.57 |
| Mₙ = 41.3 kDa, PDI = 2.1 | | | |
| 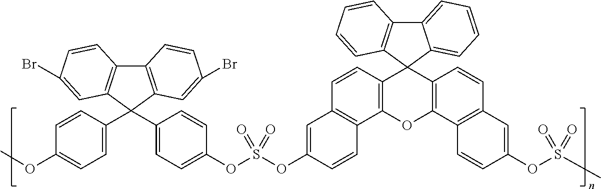 | PS21 | 299.9 | 3.58 |
| Mₙ = 67.5 kDa, PDI = 2.0 | | | |
| 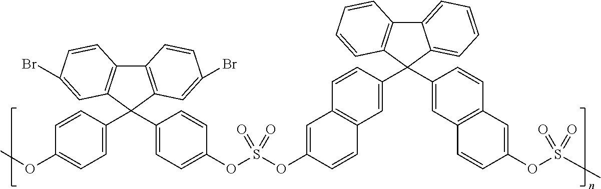 | PS22 | 266.8 | 3.8 |
| Mₙ = 23.6 kDa, PDI = 1.57 | | | |
| 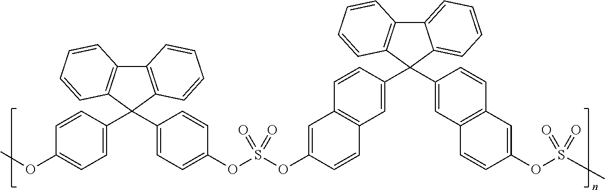 | PS23 | 253.8 | 3.94 |
| Mₙ = 22.4 kDa, PDI = 1.53 | | | |
| 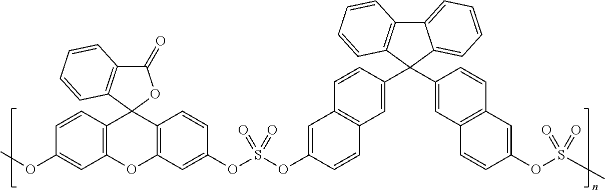 | PS24 | 258.3 | 3.73 |
| Mₙ = 10.9 kDa, PDI = 1.6 | | | |
| 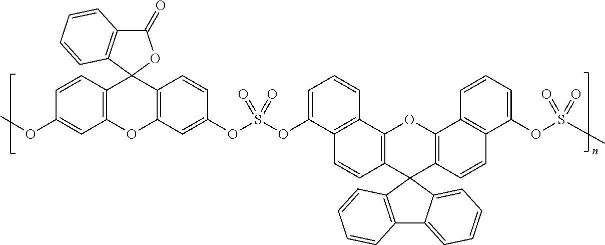 | PS25 | >300 | 3.58 |
| Mₙ = 12.7 kDa, PDI = 1.77 | | | |
| 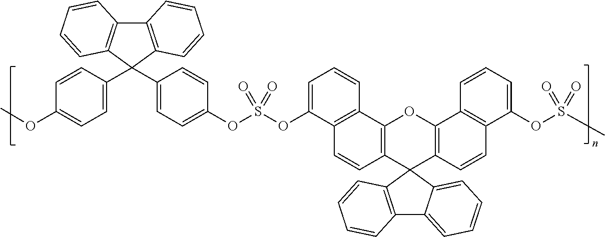 | PS26 | 280.2 | 3.58 |
| Mₙ = 12.7 kDa, PDI = 1.56 | | | |
| 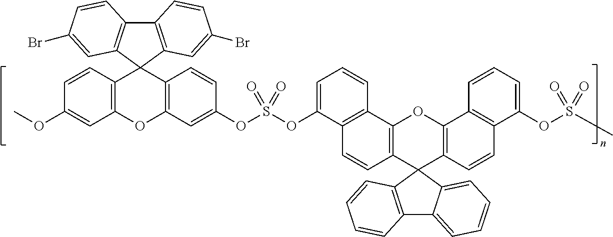 | PS27 | >300 | 3.57 |
| Mₙ = 15.7 kDa, PDI = 1.61 | | | |
| 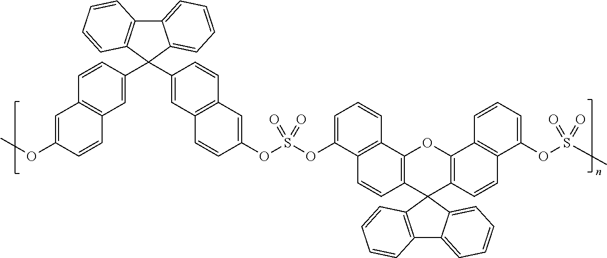 | PS28 | >310 | 3.57 |
| Mₙ = 22.2 kDa, PDI = 1.73 | | | |
| 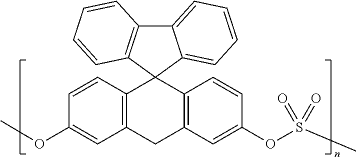 | PS29 | | |
| 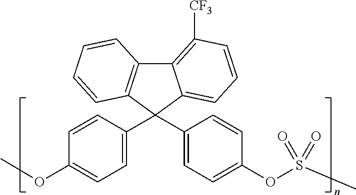 | PS30 | | |
| 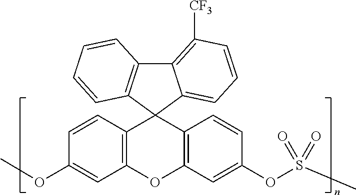 | PS31 | | |
| 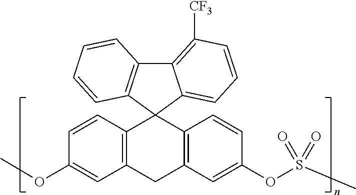 | PS32 | | |
| 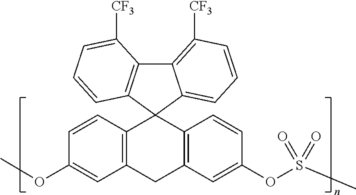 | PS33 | | |
| 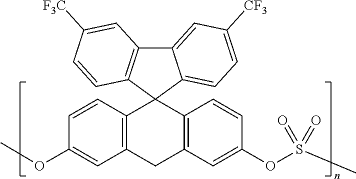 | PS34 | | |
| 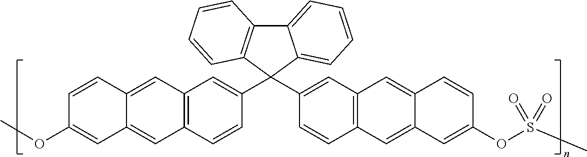 | PS35 | | |

### Preparation of the Polymers.

### Example PS5

### Preparation of ((cyclododecane-1,1-diylbis(4,1-phenylene))bis(oxy))bis(tert-butyldimethylsilane) (1)

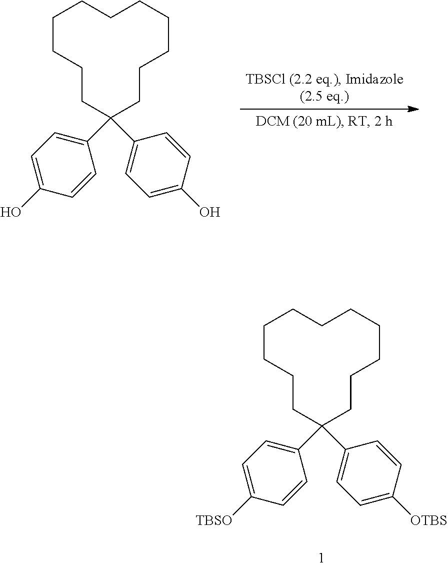 [SMILES: Oc1ccc(C2(c3ccc(O)cc3)CCCCCCCCCCC2)cc1 ; CC(C)(C)[Si](C)(C)Oc1ccc(C2(c3ccc(O[Si](C)(C)C(C)(C)C)cc3)CCCCCCCCCCC2)cc1]

A 100 mL round-bottomed flask was charged with a magnetic stir bar, 4,4′-(cyclododecane-1,1-diyl)diphenol (0.810 g, 2.3 mmol), imidazole (0.394 g, 5.8 mmol, 2.5 eq.) and 20 mL of di chloromethane (CH₂Cl₂). The solution was stirred at room temperature for 10 min and then TBSCl (0.759 g, 6.5 mmol, 2.2 eq) was added monitoring by TLC. After 2 hours, the reaction mixture was filtered, and the filtrate was concentrated under reduced pressure on a rotary evaporator. The resulting crude product was dissolved in 30 mL of ethyl acetate (EtOAc), which was subsequently washed with brine. The organic phase was dried over anhydrous MgSO₄. After filtration, the filtrate was subjected to evaporation to remove EtOAc. The product was purified by flash column chromatography over silica gel (hexanes/ethyl acetate=50/1) to afford Product 1 as white solid (1.2 g, 90% yield).

White solid. mp 107-109° C. Rf=0.78 (Hexane/EA=20:1). 1H NMR (400 MHz, CDCl3) δ 7.00 (d, J=8.7 Hz, 4H), 6.71 (d, J=8.6 Hz, 4H), 2.05-1.94 (m, 4H), 1.45-1.25 (m, 14H), 0.99-0.88 (m, 22H), 0.19 (s, 12H). 13C NMR (101 MHz, CDCl3) δ 153.10, 142.87, 128.61, 119.07, 47.31, 33.47, 26.70, 26.38, 25.83, 22.39, 22.17, 20.12, 18.30, −4.25.

### Preparation of cyclododecane-1,1-diylbis(4,1-phenylene) bis(sulfurofluoridate) (4)

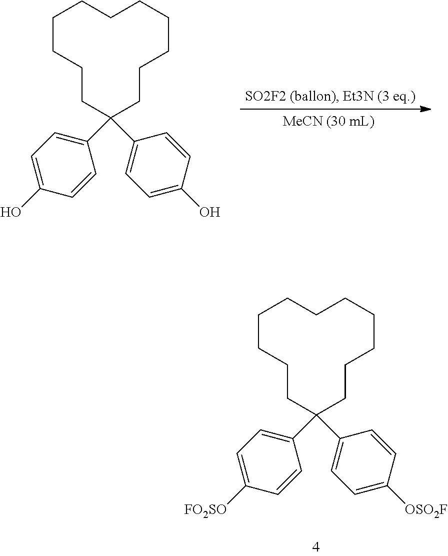

A 100 mL round-bottomed flask was charged with a magnetic stir bar, 4,4′-(cyclododecane-1,1-diyl)diphenol (1.056 g, 3 mmol), MeCN (30 mL) and Et₃N (0.909 g, 9 mmol, 3 eq.). The reaction flask was then sealed with a septum, the atmosphere above the solution was removed with gentle vacuum, and SO₂F₂ gas (sulfuryl fluoride, VIKANE) was introduced by needle from a balloon filled with the gas and monitored by TLC. The resulting mixture was stirred at room temperature until the full conversion of starting compound to the product. After completion, the solvent was removed by rotary evaporation, the residue was dissolved in EtOAc (50 mL), and the solution was washed with brine (3×100 mL). The organic phase was dried over anhydrous Na₂SO₄ and concentrated. The product was purified by flash column chromatography over silica gel (hexanes/ethyl acetate=20/1) to afford product 4 as white solid (1.45 g, 94% yield).

White solid. mp 110-112° C. Rf=0.60 (Hexane/EA=10:1). 1H NMR (400 MHz, CDCl3) δ 7.27-7.25 (m, 8H), 2.24-1.95 (m, 4H), 1.46-1.32 (m, 14H), 0.98-0.97 (m, 4H). 13C NMR (100 MHz, CDCl3) δ 149.72, 148.15, 129.65, 120.41, 48.62, 33.31, 26.37, 26.18, 22.24, 21.96, 20.00. 19F NMR (376 MHz, CDCl3) δ 34.86.

### Synthesis of the Polymer PS5:

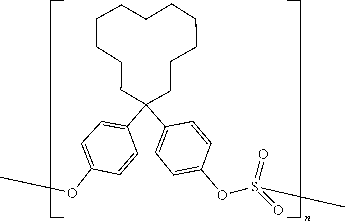

### Following the General Procedure:

White solid. mp 273-275° C. 1 H NMR (500 MHz, THF-d8) δ 7.67-7.65 (m, 4H), 5.72-5.70 (m, 4H), 1.67-1.68 (m, 22H). 13C NMR (134 MHz, THF-d8) δ 119.04, 97.22, 61.94, 59.55, 30.10, 15.27. Mₙ=19.2 kDa. PDI=1.8. Tg (DSC)=172.2° C. Eg (eV)=4.44.

### Example PS6

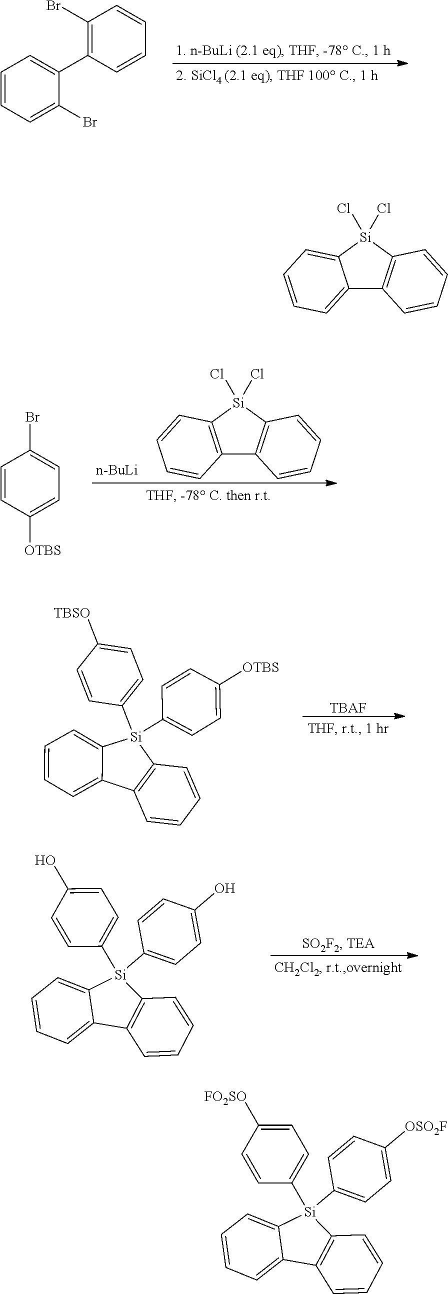

5,5-dichloro-5H-dibenzo[b,d]silole. This intermediate was prepared using the previously published method described in the publication van der Boon, L. J. P. et al. Dynamic Conformational Behavior in Stable Pentaorganosilicates. European Journal of Inorganic Chemistry. 2019, 3318-3328 (2019). 59% yield. The intermediate was used in the next step without further purification.

The following intermediates were prepared by using similar conditions described in the synthesis of PS7 monomer.

5,5-bis(4-((tert-butyldimethylsilyl)oxy)phenyl)-5H-dibenzo[b,d]silole. White solid, 64% yield. mp 64-66° C. ¹H NMR (600 MHz, Chloroform-d) δ 7.88 (d, J=7.8 Hz, 2H), 7.75 (d, J=7.1 Hz, 2H), 7.51-7.44 (m, 6H), 7.30 (t, J=7.2 Hz, 2H), 6.81 (d, J=9.9 Hz, 4H), 0.96 (d, J=1.3 Hz, 18H), 0.18 (d, J=1.2 Hz, 12H). ¹³C NMR (151 MHz, CDCl₃) δ 157.55, 148.61, 137.04, 136.81, 133.92, 130.51, 127.68, 124.27, 121.09, 119.96, 25.66, 18.19, −4.36.

4,4′-(5H-dibenzo[b,d]silole-5,5-diyl)diphenol. White solid, 90% yield. mp 67-68° C. ¹H NMR (400 MHz, DMSO-d₆) δ 9.70 (s, 2H), 8.00 (d, J=7.8 Hz, 2H), 7.79 (d, J=7.1 Hz, 2H), 7.50 (t, J=8.0 Hz, 2H), 7.39 (d, J=8.1 Hz, 4H), 7.33 (t, J=7.2 Hz, 2H), 6.78 (d, J=8.1 Hz, 4H). ¹³C NMR (151 MHz, DMSO) δ 159.79, 148.35, 137.03, 136.94, 134.24, 131.12, 128.32, 121.79, 121.47, 116.01.

(5H-dibenzo[b,d]silole-5,5-diyl)bis(4,1-phenylene) bis(sulfurofluoridate). White solid, 72% yield. mp 163-164° C. ¹H NMR (600 MHz, DMSO-d₆) δ 8.07 (d, J=7.9 Hz, 1H), 8.03 (d, J=6.7 Hz, 1H), 7.87 (d, J=8.7 Hz, 2H), 7.66 (d, J=8.5 Hz, 2H), 7.58 (t, J=7.6 Hz, 1H), 7.40 (t, J=7.6 Hz, 1H). ¹³C NMR (151 MHz, DMSO) δ 151.85, 148.65, 138.09, 134.78, 134.13, 133.80, 132.14, 128.85, 122.25, 121.61.

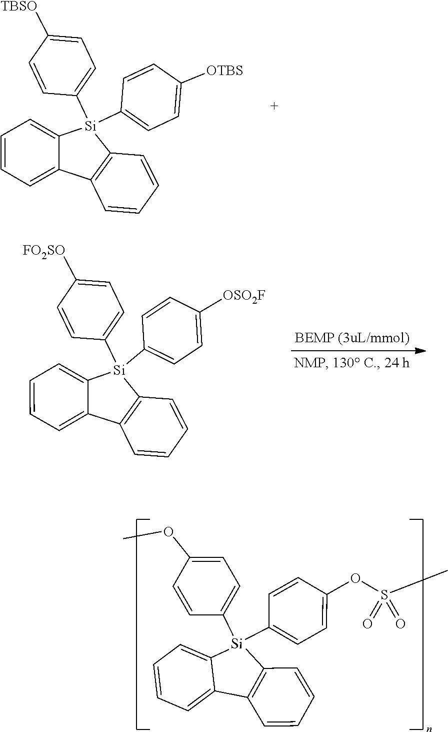

Polysulfate PS6 was prepared from the above monomers. Off white powder. mp 193-197° C. ¹H NMR (600 MHz, DMSO) δ 8.07-7.95 (m, 2H), 7.94-7.84 (m, 2H), 7.83-7.64 (m, 4H), 7.56-7.39 (m, 6H), 7.36-7.26 (m, 2H). ¹³C NMR (151 MHz, DMSO) δ 151.5, 148.1, 137.3, 134.1, 133.7, 132.2, 131.5, 128.2, 121.7, 121.0. Mₙ=7 kDa, PDI=1.4. T_{g}=176.4° C.

### Example PS7

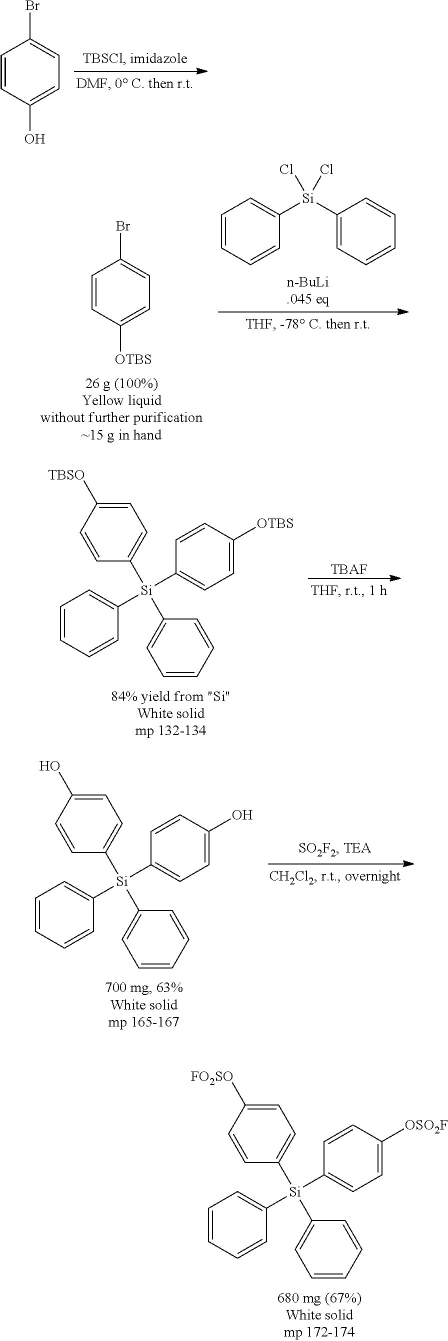

(4-bromophenoxy)(tert-butyl)dimethylsilane was prepared by using the identical method described in Journal of Medicinal Chemistry (1987), 30(5), 871-80. It was obtained as yellow liquid. ¹H NMR (400 MHz, DMSO-d₆) δ 7.41-7.33 (m, 2H), 6.83-6.68 (m, 2H), 0.90 (s, 9H), 0.14 (s, 6H).

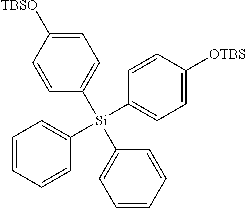 [SMILES: CC(C)(C)[Si](C)(C)Oc1ccc([Si](c2ccccc2)(c2ccccc2)c2ccc(O[Si](C)(C)C(C)(C)C)cc2)cc1]

### bis(4-((tert-butyldimethylsilyl)oxy)phenyl)diphenylsilane

To a solution of (4-bromophenoxy)(tert-butyl)dimethylsilane (11 g, 1 eq, 38 mmol) in THF (160 mL) was slowly added n-BuLi (1.6 M in hexane, 1 eq, 40 mmol) at −78° C. The reaction mixture was then stirred at 0° C. for 1 hour. After that time, it was cooled to −78° C. and a solution of dichlorodiphenylsilane (4.3 g, 0.45 eq, 17.1 mmol) in 5 mL of THF was added. The resulting mixture was stirred overnight monitoring by TLC and was hydrolyzed with 5% HCl until a yellow solution was obtained. The mixture was concentrated by rotary evaporation and the residue was dissolved in Et₂O. The crude mixture was washed with water and separated. The organic phase was collected by rotary evaporation, and purified by flash chromatography (0-3% EtOAc/Hexane) to yield the title product as a white solid (8.6 g, 84% yield) mp 132-134° C. ¹H NMR (400 MHz, Chloroform-d) δ 7.53 (d, J=7.0 Hz, 4H), 7.39 (d, J=7.4 Hz, 6H), 7.34 (t, J=7.1 Hz, 4H), 6.83 (d, J=8.3 Hz, 4H), 0.97 (s, 18H), 0.20 (s, 12H).

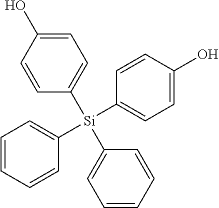 [SMILES: Oc1ccc([Si](c2ccccc2)(c2ccccc2)c2ccc(O)cc2)cc1]

### 4,4′-(diphenylsilanediyl)diphenol

At 0° C., a THF solution containing bis(4-((tert-butyldimethylsilyl)oxy)phenyl)diphenylsilane (1.8 g, 1 eq, 3 mmol) was slowly added dropwise to TBAF (1 M in THF, 2 eq, 6 mmol). The mixture was stirred at room temperature for 1 hour monitoring by TLC and was concentrated by rotary evaporation. The residue was purified by flash chromatography system (0-60% EtOAc/Hexane) to yield the product as a white solid (0.700 g, 63% yield). mp 165-167° C. ¹H NMR (400 MHz, DMSO) δ 9.69 (s, 2H), 7.49-7.33 (m, 10H), 7.26 (d, J=8.4 Hz, 4H), 6.83 (d, J=8.4 Hz, 4H).

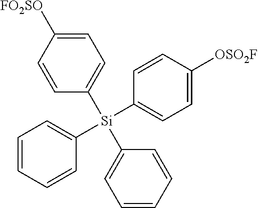

### (diphenylsilanediyl)bis(4,1-phenylene) bis(sulfurofluoridate) (General Procedure B)

4,4′-(diphenylsilanediyl)diphenol (0.700 g, 1 eq, 1.9 mmol) and triethylamine (0.8 mL, 3 eq, 6 mmol) were dissolved in in dichloromethane (20 mL). The reaction container was sealed, degassed, and SO₂F₂ gas (sulfuryl fluoride) was introduced by needle with a balloon filled with gas. The reaction was vigorously stirred overnight at room temperature monitoring by TLC. After completion, the reaction was quenched with the water. The organic layer was dried over MgSO₄ and concentrated. The resulting crude was filtered through a short pad of silica gel, and the desired product was concentrated by rotary evaporation to give a white solid (0.680 g, 67% yield). mp 172-174° C. ¹H NMR (600 MHz, DMSO) δ 7.70 (s, 8H), 7.55 (td, J=5.9, 3.0 Hz, 2H), 7.52-7.48 (m, 8H). ¹³C NMR (151 MHz, DMSO) δ 151.6, 138.9, 136.3, 135.3, 132.3, 130.9, 129.0, 121.5. ¹⁹F NMR (376 MHz, DMSO) δ 36.6 (s).

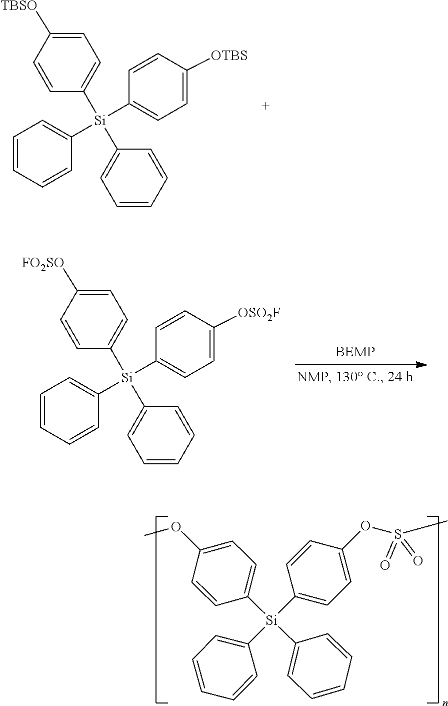

### Polysulfate PS7 (General Procedure)

To a dry 20 mL vial equipped with a stir bar, was added monomer (diphenylsilanediyl)bis(4,1-phenylene) bis(sulfurofluoridate) (0.160 g, 1 eq, 0.3 mmol), bis(4-((tert-butyldimethylsilyl)oxy)phenyl)diphenylsilane (0.180 g, 1 eq, 0.3 mmol), and NMP (0.3 mL). The container was sealed and degassed and refilled with N₂ and placed into a pre-heated 130° C. heating block. Catalyst (1 uL) was added via a microsyringe. The reaction was then allowed to stir for 7 hours at 130° C. Thereafter, another 2 mL of DMF was added to dissolve the polymer at this temperature. The resulting DMF solution was slowly injected into 50 mL of methanol under vigorous stirring. Polymers crashed out as white powder/strip in methanol. They were collected via filtration, re-dissolved in DMF, and the solid underwent precipitation once more. The final polymer product was dried at 70° C. for 3 hours in vacuo (2.0 torr). Molecular weight and polydispersity were determined on GPC. Yellow solid. mp 122-135° C. ¹H NMR (600 MHz, DMSO) δ 7.85-7.27 (m, 18H). ¹³C NMR (151 MHz, DMSO) δ 151.3, 138.1, 135.7, 133.5, 132.1, 130.3, 128.4, 120.9. Mn=7.2 kDa, PDI=1.4. T_{g}=113.1° C.

### Example PS8

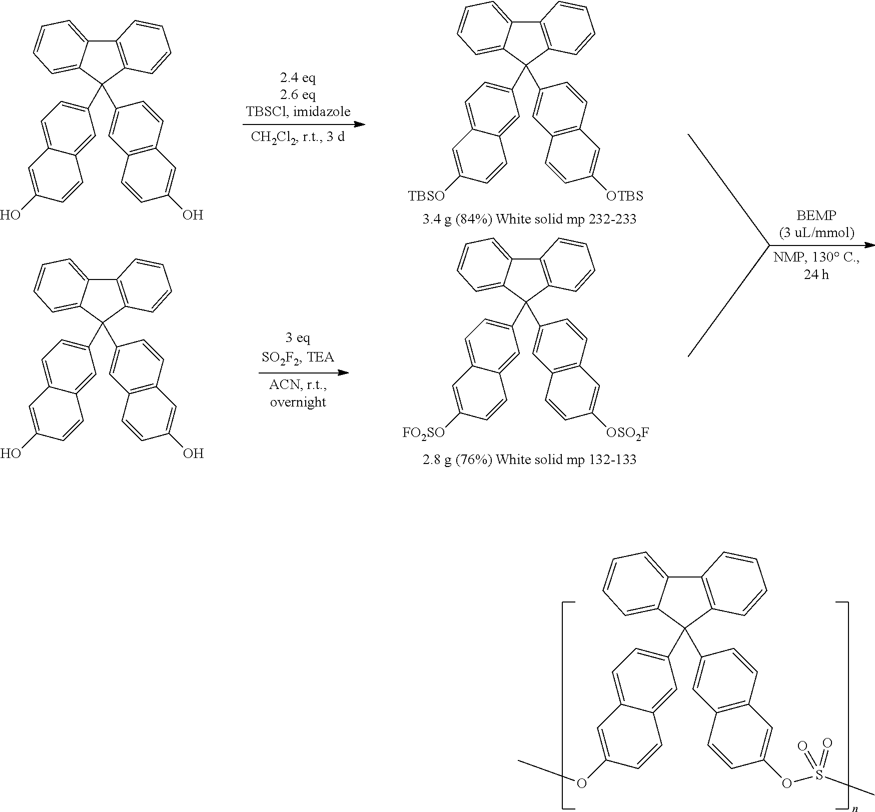

The monomers were prepared by using procedures:

(((9H-fluorene-9,9-diyl)bis(naphthalene-6,2-diyl))bis(oxy))bis(tert-butyldimethylsilane). White solid, 84% yield. mp 232-233° C. ¹H NMR (400 MHz, Chloroform-d)) δ 7.80 (d, J=7.5 Hz, 2H), 7.57 (d, J=8.7 Hz, 2H), 7.52-7.47 (m, 6H), 7.37 (ddd, J=7.5, 4.3, 1.6 Hz, 4H), 7.28 (dd, J=7.6, 1.2 Hz, 2H), 7.12 (d, J=2.4 Hz, 2H), 6.98 (dd, J=8.8, 2.4 Hz, 2H), 0.98 (s, 18H), 0.20 (s, 12H). ¹³C NMR (151 MHz, Chloroform-d) δ 153.54, 151.25, 141.00, 140.29, 133.50, 129.46, 128.98, 127.77, 127.56, 127.52, 126.85, 126.34, 125.90, 122.17, 120.31, 114.68, 65.43, 25.78, 18.32, −4.30.

### (9H-fluorene-9,9-diyl)bis(naphthalene-6,2-diyl) bis(sulfurofluoridate) (General Procedure A)

White solid, 76% yield. mp 132-133° C. ¹H NMR (400 MHz, Chloroform-d) δ 7.89-7.82 (m, 2H), 7.80 (d, J=8.7 Hz, 2H), 7.77-7.72 (m, 4H), 7.64 (d, J=1.9 Hz, 2H), 7.52 (dd, J=8.7, 1.9 Hz, 2H), 7.48-7.39 (m, 4H), 7.36 (dd, J=9.0, 2.5 Hz, 2H), 7.31 (td, J=7.5, 1.2 Hz, 2H). ¹³C NMR (151 MHz, Chloroform-d) δ 150.01, 147.66, 144.54, 140.34, 132.38, 132.29, 130.94, 128.72, 128.43, 128.19, 128.12, 126.13, 126.10, 120.68, 119.33, 118.52, 65.49. ¹⁹F NMR (376 MHz, Chloroform-d) δ 37.8 (s).

Polysulfate PS8 was prepared from corresponding monomers. White solid. mp>300° C. ¹H NMR (600 MHz, DMSO) δ 8.11-7.77 (m, 8H), 7.72-7.60 (m, 2H), 7.60-7.49 (m, 2H), 7.49-7.18 (m, 8H). ¹³C NMR (151 MHz, DMSO) δ 149.7, 147.5, 143.9, 139.7, 132.0, 131.5, 130.8, 128.4, 128.1, 126.1, 125.5, 120.8, 120.0, 118.2, 65.0. Mn=21.1 kDa, PDI=1.67. T_{g}=298° C.

### Example PS9

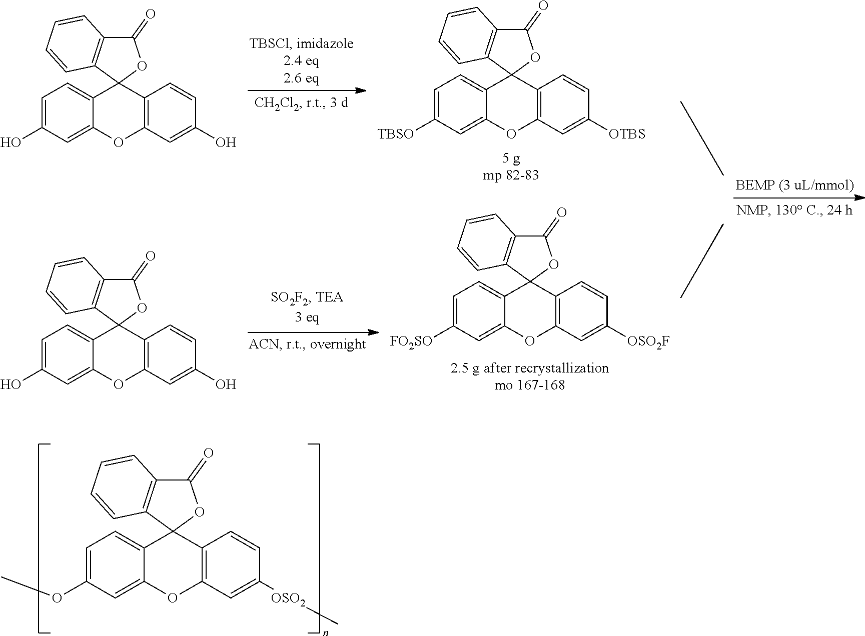

### Monomers:

3′,6′-bis((tert-butyldimethylsilyl)oxy)-3H-spiro[isobenzofuran-1,9′-xanthen]-3-one. White solid, 89% yield. mp 82-83° C. ¹H NMR (400 MHz, DMSO) δ 8.14-8.08 (m, 1H), 7.91 (d, J=2.5 Hz, 2H), 7.88-7.77 (m, 2H), 7.54-7.48 (m, 1H), 7.43 (dd, J=8.9, 2.5 Hz, 2H), 7.17 (d, J=8.9 Hz, 2H). ¹³C NMR (151 MHz, Chloroform-d) δ 169.48, 157.59, 153.18, 152.32, 134.95, 129.63, 129.01, 126.88, 124.97, 124.02, 116.61, 112.09, 107.65, 83.29, 25.62, 18.22, −4.39.

3-oxo-3H-spiro[isobenzofuran-1,9′-xanthene]-3′,6′-diyl bis(sulfurofluoridate). White solid, 45% yield. mp 167-168° C. ¹H NMR (400 MHz, DMSO-d₆) δ 7.99 (d, J=7.7 Hz, 1H), 7.78 (td, J=7.5, 1.3 Hz, 1H), 7.70 (td, J=7.5, 1.0 Hz, 1H), 7.29 (d, J=7.6 Hz, 1H), 6.77 (t, J=1.4 Hz, 2H), 6.62 (d, J=1.3 Hz, 4H), 0.91 (s, 18H), 0.19 (s, 12H). ¹³C NMR (151 MHz, Chloroform-d) δ 168.44, 152.20, 151.38, 150.59, 135.87, 130.76, 130.21, 125.77, 125.53, 123.75, 119.65, 117.25, 110.37, 79.97. ¹⁹F NMR (376 MHz, DMSO) δ 37.0 (s).

Polysulfate PS9 was prepared from the above monomers. Yellow solid. mp>300° C. ¹H NMR (600 MHz, DMSO) δ 8.10-7.99 (m, 1H), 7.83-7.70 (m, 2H), 7.67-7.55 (m, 2H), 7.42 (d, J=7.5 Hz, 1H), 7.32-7.22 (m, 2H), 7.11-7.00 (m, 2H). ¹³C NMR (151 MHz, DMSO) δ 168.2, 152.0, 150.8, 150.5, 136.1, 130.8, 130.5, 125.2, 125.0, 124.2, 118.6, 117.5, 110.1, 79.9. Mn=15.2 kDa, PDI=1.53. T_{g}=239° C.

### Example PS10

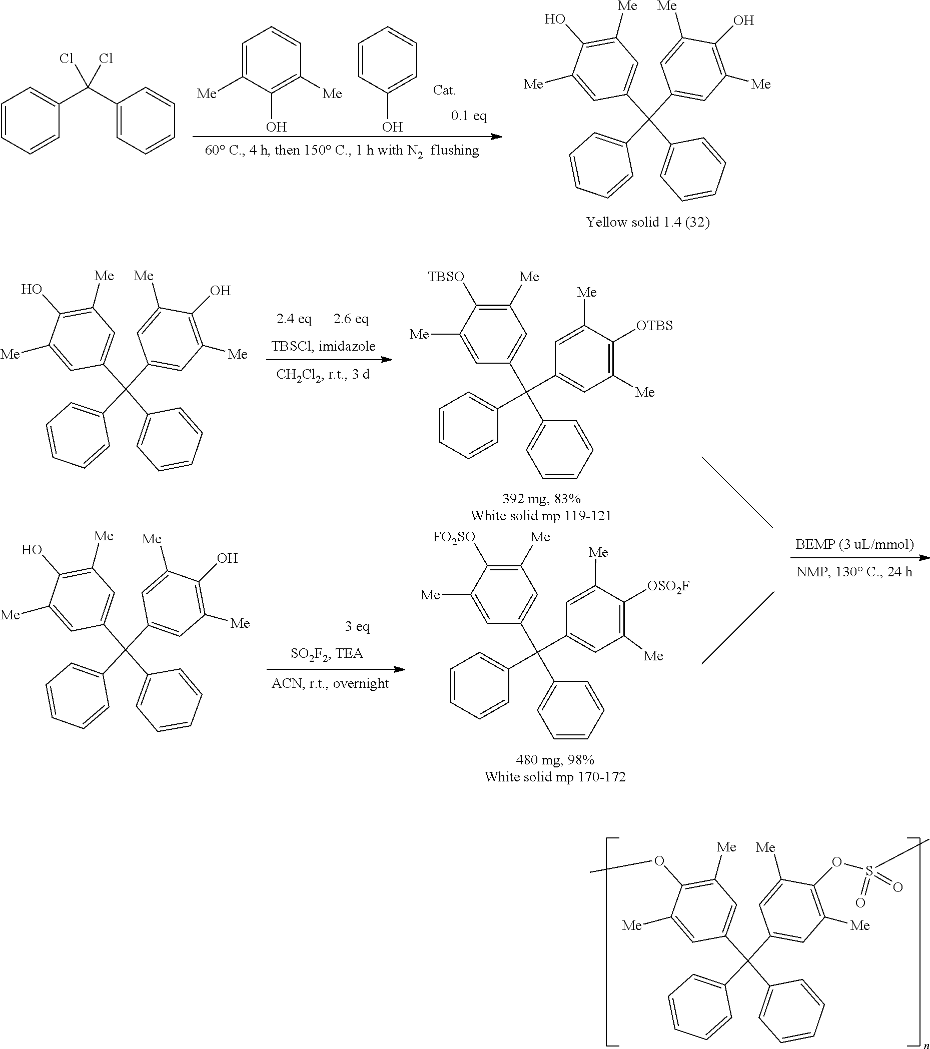

### 4,4′-(diphenylmethylene)bis(2,6-dimethylphenol)

Dichlorodiphenylmethane (2.36 g, 1 eq, 10 mmol), 2,6-dimethylphenol (2.68 g, 2.2 eq, 22 mmol), and phenol (0.100 g, 0.1 eq, 1 mmol) were stirred at room temperature until no volatiles were produced. The mixture was then heated at 60° C. for 4 hours. The temperature was slowly increased to 150° C. and held for 20 minutes. During this period, the flask was flushed with N₂. Thereafter, the crude product was purified by flash chromatography system (0-25% EtOAc/Hexane) to afford the product as a yellow solid (1.4 g, 34% yield). mp 200-201° C. ¹H NMR (400 MHz, DMSO-d₆) δ 8.09 (d, J=3.6 Hz, 2H), 7.20 (d, J=7.2 Hz, 4H), 7.09 (t, J=8.0 Hz, 6H), 6.61 (d, J=3.0 Hz, 4H), 2.00 (d, J=3.3 Hz, 12H).

Monomers were prepared by corresponding procedures:

bis(4-((tert-butyldimethylsilyl)oxy)-3,5-dimethylphenyl)diphenylmethane. Colorless crystal. mp 170-172° C. ¹H NMR (600 MHz, CDCl₃) δ 7.46-7.03 (m, 12H), 2.12 (s, 12H), 1.05 (d, J=1.8 Hz, 18H), 0.23 (d, J=1.9 Hz, 12H).

(diphenylmethylene)bis(2,6-dimethyl-4,1-phenylene) bis(sulfurofluoridate). Colorless oil. ¹H NMR (400 MHz, Chloroform-d) δ 7.30-7.25 (m, 4H), 7.24-7.18 (m, 2H), 7.17-7.10 (m, 4H), 6.93 (s, 4H), 2.28 (s, 12H).

Polysulfate PS10 was prepared from above monomers. Gray solid, mp 245-257° C. ¹H NMR (600 MHz, DMSO) δ 7.38-6.91 (m, 14H), 2.23-1.98 (m, 12H). Mn=14.1 kDa, PDI=1.45. T_{g}=102.5° C.

### Example PS11

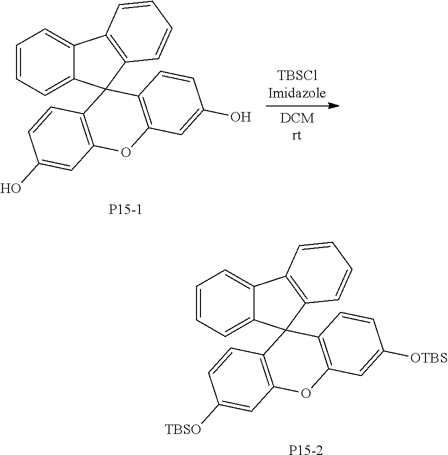

### Preparation of 3′,6′-bis((tert-butyldimethylsilyl)oxy)spiro[fluorene-9,9′-xanthene] (P15-2)

Spiro[fluorene-9,9′-xanthene]-3′,6′-diol (P15-1, 0.300 g, 0.82 mmol, 1.0 equiv.), imidazole (0.170 g, 2.5 mmol, 3.0 equiv.), and TBSCl (0.300 g, 2.0 mmol, 2.5 equiv.) were dissolved in 1 mL dry DMF. The mixture was stirred at room temperature for 1 hour, then 5 mL water was added. The aqueous layer was extracted with EtOAc (3×10 mL). The combined organic layer was washed with brine (10 mL), dried over Na₂SO₄ and evaporated. The crude product was purified by column chromatography on silica gel (5% EtOAc in Hexanes) to afford the product as a white solid (0.449 g, 92%). ¹H NMR (500 MHz, CDCl3) δ 7.76 (d, J=7.5 Hz, 2H), 7.34 (td, J=7.5, 1.2 Hz, 2H), 7.20 (td, J=7.4, 1.1 Hz, 2H), 7.14 (d, J=7.6 Hz, 2H), 6.66 (d, J=2.3 Hz, 2H), 6.26 (dd, J=8.5, 2.4 Hz, 2H), 6.22 (d, J=8.5 Hz, 2H), 0.96 (s, 18H), 0.19 (s, 12H).

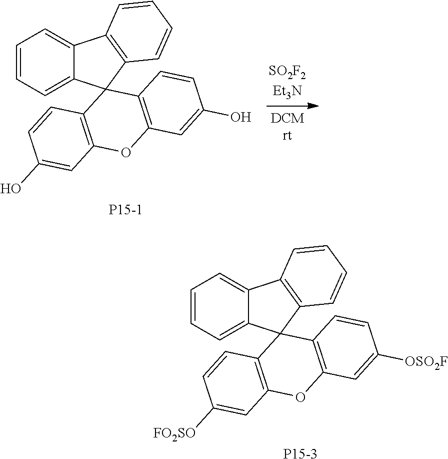

### Preparation of spiro[fluorene-9,9′-xanthene]-3′,6′-diyl bis(sulfurofluoridate) (P15-3)

Spiro[fluorene-9,9′-xanthene]-3′,6′-diol (P15-1, 0.300 g, 0.82 mmol, 1.0 equiv.) was dissolved in 4 mL dry dichloromethane (CH₂Cl₂), and Et₃N (347 μL, 0.253 g, 2.5 mmol, 3.0 equiv.) was added. The mixture was charged with SO₂F₂ via a balloon, and stirred under room temperature for 4 hours. Subsequently, the mixture washed with water (20 mL), the organic phase was dried over Na₂SO₄ and evaporated. The crude product was purified by column chromatography on silica gel (5% EtOAc in Hexanes) to afford the product as a white solid (quant.). ¹H NMR (500 MHz, CDCl3) δ 7.83 (d, J=7.6 Hz, 2H), 7.44 (td, J=7.5, 1.0 Hz, 2H), 7.28 (dd, J=7.5, 1.1 Hz, 2H), 7.25 (d, J=2.1 Hz, 2H), 7.14 (d, J=7.6 Hz, 2H), 6.81 (dd, J=9.0, 2.3 Hz, 2H), 6.51 (d, J=8.7 Hz, 2H).

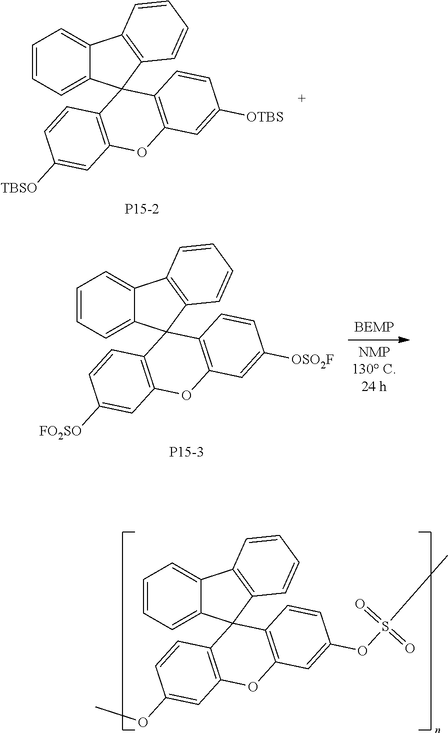

### Preparation of PS11:

The PS11 was prepared by the generation procedure.

¹H NMR (500 MHz, DMSO-d₆) δ 7.97-7.90 (m, 1H), 7.42-7.24 (m, 2H), 7.17-6.90 (m, 2H), 6.86-6.72 (m, 1H), 6.34-6.18 (m, 1H). Mp=330° C. Mn=22.8 kDa. PDI=1.29. T_{g}=241.6° C.

### Example PS12

### Preparation of (((2,2-diphenylethene-1,1-diyl)bis(4,1-phenylene))bis(oxy))bis(tert-butyldimethylsilane) (3)

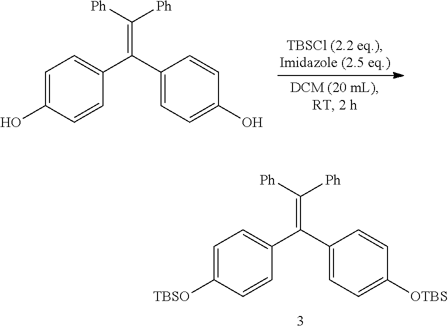 [SMILES: Oc1ccc(C(=C(c2ccccc2)c2ccccc2)c2ccc(O)cc2)cc1 ; CC(C)(C)[Si](C)(C)Oc1ccc(C(=C(c2ccccc2)c2ccccc2)c2ccc(O[Si](C)(C)C(C)(C)C)cc2)cc1]

A 100 mL round-bottomed flask was charged with a magnetic stir bar, 4,4′-(2,2-diphenylethene-1,1-diyl)diphenol (0.728 g, 2.0 mmol), imidazole (0.340 g, 5 mmol, 2.5 eq.) and 20 mL of dichloromethane (CH₂Cl₂). The solution was stirred at room temperature for 10 min, then TBSCl (0.660 g, 4.4 mmol, 2.2 eq) was added at room temperature. After 2 h, the reaction was monitored by TLC, the starting material disappeared. After completion, the reaction mixture was filtered, and the filtrate was concentrated under reduced pressure on a rotary evaporator. The resulting crude product was dissolved in 30 mL of ethyl acetate (EtOAc), which was subsequently washed with brine. The organic phase was dried over anhydrous MgSO₄. After filtration, the filtrate was subjected to evaporation to remove EtOAc. The product was purified by flash column chromatography over silica gel (hexanes/ethyl acetate=20/1) to afford product 3 as white solid (1.1 g, 93% yield).

White solid. mp 97-99° C. Rf=0.75 (Hexane/EA=20:1). 1H NMR (400 MHz, CDCl3) δ 7.12-7.05 (m, 6H), 7.02 (dd, J=6.7, 2.9 Hz, 4H), 6.89 (d, J=7.9 Hz, 4H), 6.59 (d, J=8.6 Hz, 4H), 0.97 (s, 18H), 0.17 (s, 12H). 13C NMR (101 MHz, CDCl3) δ 154.31, 144.39, 140.56, 139.43, 137.05, 132.65, 131.53, 127.70, 126.15, 119.39, 25.83, 18.38, −4.30.

### Preparation of 4-(1-(4-((fluorosulfonyl)oxy)phenyl)-2,2-diphenylvinyl)phenyl Sulfurofluoridate (6)

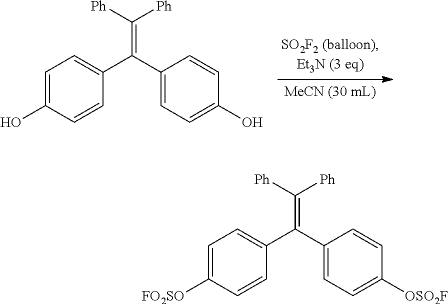

A 100 mL round-bottomed flask was charged with a magnetic stir bar, 4,4′-(2,2-diphenylethene-1,1-diyl)diphenol (0.728 g, 2 mmol), MeCN (30 mL) and Et₃N (0.606 g, 6 mmol, 3 eq.). The reaction flask was then sealed with a septum, the atmosphere above the solution was removed with gentle vacuum, and SO₂F₂ gas (sulfuryl fluoride, VIKANE) was introduced by needle from a balloon filled with the gas. The resulting mixture was stirred at room temperature until the full conversion of starting compound to the product, monitored by TLC. After completion, the solvent was removed by rotary evaporation, the residue was dissolved in EtOAc (50 mL), and the solution was washed with brine (3×100 mL). The organic phase was dried over anhydrous Na₂SO₄ and concentrated. The product was purified by flash column chromatography over silica gel (hexanes/ethyl acetate=9/1) to afford product 6 as white solid (0.980 g, 93% yield).

White solid. mp 158-160. Rf=0.55 (Hexane/EA=10:1). 1H NMR (400 MHz, CDCl3) δ 7.20-7.07 (m, 14H), 7.01-6.96 (m, 4H). 13C NMR (101 MHz, CDCl3) δ 148.65, 144.49, 143.71, 142.41, 136.86, 133.26, 131.22, 128.20, 127.54, 120.56 (d, J=10.5 Hz). 19F NMR (376 MHz, CDCl3) δ 35.18.

### Synthesis of the Polymer PS12:

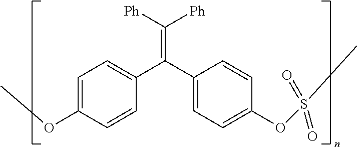

### Following the General Procedure:

White solid. mp 220-223° C. 1H NMR (500 MHz, THF-d8) δ 7.10-6.94 (m, 18H), 13C NMR (134 MHz, THF-d8) δ 149.09, 143.40, 142.98, 142.78, 137.98, 132.84, 131.12, 127.84, 126.95, 120.49. Mw ps=22.3 kDa. PDI=1.8. Tg (DSC)=153.2° C. Eg (eV)=3.27.

### Example PS13

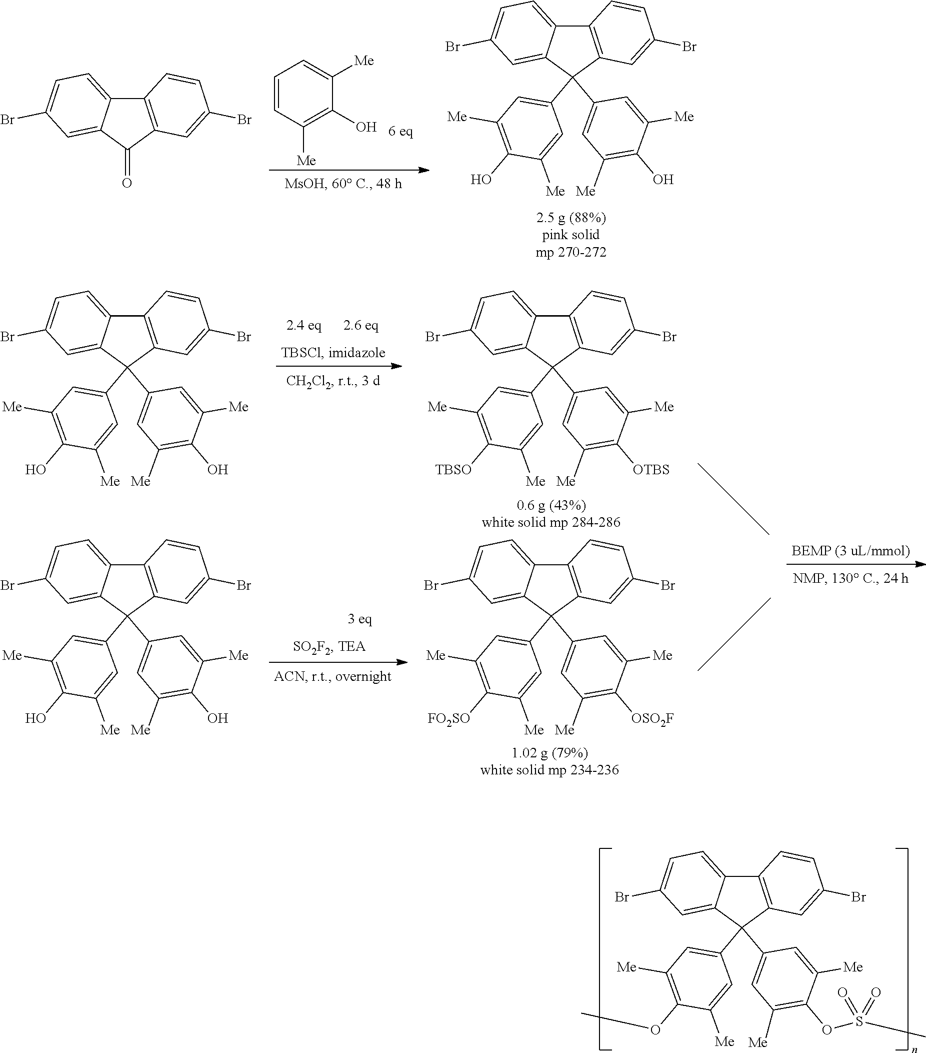

### 4,4′-(2,7-dibromo-9H-fluorene-9,9-diyl)bis(2,6-dimethylphenol)

This bisphenol was prepared by using the condition described in the synthesis of P21. Pink solid, 88% yield. mp 270-272° C. ¹H NMR (400 MHz, Chloroform-d) δ 7.55 (d, J=8.7 Hz, 2H), 7.45 (d, J=5.2 Hz, 4H), 6.70 (s, 4H), 2.14 (s, 12H).

### Monomers:

(((2,7-dibromo-9H-fluorene-9,9-diyl)bis(2,6-dimethyl-4,1-phenylene))bis(oxy))bis(tert-butyldimethylsilane). White solid, 43% yield. mp 284-286° C. ¹H NMR (400 MHz, Chloroform-d) δ 7.55 (dd, J=7.7, 3.0 Hz, 2H), 7.45 (d, J=7.8 Hz, 4H), 6.67 (d, J=2.6 Hz, 4H), 2.09 (d, J=2.9 Hz, 12H), 1.01 (d, J=3.1 Hz, 18H), 0.17 (d, J=3.1 Hz, 12H).

(2,7-dibromo-9H-fluorene-9,9-diyl)bis(2,6-dimethyl-4,1-phenylene) bis(sulfurofluoridate). White solid, 79% yield. mp 234-236° C. ¹H NMR (400 MHz, Chloroform-d) δ 7.61 (d, J=8.1 Hz, 2H), 7.53 (dd, J=8.1, 1.7 Hz, 2H), 7.41 (d, J=1.7 Hz, 2H), 6.82 (s, 4H), 2.29 (s, 12H). 19F NMR (376 MHz, Chloroform-d) δ 43.7 (s).

Polysulfate PS13 was prepared from above monomers. Gray solid, mp 280-289° C. ¹H NMR (600 MHz, THF) δ 7.80-7.77 (m, 2H), 7.69-7.65 (m, 2H), 7.59-7.55 (m, 2H), 7.01-6.98 (m, 4H), 2.29 (s, 13H). ¹³C NMR (151 MHz, THF) S 152.3, 147.8, 143.6, 138.2, 131.9, 131.2, 129.3, 128.9, 122.0, 121.8, 64.7, 16.2. Mn=9 kDa, PDI=1.45. T_{g}=176.6° C.

### Example PS14

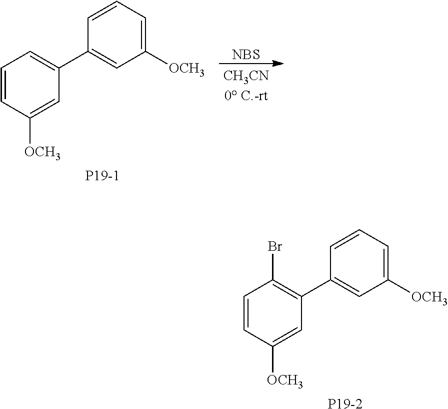

### Preparation of 2-bromo-3′,5-dimethoxy-1,1′-biphenyl (P19-2)

To a solution of 3,3′-dimethoxy-1, F-biphenyl (P19-1, 7.076 g, 33.0 mmol, 1.0 equiv.) in 80 mL dry acetonitrile stirred under 0° C. was added an 80 mL acetonitrile solution of NBS (6.230 g, 35 mmol, 1.05 equiv.) dropwise over 30 min. The yellow solution was then warmed up to room temperature with monitoring by TLC (Hex/EtOAc=2/1) and stirred overnight. Upon completion, the solvent was concentrated to ca. 30 mL under reduced pressure, and water (30 mL) was added. The aqueous layer was extracted with EtOAc (3×30 mL). The combined organic layer was washed with brine (30 mL), dried over Na₂SO₄ and evaporated. The crude yellow oil was purified by column chromatography on silica gel (20% EtOAc in Hexanes) to afford the product as a colorless oil (8.4 g, 87%). ¹H NMR (500 MHz, CDCl3) δ 7.54 (d, J=8.8 Hz, 1H), 7.37-7.31 (t, 1H), 6.99 (dt, J=7.5, 1.3 Hz, 1H), 6.96-6.92 (m, 2H), 6.88 (d, J=3.1 Hz, 1H), 6.78 (dd, J=8.8, 3.1 Hz, 1H), 3.85 (s, 3H), 3.81 (s, 3H). ¹³C NMR (126 MHz, CDCl3) δ 159.11, 158.76, 143.23, 142.45, 133.70, 129.01, 121.71, 116.57, 114.98, 114.82, 113.29, 112.97, 55.55, 55.32.

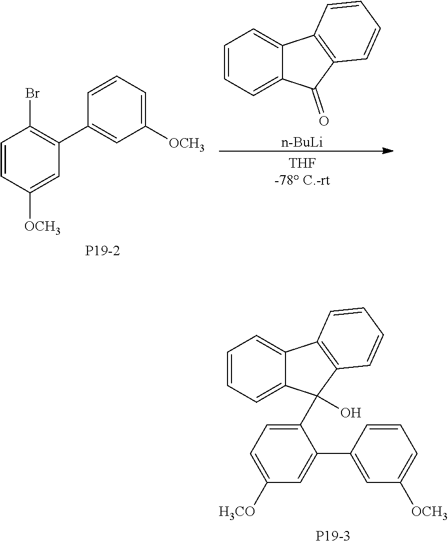

### Preparation of 9-(3′,5-dimethoxy-[1,1′-biphenyl]-2-yl)-9H-fluoren-9-ol (P19-3)

2-bromo-3′,5-dimethoxy-1,1′-biphenyl (P19-2, 8.4 g, 28.7 mmol, 1.0 equiv.) was dissolved in 60 mL extra dry THF, and cooled down to −78° C. n-BuLi (19 mL, 1.6 M in hexanes, 30.1 mmol, 1.05 equiv.) was added dropwise to the reaction mixture. The reaction mixture was warmed to room temperature and stirred for an additional 1 hour, followed by cooling down to −78° C. A solution of 9H-fluoren-9-one (5.7 g, 31.6 mmol, 1.1 equiv.) in extra dry THF (60 mL) was added dropwise, and stirred at that temperature for 1 hour with monitoring by TLC. Then, the reaction was warmed to room temperature and stirred overnight. After completion, it was quenched by sat. NH₄Cl (20 mL). The aqueous layer was extracted with EtOAc (3×30 mL). The combined organic layer was washed with brine (30 mL), dried over Na₂SO₄ and evaporated. The crude product was purified by column chromatography on silica gel (10% EtOAc in Hexanes) to afford the product as a white solid (7.0 g, 62%). ¹H NMR (500 MHz, CDCl3) δ 8.37 (d, J=8.8 Hz, 1H), 7.20 (m, 8H), 7.05 (dd, J=8.8, 2.8 Hz, 1H), 6.61-6.43 (m, 2H), 6.44-6.34 (m, 1H), 5.61 (d, J=7.4 Hz, 1H), 5.58-5.55 (m, 1H), 3.79 (s, 3H), 3.37 (s, 3H).

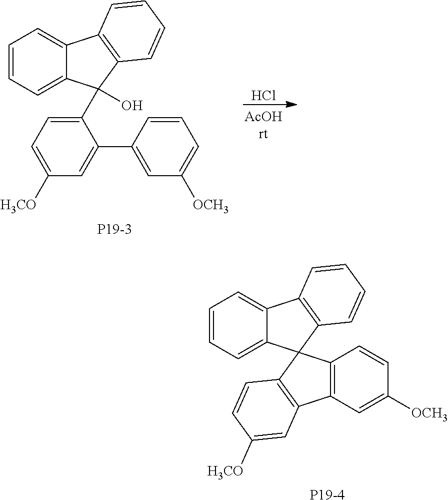

### Preparation of 3,6-dimethoxy-9,9′-spirobi[fluorene](P19-4)

9-(3′,5-dimethoxy-[1,1′-biphenyl]-2-yl)-9H-fluoren-9-ol (P19-3, 1.0 g, 2.5 mmol, 1.0 equiv.) was dissolved in 100 mL AcOH, and 2 mL conc. HCl was added dropwise. The mixture was stirred at room temperature for 24 hours with monitoring by TLC. After completion, water (50 mL) was added, and the aqueous layer was extracted with EtOAc (3×30 mL). The combined organic layer was washed with brine (30 mL), dried over Na₂SO₄ and evaporated. The crude product was purified by column chromatography on silica gel (5% EtOAc in Hexanes) to afford the product as a white solid (0.62 g, 65%). ¹H NMR (500 MHz, CDCl3) δ 7.82 (d, J=7.6 Hz, 1H), 7.42-7.30 (m, 2H), 7.10 (td, J=7.5, 1.1 Hz, 1H), 6.74 (d, J=7.6 Hz, 1H), 6.67 (dd, J=8.3, 2.4 Hz, 1H), 6.62 (d, J=8.5 Hz, 1H), 3.89 (s, 3H).

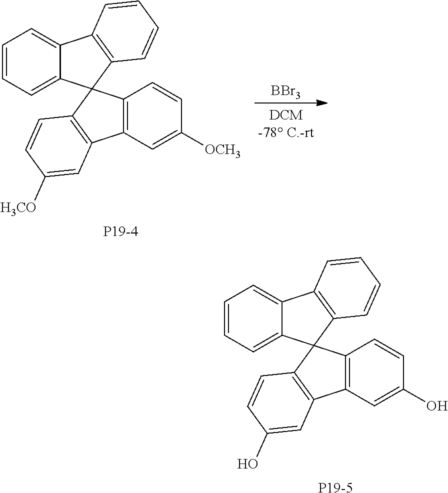

### Preparation of 9,9′-spirobi[fluorene]-3,6-diol (P19-5)

3,6-dimethoxy-9,9′-spirobi[fluorene](P19-4, 0.720 g, 1.9 mmol, 1.0 equiv.) was dissolved in 5 mL dry DCM, and cooled to −78° C. BBr₃ (15.2 mL, 1.0 M in DCM, 15.2 mmol, 8.0 equiv.) was added dropwise via a syringe. Then the reaction was allowed to warm to room temperature and stirred overnight with monitoring by TLC. Subsequently, water (30 mL) was added, and the aqueous layer was extracted with EtOAc (3×30 mL). The combined organic layer was washed with brine (30 mL), dried over Na₂SO₄ and evaporated. The crude product was purified by column chromatography on silica gel (20% EtOAc in Hexanes) to afford the product as a white solid (quant.). ¹H NMR (500 MHz, CDCl3) δ 7.81 (d, J=7.6 Hz, 2H), 7.34 (td, J=7.5, 1.1 Hz, 2H), 7.23 (dd, J=1.8, 1.0 Hz, 2H), 7.10 (td, J=7.5, 1.1 Hz, 2H), 6.74 (d, J=7.6 Hz, 2H), 6.57 (m, 4H), 4.87 (brs, 1H).

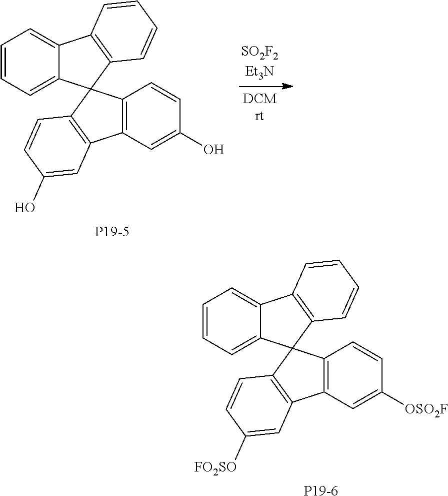

### Preparation of 9,9′-spirobi[fluorene]-3,6-diyl bis(sulfurofluoridate) (P19-6)

9,9′-spirobi[fluorene]-3,6-diol (P19-5, 0.240 g, 0.69 mmol, 1.0 equiv.) was dissolved in 4 mL dry DCM, and Et₃N (290 μL, 0.209 g, 2.07 mmol, 3.0 equiv.) was added. The mixture was charged with SO₂F₂ via a balloon, and stirred under room temperature for 4 hours with monitoring by TLC. Subsequently, the mixture washed with water (20 mL), the organic phase was dried over Na₂SO₄ and evaporated. The crude product was purified by column chromatography on silica gel (5% EtOAc in Hexanes) to afford the product as a white solid (quant.). ¹H NMR (500 MHz, CDCl3) δ 7.86 (d, J=7.7 Hz, 2H), 7.79 (d, J=2.3 Hz, 2H), 7.42 (td, J=7.5, 1.0 Hz, 2H), 7.19-7.11 (m, 4H), 6.84 (d, J=8.4 Hz, 2H), 6.72 (d, J=7.6 Hz, 2H).

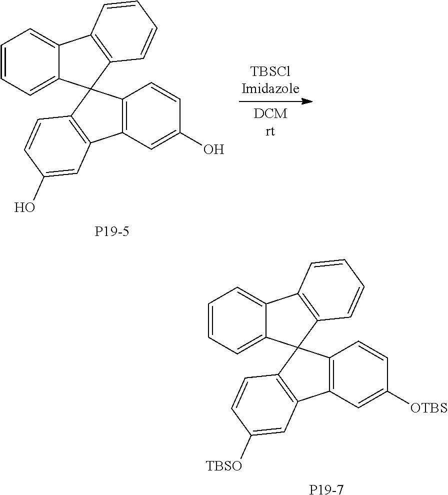

### Preparation of 3,6-bis((tert-butyldimethylsilyl)oxy)-9,9′-spirobi[fluorene](P19-7)

9,9′-spirobi[fluorene]-3,6-diol (P19-5, 0.300 g, 0.86 mmol, 1.0 equiv.), imidazole (0.351 g, 5.16 mmol, 6.0 equiv.), and TBSCl (0.520 g, 3.44 mmol, 4.0 equiv.) were dissolved in 1 mL dry DMF. The mixture was stirred under room temperature for 1 hour with monitoring by TLC. Then 5 mL of water was added, the aqueous layer was extracted with EtOAc (3×10 mL). The combined organic layer was washed with brine (10 mL), dried over Na₂SO₄ and evaporated. The crude product was purified by column chromatography on silica gel (5% EtOAc in Hexanes) to afford the product as a white solid (0.427 g, 86%). ¹H NMR (500 MHz, CDCl3) δ 7.80 (d, J=7.6 Hz, 2H), 7.34 (td, J=7.5, 1.1 Hz, 2H), 7.20 (dd, J=2.2, 0.5 Hz, 2H), 7.10 (td, J=7.5, 1.1 Hz, 2H), 6.74 (dt, J=7.6, 0.8 Hz, 2H), 6.59-6.49 (m, 4H), 1.01 (s, 18H), 0.24 (s, 12H).

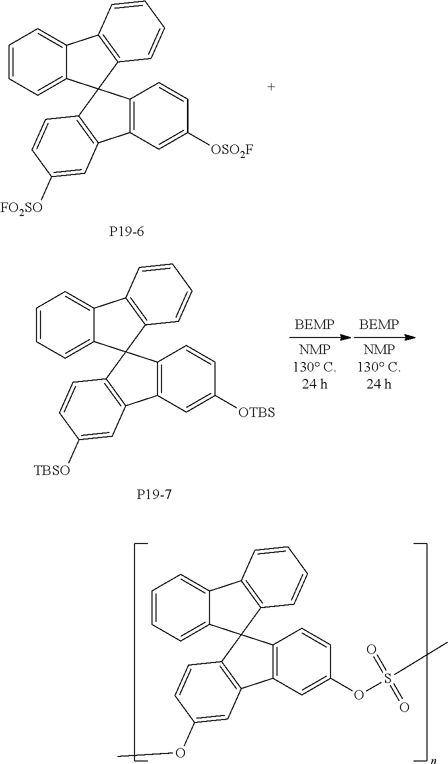

### Preparation of PS14:

The PS14 was prepared by the generation procedure.

¹H NMR (500 MHz, DMSO-d₆) δ 8.36 (s, 2H), 7.97 (d, J=14.5 Hz, 2H), 7.42-7.28 (m, 2H), 7.26-7.18 (m, 2H), 7.07-6.97 (m, 2H), 6.74-6.49 (m, 4H). ¹³C NMR (126 MHz, DMSO-d₆) δ 150.45, 148.67, 146.85, 142.54, 141.67, 128.81, 128.64, 125.71, 123.90, 122.00, 121.20, 115.43. mp=335° C. Mn=19.2 kDa. PDI=1.71. T_{g}=253.2° C.

### Example PS15

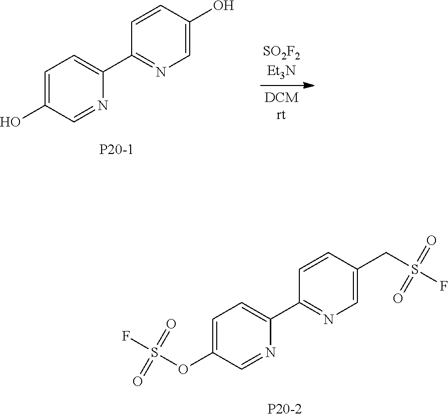 [SMILES: Oc1ccc(-c2ccc(O)cn2)nc1 ; O=S(=O)(F)Cc1ccc(-c2ccc(OS(=O)(=O)F)cn2)nc1]

### Preparation of [2,2′-bipyridine]-5,5′-diyl bis(sulfurofluoridate) (P20-2)

[2,2′-bipyridine]-5,5′-diol (P20-1, 0.100 g, 0.53 mmol, 1.0 equiv.) was suspended in 4 mL dry DCM, and Et₃N (222 μL, 0.161 g, 1.60 mmol, 3.0 equiv.) was added. The mixture was charged with SO₂F₂ via a balloon, and stirred under room temperature overnight with monitoring by TLC. Subsequently, the mixture washed with water (30 mL), the organic phase was dried over Na₂SO₄ and evaporated. The crude product was purified by column chromatography on silica gel (20% EtOAc in Hexanes) to afford the product as a white solid (0.157 g, 84%). ¹H NMR (400 MHz, CDCl3) δ 8.74 (d, J=2.7 Hz, 1H), 8.62 (d, J=9.1 Hz, 1H), 7.87 (dd, J=8.7, 2.7 Hz, 1H).

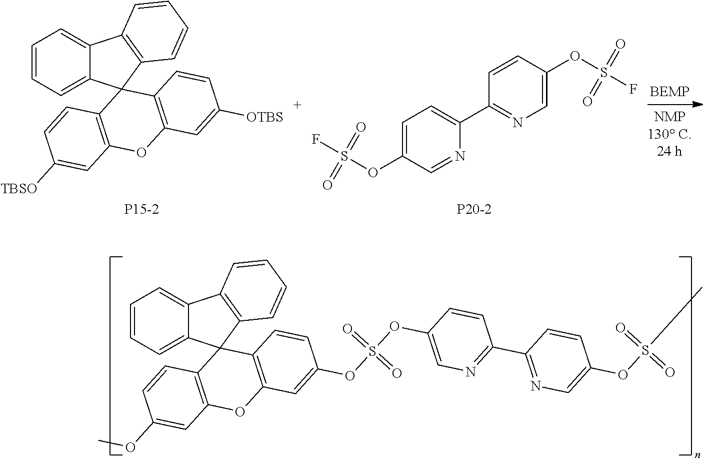

### Preparation of PS15:

The PS16 was prepared by the generation procedure.

mp=298° C. Mn=15.7 kDa. PDI=1.31. T_{g}=191.3° C.

### Example PS16

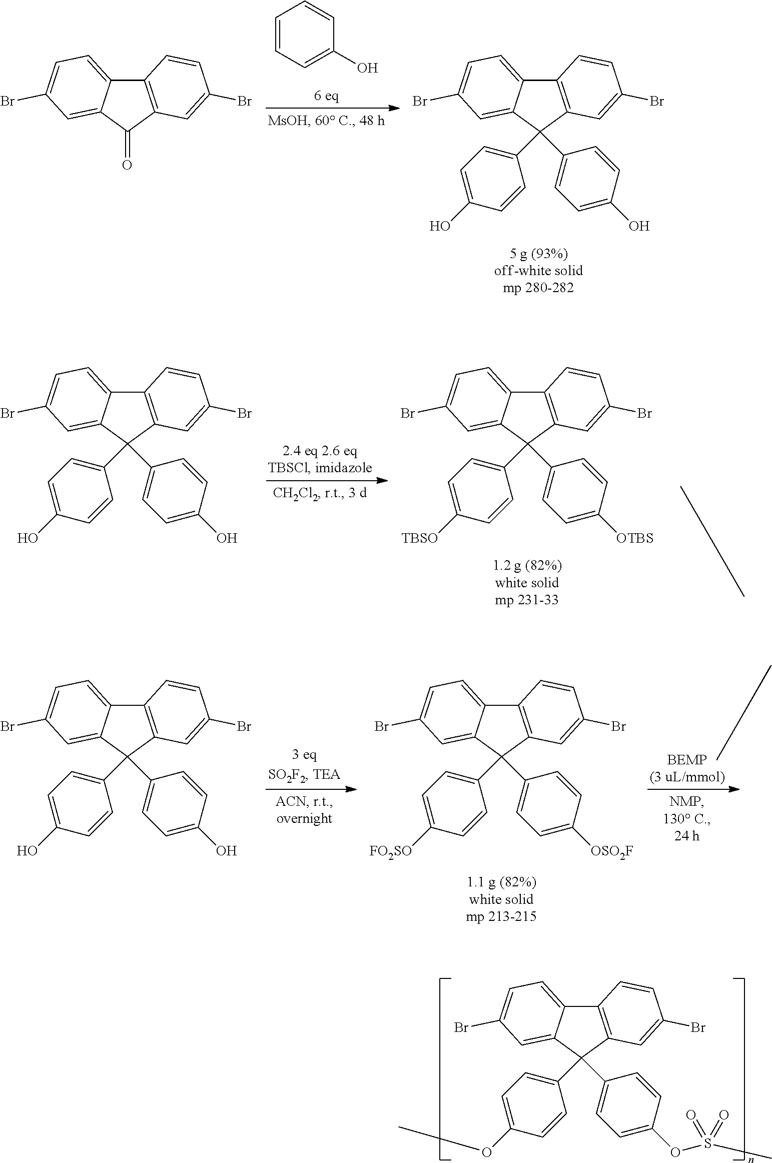

### 4,4′-(2,7-dibromo-9H-fluorene-9,9-diyl)diphenol

The mixture of 2,7-dibromo-9H-fluoren-9-one (3.6 g, 1 eq, 10.6 mmol), phenol (5 g, 6 eq, 66.6 mmol), and 14 mL MsOH were heated at 60° C. for 24 hours. The resulting liquid were poured into ice-water and obtained solid was collected by filtration. The solid was dried under vacuum at room temperature, and then re-dissolved in EtOAc. The solution was injected into hexane via syringe and the resulting solid was collected as desired product with high purity as an off-white solid (93% yield). mp 280-282° C. ¹H NMR (400 MHz, DMSO-d₆) δ 9.38 (s, 2H), 7.86 (d, J=8.2 Hz, 2H), 7.54 (d, J=8.2 Hz, 2H), 7.45 (s, 2H), 6.85 (d, J=8.5 Hz, 4H), 6.62 (d, J=8.6 Hz, 4H).

### Monomers:

(((2,7-dibromo-9H-fluorene-9,9-diyl)bis(4,1-phenylene))bis(oxy))bis(tert-butyldimethylsilane). White solid, 82% yield. mp 231-233° C. ¹H NMR (400 MHz, Chloroform-d) δ 7.55 (d, J=8.5 Hz, 2H), 7.49-7.37 (m, 4H), 6.96 (d, J=8.6 Hz, 4H), 6.68 (d, J=8.6 Hz, 4H), 0.95 (s, 18H), 0.17 (s, 12H).

(2,7-dibromo-9H-fluorene-9,9-diyl)bis(4,1-phenylene) bis(sulfurofluoridate). White solid, 82% yield. mp 213-215° C. ¹H NMR (400 MHz, Chloroform-d) δ 7.63 (d, J=7.7 Hz, 2H), 7.55 (d, J=7.6 Hz, 2H), 7.42 (s, 2H), 7.30-7.16 (m, 8H). ¹⁹F NMR (376 MHz, Chloroform-d) δ 38.1 (s).

Polysulfate PS16 was prepared from the above monomers. Gray solid, mp 300-312° C. ¹H NMR (600 MHz, DMSO) δ 7.97-7.90 (m, 2H), 7.70-7.50 (m, 4H), 7.40-7.09 (m, 8H). ¹³C NMR (151 MHz, DMSO) δ 151.6, 148.8, 143.7, 137.7, 131.5, 129.7, 128.6, 123.1, 121.6, 121.4, 64.2. Mn=20.4 kDa, PDI=1.57. T_{g}=256.9° C.

### Example PS17

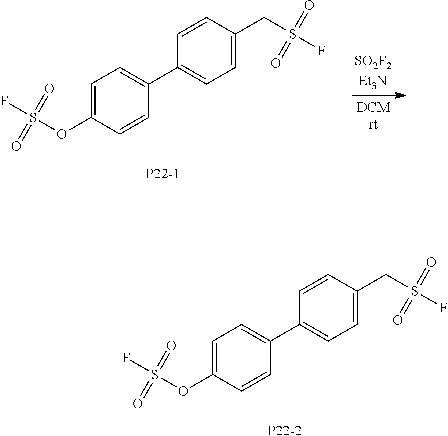

The compound was prepared according to the previous literature published by our group [Gao B, Zhang L, Zheng Q, et al. Bifluoride-catalysed sulfur (VI) fluoride exchange reaction for the synthesis of polysulfates and polysulfonates. Nature Chemistry, 2017, 9(11): 1083-1088.].

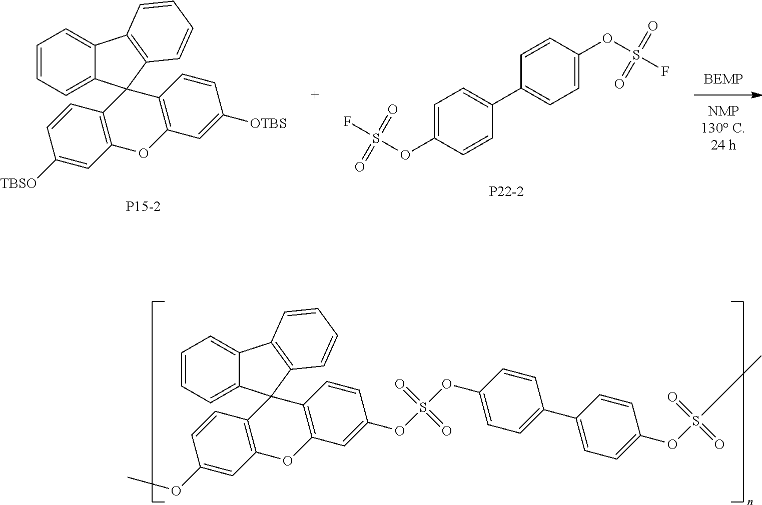

### Preparation of PS17:

The PS17 was prepared by the generation procedure.

¹H NMR (500 MHz, DMSO-d₆) δ 8.04-7.94 (m, 2H), 7.87-7.70 (m, 4H), 7.62-7.35 (m, 8H), 7.27-6.81 (m, 6H), 6.44-6.27 (m, 2H). mp=298° C. Mn=42.9 kDa. PDI=1.82. T_{g}=191.3° C.

Synthesis of Monomer with Spirocycle:

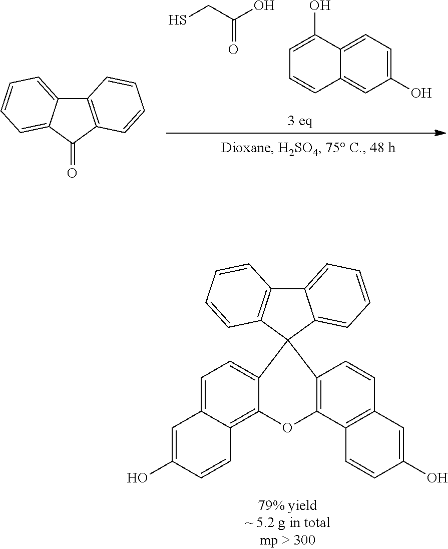 [SMILES: O=C1c2ccccc2-c2ccccc21 ; O=C(O)CS ; Oc1ccc2c(O)cccc2c1 ; Oc1ccc2c3c(ccc2c1)C1(c2ccccc2-c2ccccc21)c1ccc2cc(O)ccc2c1O3]

### Spiro[dibenzo[c,h]xanthene-7,9′-fluorene]-3,11-diol

To a mixture of 9H-fluoren-9-one (1.8 g, 1 eq, 10 mmol) and naphthalene-1,6-diol (4 g, 2.7 eq, 27.4 mmol) in 1,4-dioxane (50 mL), was slowly added 2-mercaptoacetic acid (200 μL) and sulfuric acid in sequence. The resulting mixture was heated at 75° C. for 12 hours monitoring by TLC. The reaction mixture was quenched with water, extracted with EtOAc, dried over Na₂SO₄ and concentrated to dryness. The residue was purified by flash chromatography system (0-60% EtOAc/Hexane) to afford the product a pale yellow solid (5.2 g, 79% yield). mp>300° C. ¹H NMR (600 MHz, DMSO) δ 9.92 (s, 2H), 8.60 (d, J=9.0 Hz, 2H), 8.04 (d, J=7.7 Hz, 2H), 7.53-7.33 (m, 2H), 7.31 (dd, J=9.0, 2.4 Hz, 2H), 7.22 (td, J=7.4, 1.1 Hz, 2H), 7.15 (d, J=8.7 Hz, 2H), 7.09 (d, J=7.6 Hz, 2H), 7.07 (d, J=2.4 Hz, 2H), 6.15 (d, J=8.7 Hz, 2H). ¹³C NMR (151 MHz, DMSO) δ 156.7, 155.9, 145.8, 139.8, 135.3, 129.0, 128.6, 126.2, 125.8, 123.6, 122.1, 120.9, 119.2, 118.5, 115.1, 109.6, 53.8.

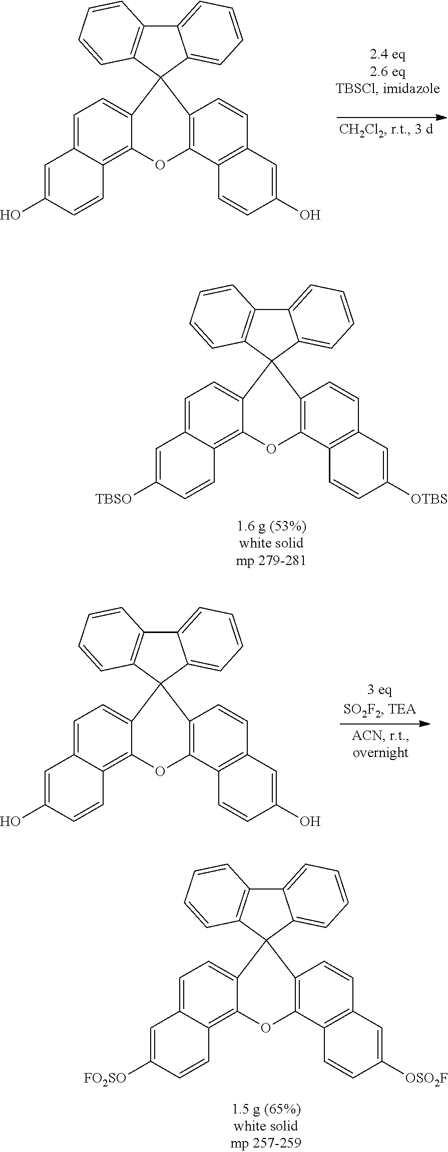

### Monomers:

3,11-bis((tert-butyldimethylsilyl)oxy)spiro[dibenzo[c,h]xanthene-7,9′-fluorene]. White solid, 53% yield. mp 279-281° C. ¹H NMR (600 MHz, CDCl₃) δ 8.86 (d, J=9.4 Hz, 2H), 7.94 (d, J=7.7 Hz, 2H), 7.78 (s, 2H), 7.70 (d, J=9.2 Hz, 2H), 7.48 (t, J=7.5 Hz, 2H), 7.36 (d, J=8.7 Hz, 2H), 7.27 (q, J=7.5 Hz, 2H), 7.17 (d, J=7.7 Hz, 2H), 6.56 (d, J=8.7 Hz, 2H). ¹³C NMR (151 MHz, CDCl₃) δ 155.3, 148.4, 145.6, 139.8, 133.8, 128.7, 128.5, 127.9, 126.2, 124.7, 123.7, 123.5, 120.3, 119.9, 119.5, 118.8. ¹⁹F NMR (376 MHz, CDCl₃) δ 38.1 (s).

spiro[dibenzo[c,h]xanthene-7,9′-fluorene]-3,11-diyl bis(sulfurofluoridate). White solid, 65% yield. mp 257-259° C. ¹H NMR (600 MHz, DMSO) δ 8.64 (d, J=9.0 Hz, 2H), 8.01 (d, J=7.8 Hz, 2H), 7.43 (t, J=7.6 Hz, 2H), 7.29 (d, J=9.0 Hz, 2H), 7.22 (dd, J=17.1, 8.1 Hz, 6H), 7.10 (d, J=7.5 Hz, 2H), 6.22 (d, J=8.7 Hz, 2H), 1.00 (s, 18H), 0.25 (s, 12H). ¹³C NMR (151 MHz, DMSO) δ 155.3, 153.9, 145.2, 139.3, 134.5, 128.4, 128.1, 125.7, 125.6, 123.1, 122.1, 122.0, 120.3, 119.4, 115.8, 114.9, 25.6, −4.5.

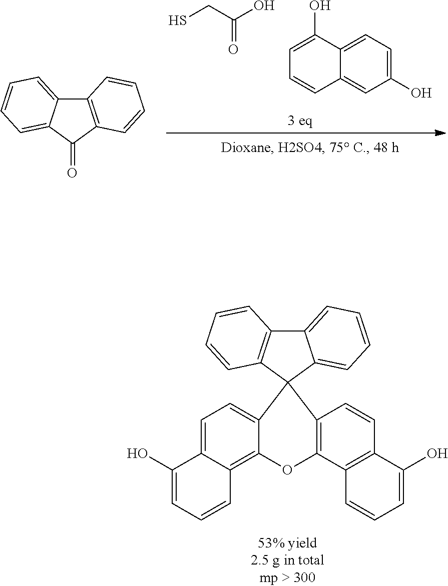 [SMILES: O=C1c2ccccc2-c2ccccc21 ; O=C(O)CS ; Oc1ccc2c(O)cccc2c1 ; Oc1cccc2c3c(ccc12)C1(c2ccccc2-c2ccccc21)c1ccc2c(O)cccc2c1O3]

### spiro[dibenzo[c,h]xanthene-7,9′-fluorene]-4,10-diol

This intermediate was prepared by using similar condition in the synthesis of Spiro[dibenzo[c,h]xanthene-7,9′-fluorene]-3,11-diol. The product was obtained as yellow solid with a 53% yield. mp>300° C. ¹H NMR (600 MHz, DMSO) δ 10.21 (s, 1H), 8.15 (d, J=8.4 Hz, 1H), 8.07 (d, J=7.7 Hz, 1H), 7.60 (d, J=8.9 Hz, 1H), 7.56 (t, J=8.0 Hz, 1H), 7.49-7.42 (m, 1H), 7.28-7.22 (m, 1H), 7.12 (d, J=7.6 Hz, 1H), 7.03-6.95 (m, 1H), 6.21 (d, J=8.9 Hz, 1H). ¹³C NMR (151 MHz, DMSO) δ 155.8, 153.9, 145.5, 139.9, 129.1, 128.7, 127.9, 126.3, 125.8, 124.8, 123.8, 121.0, 118.4, 118.0, 112.2, 109.9, 54.1.

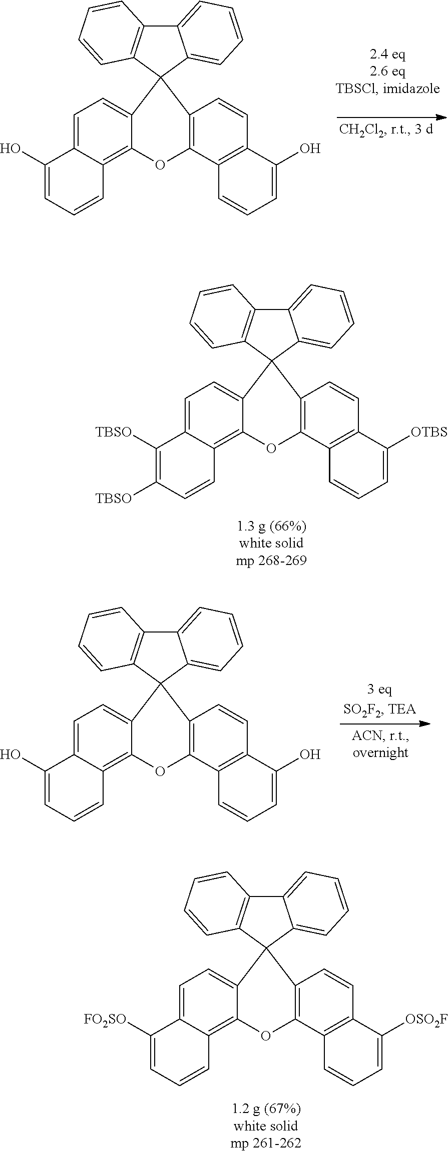

4,10-bis((tert-butyldimethylsilyl)oxy)spiro[dibenzo[c,h]xanthene-7,9′-fluorene]. Yellow solid, 66% yield. mp 268-269° C. ¹H NMR (600 MHz, CDCl₃) δ 8.80 (d, J=8.4 Hz, 2H), 7.94 (d, J=7.7 Hz, 2H), 7.77 (t, J=8.1 Hz, 2H), 7.66 (d, J=7.7 Hz, 2H), 7.54 (d, J=8.9 Hz, 2H), 7.48 (td, J=7.5, 1.1 Hz, 2H), 7.25 (td, J=7.4, 1.1 Hz, 2H), 7.17 (d, J=7.6 Hz, 2H), 6.61 (d, J=8.9 Hz, 2H). ¹³C NMR (151 MHz, CDCl₃) δ 155.2, 146.3, 145.7, 140.0, 128.9, 128.8, 128.1, 126.4, 126.3, 126.1, 126.0, 122.6, 120.5, 120.3, 118.6, 116.3, 54.0. ¹⁹F NMR (376 MHz, DMSO-D₆) δ 34.7 (s).

spiro[dibenzo[c,h]xanthene-7,9′-fluorene]-4,10-diyl bis(sulfurofluoridate). Yellow solid, 67% yield. Mp 261-262° C. ¹H NMR (600 MHz, CDCl₃) δ 8.37 (dd, J=8.4, 1.2 Hz, 2H), 7.92-7.85 (m, 2H), 7.64 (d, J=8.8 Hz, 2H), 7.55 (t, J=8.0 Hz, 2H), 7.42 (td, J=7.4, 1.4 Hz, 2H), 7.25-7.16 (m, 4H), 6.95 (dd, J=7.6, 1.0 Hz, 2H), 6.41 (d, J=8.8 Hz, 2H), 1.03 (s, 19H), 0.27 (s, 12H). ¹³C NMR (151 MHz, CDCl₃) δ 156.1, 151.8, 146.0, 140.0, 128.5, 128.1, 128.0, 126.5, 126.5, 126.3, 124.7, 120.0, 118.5, 117.9, 114.7, 113.5, 54.4, 25.9, 18.5, −4.2.

Polysulfates PS18-P28 were prepared from corresponding monomers by using the standard polymerization condition. The spectral data are listed as following:

### Example PS18

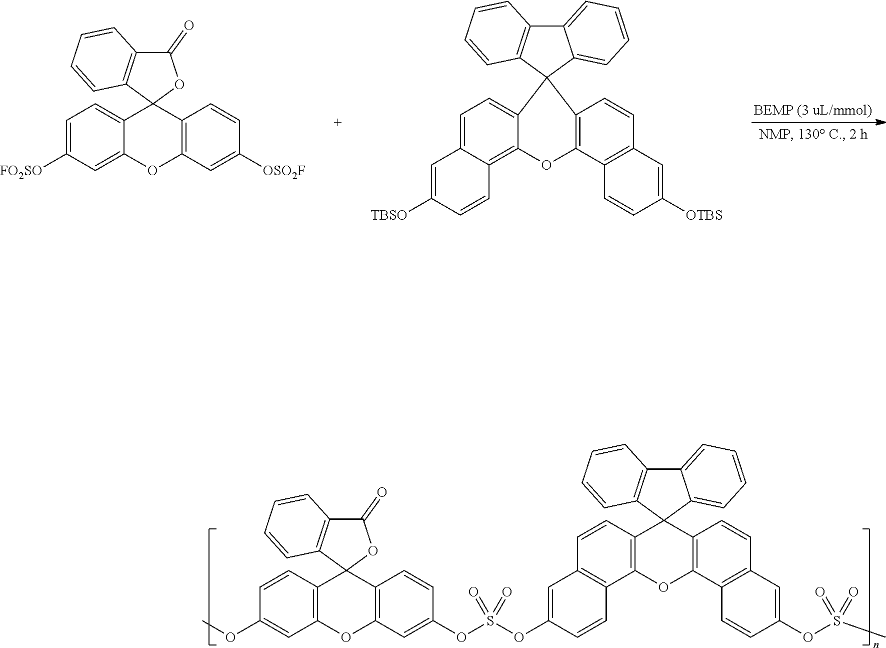

Yellow solid. mp>300° C. ¹H NMR (600 MHz, DMSO) δ 9.02-8.84 (m, 2H), 8.06-7.99 (m, 4H), 7.81-7.00 (m, 20H), 6.39-6.22 (m, 2H). ¹³C NMR (151 MHz, DMSO) δ 168.2, 154.9, 150.8, 150.6, 150.4, 148.2, 145.0, 139.3, 139.1, 136.1, 133.5, 130.5, 128.6, 128.4, 126.8, 125.8, 125.0, 124.7, 124.1, 123.6, 122.6, 120.6, 120.3, 118.9, 118.6, 118.4, 117.5, 117.5, 110.0, 53.3, 51.8. Mn=24.3 kDa, PDI=1.79. T_{g}=301.9° C.

### Example PS19

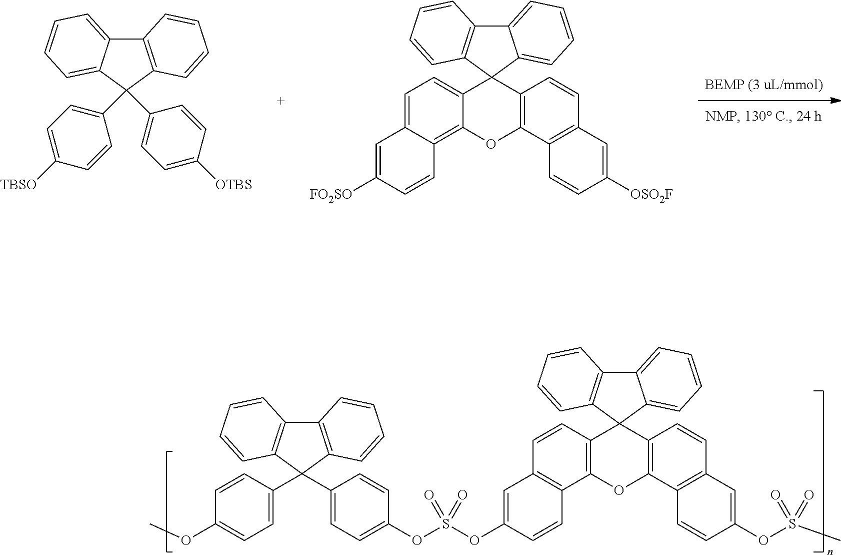

White solid. mp>300° C. ¹H NMR (600 MHz, DMSO) δ 9.06-8.73 (m, 2H), 8.07-8.00 (m, 2H), 7.92-7.70 (m, 4H), 7.50-7.03 (m, 24H), 6.44-6.19 (m, 2H). ¹³C NMR (151 MHz, DMSO) δ 155.0, 149.5, 148.6, 148.4, 145.1, 145.0, 139.4, 139.3, 133.5, 129.6, 129.5, 128.7, 128.5, 128.2, 126.8, 125.9, 124.5, 123.6, 122.5, 121.2, 121.2, 120.8, 120.6, 120.4, 118.8, 118.8, 118.5, 64.0, 53.3. Mn=11.6 kDa, PDI=1.42. T_{g}=271.9° C.

### Example PS20

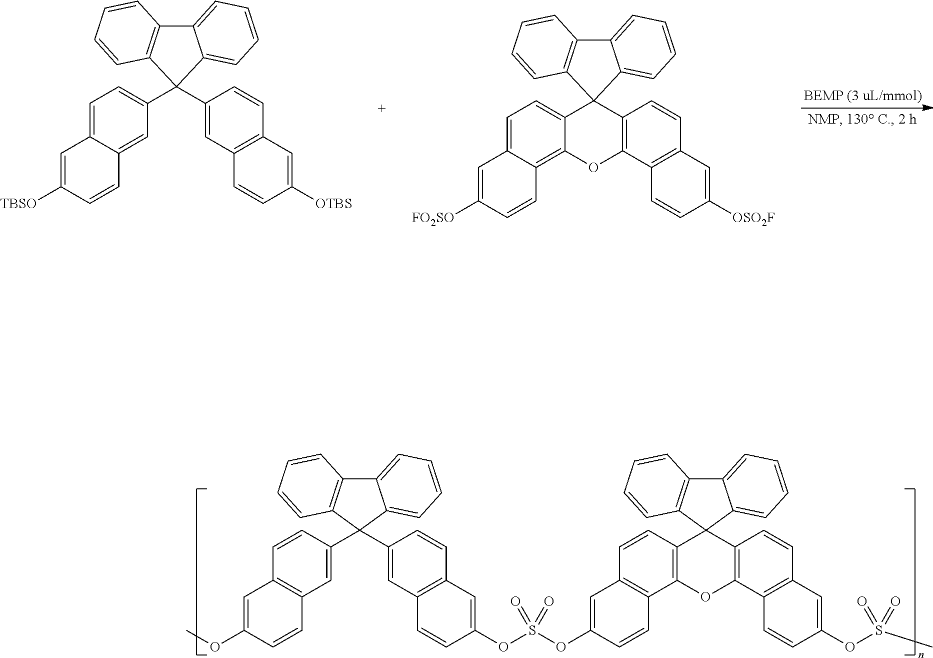

White solid. mp>300° C. ¹H NMR (600 MHz, DMSO) δ 9.16-8.69 (m, 2H), 8.07-7.97 (m, 3H), 7.94-6.72 (m, 31H), 6.43-6.13 (m, 2H). ¹³C NMR (151 MHz, DMSO) δ 154.9, 149.7, 148.3, 147.4, 145.0, 144.0, 139.7, 139.3, 133.5, 132.0, 131.5, 130.8, 128.4, 128.1, 126.8, 126.1, 125.8, 125.5, 124.7, 123.6, 122.6, 120.6, 120.4, 120.0, 118.8, 118.6, 118.2, 65.0, 53.2. Mn=41.3 kDa, PDI=2.1. T_{g}>310° C.

### Example PS21

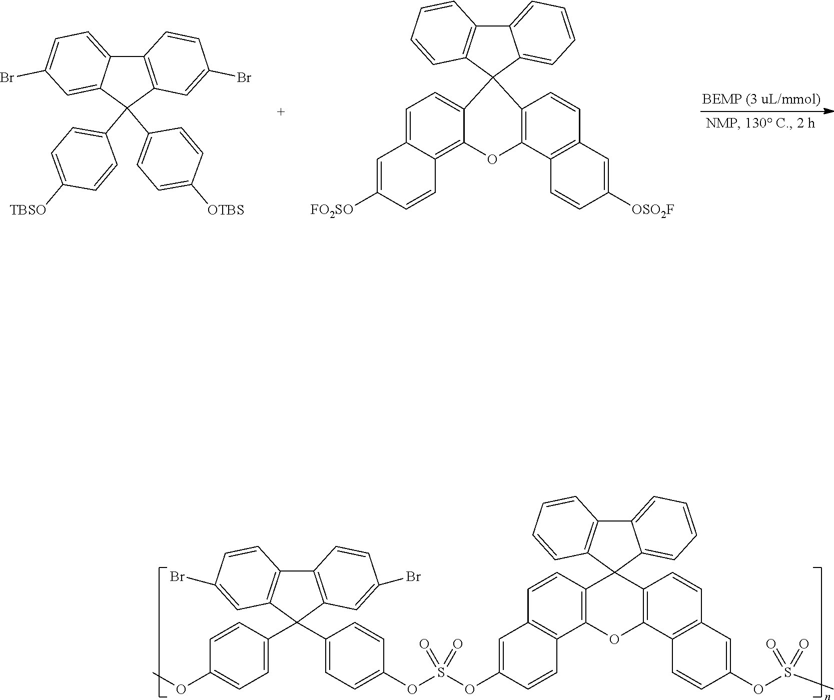

White solid. mp>300° C. ¹H NMR (600 MHz, DMSO) δ 8.99-8.82 (m, 2H), 8.04-7.97 (m, 2H), 7.94-7.00 (m, 26H), 6.38-6.18 (m, 2H). ¹³C NMR (151 MHz, DMSO) δ 154.9, 151.6, 148.9, 148.3, 145.0, 143.7, 139.3, 137.7, 133.4, 131.5, 129.7, 129.6, 128.6, 126.8, 125.8, 124.5, 123.5, 123.1, 122.5, 121.6, 121.5, 121.4, 120.6, 120.3, 118.8, 118.5, 64.2, 53.3. Mn=67.5 kDa, PDI=2.0. T_{g}=299.9° C.

### Example PS22

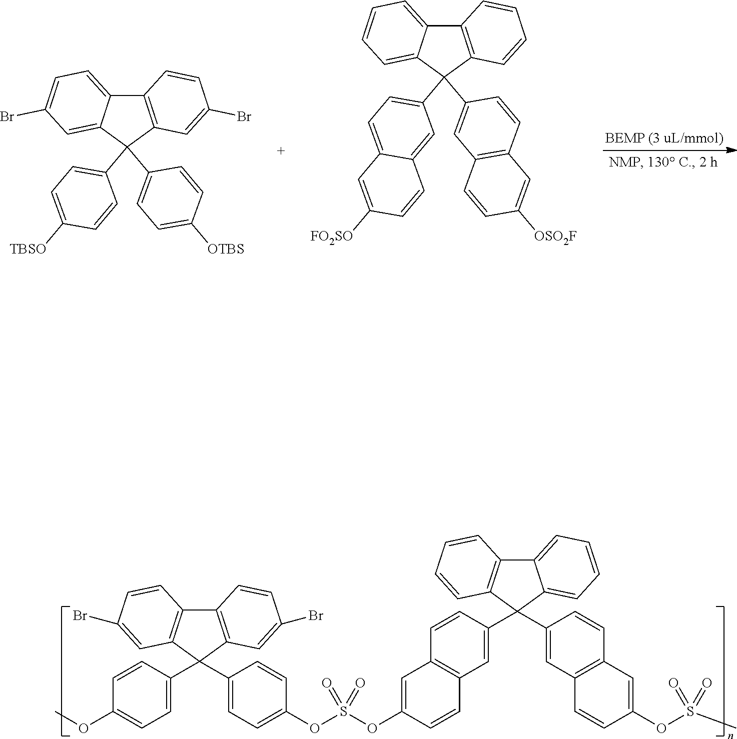

White solid. mp>300° C. ¹H NMR (600 MHz, DMSO) δ 8.03-7.96 (m, 2H), 7.95-7.75 (m, 8H), 7.72-7.62 (m, 4H), 7.61-7.53 (m, 4H), 7.47-7.20 (m, 16H). ¹³C NMR (151 MHz, DMSO) δ 151.6, 149.7, 148.9, 147.5, 144.0, 143.7, 139.7, 137.7, 132.0, 131.6, 131.5, 130.7, 129.7, 128.7, 128.4, 128.1, 126.2, 125.5, 123.1, 121.7, 121.5, 120.8, 119.9, 118.2, 65.0, 64.2. Mn=23.6 kDa, PDI=1.57. T_{g}=266.8° C.

### Example PS23

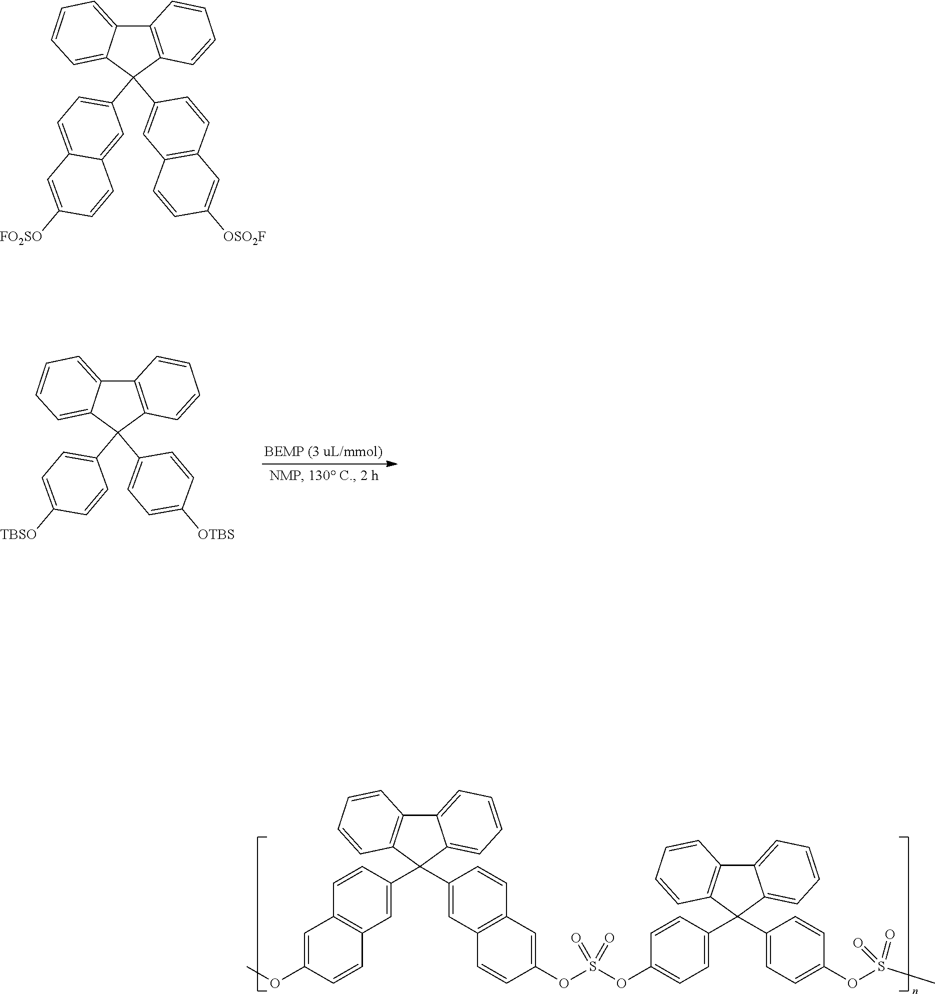

White solid. mp>300° C. ¹H NMR (600 MHz, DMSO) δ 8.02-7.96 (m, 2H), 7.94-7.72 (m, 8H), 7.69-7.60 (m, 2H), 7.60-7.52 (m, 2H), 7.48-7.11 (m, 22H). ¹³C NMR (151 MHz, DMSO) δ 149.7, 149.5, 148.6, 147.5, 145.1, 143.9, 139.7, 139.4, 131.9, 131.4, 130.7, 129.6, 129.5, 128.4, 128.1, 126.1, 125.9, 125.4, 121.2, 120.8, 119.9, 118.1, 65.0, 64.0. Mn=22.4 kDa, PDI=1.53. T_{g}=253.8° C.

### Example PS24

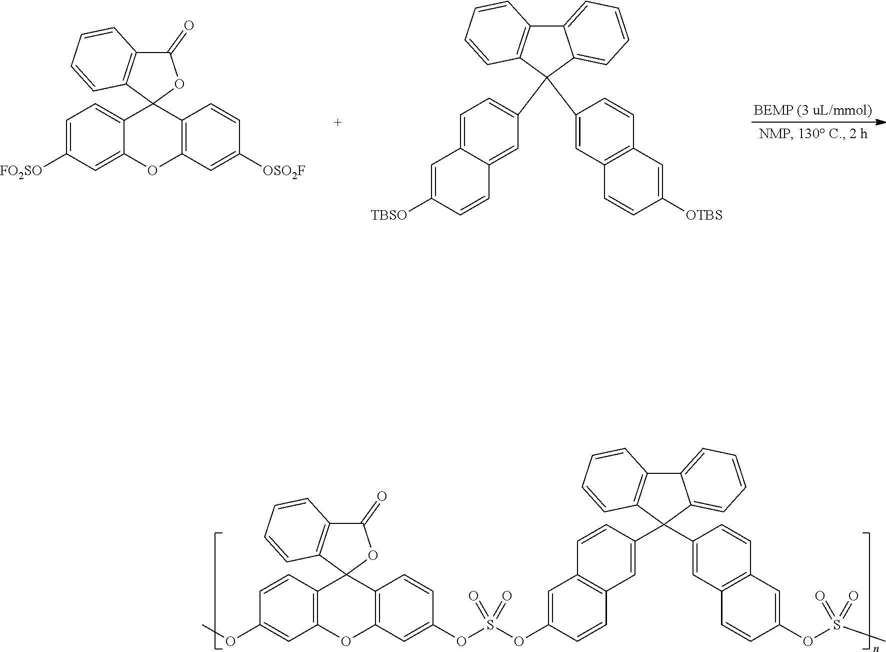

Yellow solid. mp>300° C. H NMR (600 MHz, DMSO) δ 9.05-8.59 (m, 2H), 8.15-7.97 (m, 2H), 7.92-7.65 (m, 6H), 7.41-7.04 (m, 22H), 6.44-6.17 (m, 2H). ¹³C NMR (151 MHz, DMSO) δ 154.8, 149.5, 148.5, 145.3, 145.0, 139.4, 129.5, 128.7, 128.1, 126.9, 126.7, 125.7, 125.4, 121.8, 121.4, 121.2, 120.8, 119.1, 118.8, 116.3, 64.0, 53.2. Mn=10.9 kDa, PDI=1.6. T_{g}=258.3° C.

### Example PS25

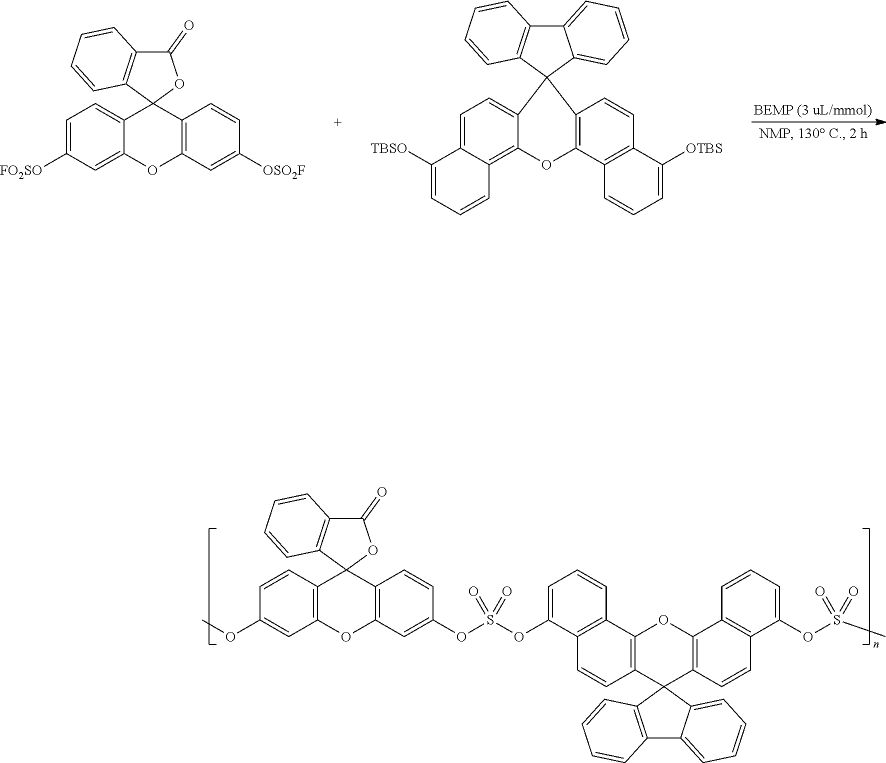

Yellow solid. mp>300° C. ¹H NMR (600 MHz, DMSO) δ 8.06-7.97 (m, 4H), 7.95-7.85 (m, 4H), 7.79-7.66 (m, 4H), 7.63-7.54 (m, 4H), 7.51-7.36 (m, 8H), 7.33-7.22 (m, 4H), 7.15-6.92 (m, 2H). ¹³C NMR (151 MHz, DMSO) δ 168.2, 152.0, 150.8, 150.6, 150.5, 149.7, 147.5, 147.4, 144.0, 144.0, 139.7, 136.1, 132.0, 131.6, 131.5, 130.9, 130.5, 128.5, 128.1, 126.2, 125.5, 125.2, 125.0, 124.2, 120.8, 119.9, 118.4, 118.2, 117.6, 110.0, 79.9, 65.0. Mn=12.7 kDa, PDI=1.77. T_{g}=>300° C.

### Example PS26

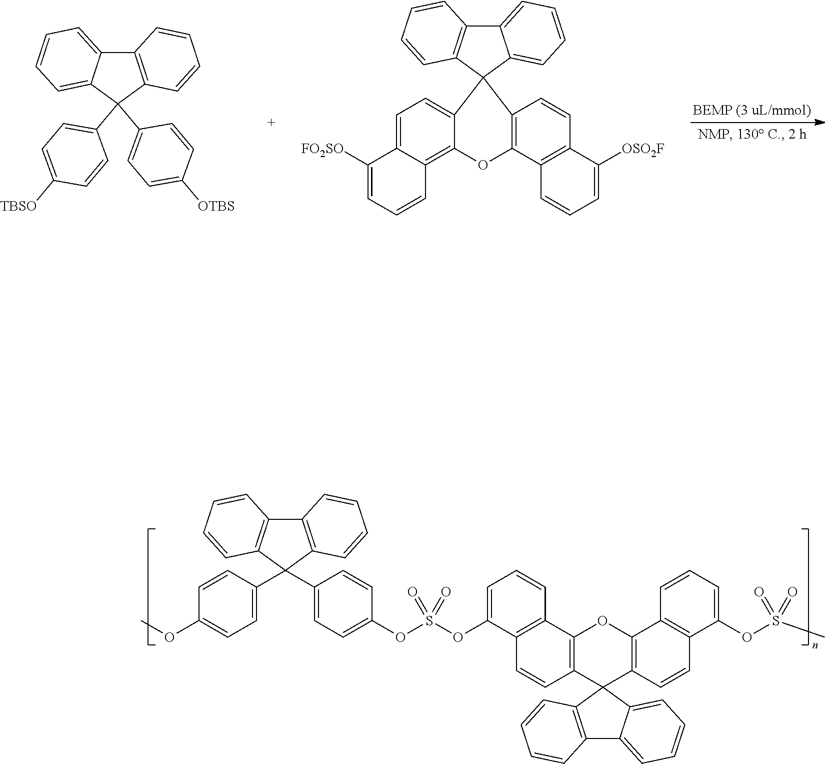

White solid. mp>300° C. H NMR (600 MHz, DMSO) δ 9.11-8.60 (m, 2H), 8.15-7.97 (m, 2H), 7.95-6.78 (m, 22H), 6.54-6.04 (m, 2H). ¹³C NMR (151 MHz, DMSO) δ 168.2, 154.8, 152.1, 150.7, 150.5, 145.4, 145.0, 139.3, 136.0, 130.8, 130.4, 128.6, 126.9, 125.7, 125.4, 125.2, 124.9, 124.0, 122.0, 120.6, 119.2, 118.9, 118.5, 116.3, 110.1, 79.8, 53.2. Mn=12.7 kDa, PDI=1.56. T_{g}=280.2° C.

### Example PS27

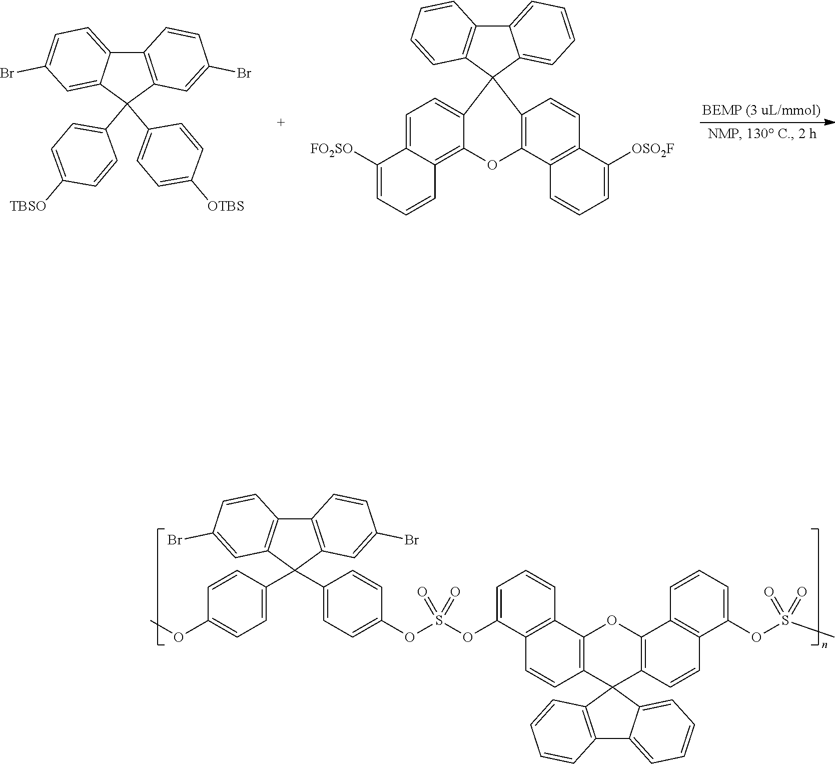

White solid. mp>300° C. ¹H NMR (600 MHz, DMSO) δ 9.15-8.56 (m, 2H), 8.09-7.96 (m, 2H), 7.93-7.69 (m, 6H), 7.63-7.53 (m, 4H), 7.44-7.19 (m, 12H), 7.17-6.96 (m, 4H), 6.45-6.20 (m, 2H). ¹³C NMR (151 MHz, DMSO) δ 155.2, 152.0, 149.3, 145.9, 145.5, 144.3, 139.8, 138.1, 132.0, 130.1, 129.1, 127.4, 126.2, 125.8, 123.6, 122.1, 121.9, 121.1, 119.2, 116.8, 64.7, 53.6. Mn=15.7 kDa, PDI=1.61. T_{g}=>300° C.

### Example PS28

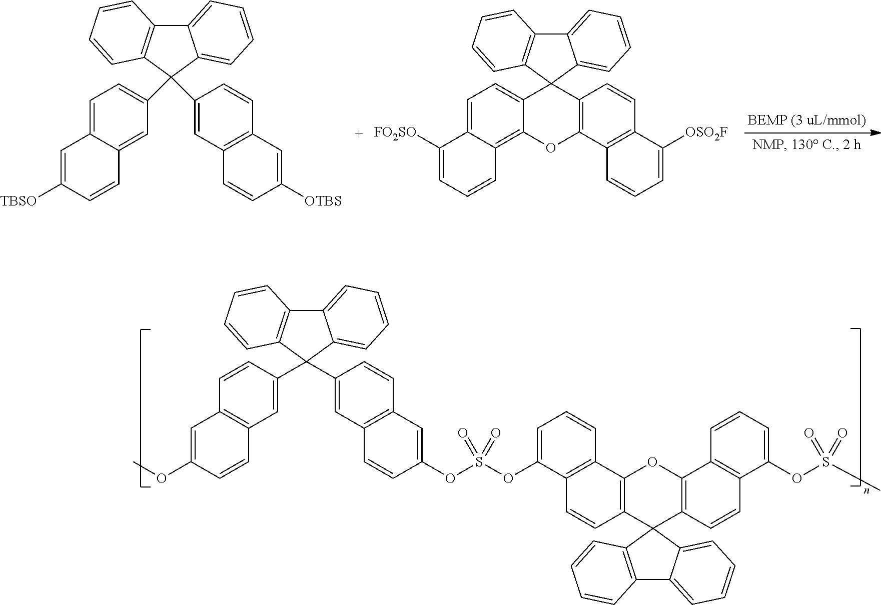

White solid. mp>300° C. ¹H NMR (600 MHz, DMSO) δ 9.01-8.76 (m, 2H), 8.12-7.96 (m, 4H), 7.96-6.69 (m, 31H), 6.46-6.23 (m, 2H). ¹³C NMR (151 MHz, DMSO) δ 154.8, 149.7, 147.3, 145.6, 145.1, 144.0, 139.7, 139.3, 131.9, 131.5, 130.8, 128.3, 128.1, 126.9, 126.1, 125.7, 125.5, 125.4, 121.8, 120.8, 120.6, 120.1, 119.2, 118.4, 116.5, 65.0, 53.2. Mn=22.2 kDa, PDI=1.73. T_{g}=>310° C.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A polymer represented by Formula (1): 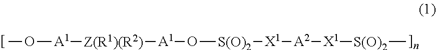
wherein:
A¹, A² and A³ independently are divalent aryl groups;
Z is C or Si (preferably C);
optionally, A² is A³-Z(R³)(R⁴)-A³;
optionally, both A¹ divalent aryl groups are bound together by a covalent bond, —CH₂—, —CH(R⁷)—, —C(R⁷)₂—, —O—, —S—, —SO₂—, —(C═O)—, —NH—, or —N(R⁷)—;
optionally, both A³ divalent aryl groups are bound together by a covalent bond, —CH₂—, —CH(R⁷)—, —C(R⁷)₂—, —O—, —S—, —SO₂—, —(C═O)—, —NH—, or —N(R⁷)—;
optionally, when Z is C, Z(R¹)(R²) and/or Z(R³)(R⁴) constitute an unsaturated moiety of formula: 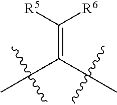
X¹ is O or a covalent bond;
R¹ is selected from the group consisting of alkyl, aryl, arylalkyl, and alkylaryl; R² is selected from the group consisting of H, halogen, alkyl, aryl, arylalkyl, and alkylaryl; or R¹ and R² together constitute a first divalent substituent which together with Z constitutes a first hydrocarbon ring or heterocyclic ring;
R³ is selected from the group consisting of alkyl, aryl, arylalkyl, and alkylaryl; R⁴ is selected from the group consisting of H, halogen, alkyl, aryl, arylalkyl, and alkylaryl; or R¹ and R⁴ together constitute a second divalent substituent which together with Z constitutes a second hydrocarbon or heterocyclic ring;
R⁵, R⁶ and R⁷ are selected from the group consisting of alkyl, aryl, arylalkyl, and alkylaryl;
n is the average number of repeating units within the brackets of the formula and has a value sufficient to provide a number average molecular weight (Mₙ) of at least about 7,000 g/mol; as determined by size exclusion chromatography (SEC) using styrene-divinyl benzene columns, DMF/0.2% LiBr elution solvent, and polystyrene molecular weight standards; and
each divalent aryl group and divalent substituent independently is unsubstituted or is substituted by one or more substituent selected from the group consisting of halogen, alkyl, aryl, arylalkyl, alkylaryl, alkoxy, and aryloxy;
excluding homopolymers of formula:

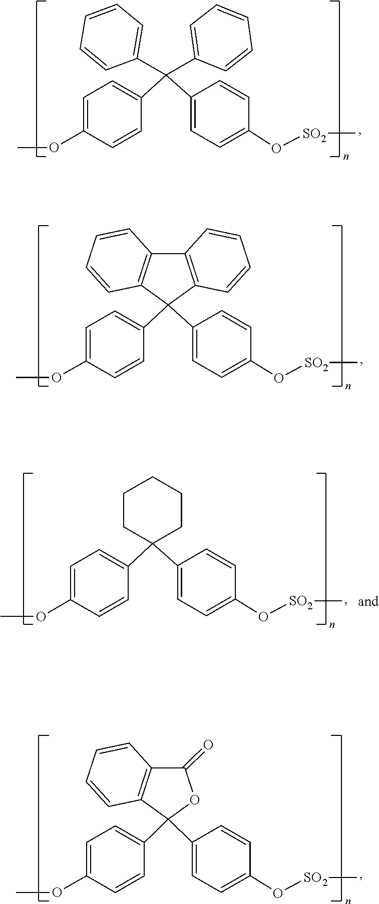

2. The polymer of claim 1, wherein n has a value sufficient to provide a number average molecular weight (Mₙ) of at least about 10,000 g/mol.

3. The polymer of claim 1, wherein n has a value sufficient to provide a number average molecular weight (Mₙ) of at least about 20,000 g/mol.

4. The polymer of claim 1, wherein n has a value sufficient to provide a number average molecular weight (Mₙ) of at least about 30,000 g/mol.

5. The polymer of claim 1, wherein n has a value sufficient to provide a number average molecular weight (Mₙ) of at least about 50,000 g/mol.

6. The polymer of claim 1, wherein n has a value sufficient to provide a number average molecular weight (Mₙ) of at least about 60,000 g/mol.

7. The polymer of claim 1, wherein n has a value sufficient to provide a number average molecular weight (Mₙ) of at least about 70,000 g/mol.

8. The polymer of claim 1, wherein n has a value sufficient to provide a number average molecular weight (Mₙ) in the range of about 7,000 g/mol to about 100,000 g/mol.

9. The polymer of claim 1, wherein n has a value sufficient to provide a number average molecular weight (Mₙ) in the range of about 10,000 g/mol to about 100,000 g/mol.

10. The polymer of claim 1, wherein n has a value sufficient to provide a number average molecular weight (Mₙ) in the range of about 15,000 g/mol to about 80,000 g/mol.

11. The polymer of claim 1, wherein n has a value sufficient to provide a number average molecular weight (Mₙ) in the range of about 20,000 g/mol to about 80,000 g/mol.

12. The polymer of any one of claims 1 to 11, wherein the first hydrocarbon or heterocyclic ring is a 5 to 12 membered hydrocarbon or heterocyclic ring.

13. The polymer of any one of claims 1 to 12, wherein the second hydrocarbon or heterocyclic ring is a 5 to 12 membered hydrocarbon or heterocyclic ring.

14. The polymer of any one of claims 1 to 13, wherein Z is C.

15. The polymer of any one of claims 1 to 14, wherein the first divalent aryl group and/or the second divalent aryl group are independently selected from the group consisting of divalent phenyl (—C₆H₄—), divalent naphthyl (—C₁₀H₆—), divalent anthracenyl (—C₁₄H₁₀—) divalent biphenyl (—C₆H₄—C₆H₄—), divalent binaphthyl (—C₁₀H₆—C₁₀H₆—), and divalent heteroaryl.

16. The polymer of any one of claims 1 to 15, wherein R¹ and R² together constitute the first divalent substituent; and the first divalent substituent together with Z constitute a 5-, 6-, or 7-membered hydrocarbon ring bearing an aromatic moiety fused to the hydrocarbon ring.

17. The polymer of any one of claims 1 to 15, wherein R¹ and R² together constitute the first divalent substituent; and the first divalent substituent together with Z constitute a 5-, 6-, or 7-membered heterocyclic ring bearing an aromatic moiety fused to the heterocyclic ring.

18. The polymer of any one of claims 1 to 17, wherein A² is A³-Z(R³)(R⁴)-A³; and R³ and R⁴ together constitute the second divalent substituent; and the second divalent substituent together with Z constitute a 5-, 6-, or 7-membered hydrocarbon ring bearing an aromatic moiety fused to the hydrocarbon ring.

19. The polymer of any one of claims 1 to 17, wherein A² is A³-Z(R³)(R⁴)-A³; and R³ and R⁴ together constitute the second divalent substituent; and the second divalent substituent together with Z constitute a 5-, 6-, or 7-membered heterocyclic ring bearing an aromatic moiety fused to the heterocyclic ring.

20. The polymer of any one of claims 1 to 19, wherein the first divalent ligand together with Z constitutes a cyclic group selected from the group consisting of an anthrone group, a 2,3-benzofluorene group, a chroman group, a 2-coumarone group, a 4,5-diazafluorene group, a dibenzosuberane group, a dibenzosuberene group, a 9,10-dihydroanthracene group, a 2,7-dihydro-3,4-benzofuran group, a 9,10-dihydro-9,10-difluoroanthracene group, a 2,3-dihydrobenzofuran group, a 9,10-dihydrophenanthrene group, a fluorene group, an indan group, an indene group, a 3-isochromanone group, a phthalide group, a thioxanthene group, and a xanthene group.

21. The polymer of any one of claims 1 to 20, wherein the second divalent ligand together with Z constitutes a cyclic group selected from the group consisting of an anthrone group, a 2,3-benzofluorene group, a chroman group, a 2-coumarone group, a 4,5-diazafluorene group, a dibenzosuberane group, a dibenzosuberene group, a 9,10-dihydroanthracene group, a 2,7-dihydro-3,4-benzofuran group, a 9,10-dihydro-9,10-difluoroanthracene group, a 2,3-dihydrobenzofuran group, a 9,10-dihydrophenanthrene group, a fluorene group, an indan group, an indene group, a 3-isochromanone group, a phthalide group, a thioxanthene group, and a xanthene group.

22. The polymer of any one of claims 1 to 21, wherein the first divalent aryl group and the second divalent aryl group both are 1,4-divalent phenyl groups.

23. The polymer of any one of claims 1 to 22, wherein X¹ is O, and the polymer is a polysulfate polymer.

24. The polymer of any one of claims 1 to 21, wherein X is a covalent bond, and the polymer is a polysulfonate polymer.

25. The polymer of any one of claims 1 to 21, wherein both A¹ divalent aryl groups are bound together by a covalent bond, —CH₂—, —CH(R⁷)—, —C(R⁷)₂—, —O—, —S—, —SO₂—, —(C═O)—, —NH—, or —N(R⁷)—.

26. The polymer of any one of claims 1 to 21, wherein A² is A³-Z(R³)(R⁴)-A³; and
both A³ divalent aryl groups are bound together by a covalent bond, —CH₂—, —CH(R⁷)—, —C(R⁷)₂—, —O—, —S—, —SO₂—, —(C═O)—, —NH—, or —N(R⁷)—.

27. The polymer of any one of claims 1 to 21, wherein Z is C; and Z(R¹)(R²) and/or Z(R³)(R⁴) constitute an unsaturated moiety of formula:

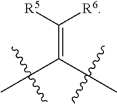

28. The polymer of claim 1, wherein the polymer is selected from the group consisting of:

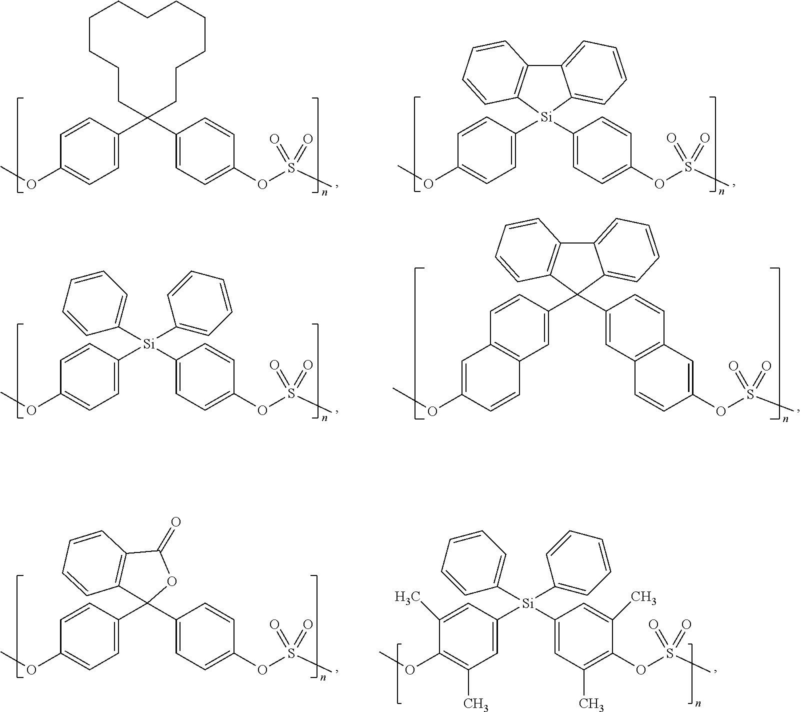

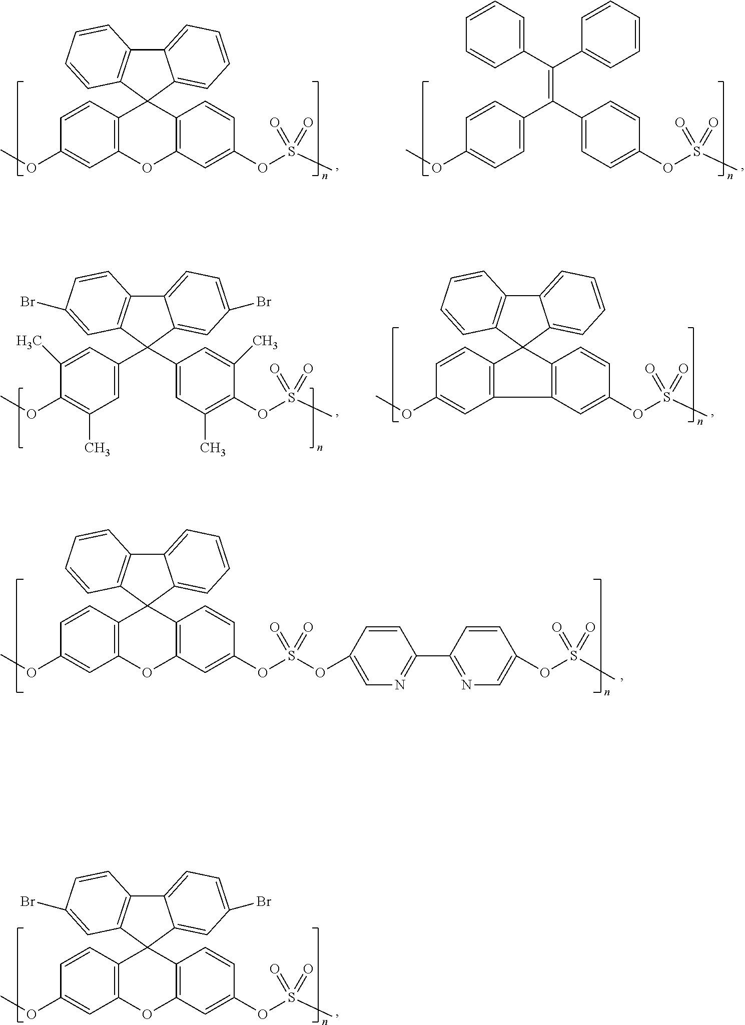

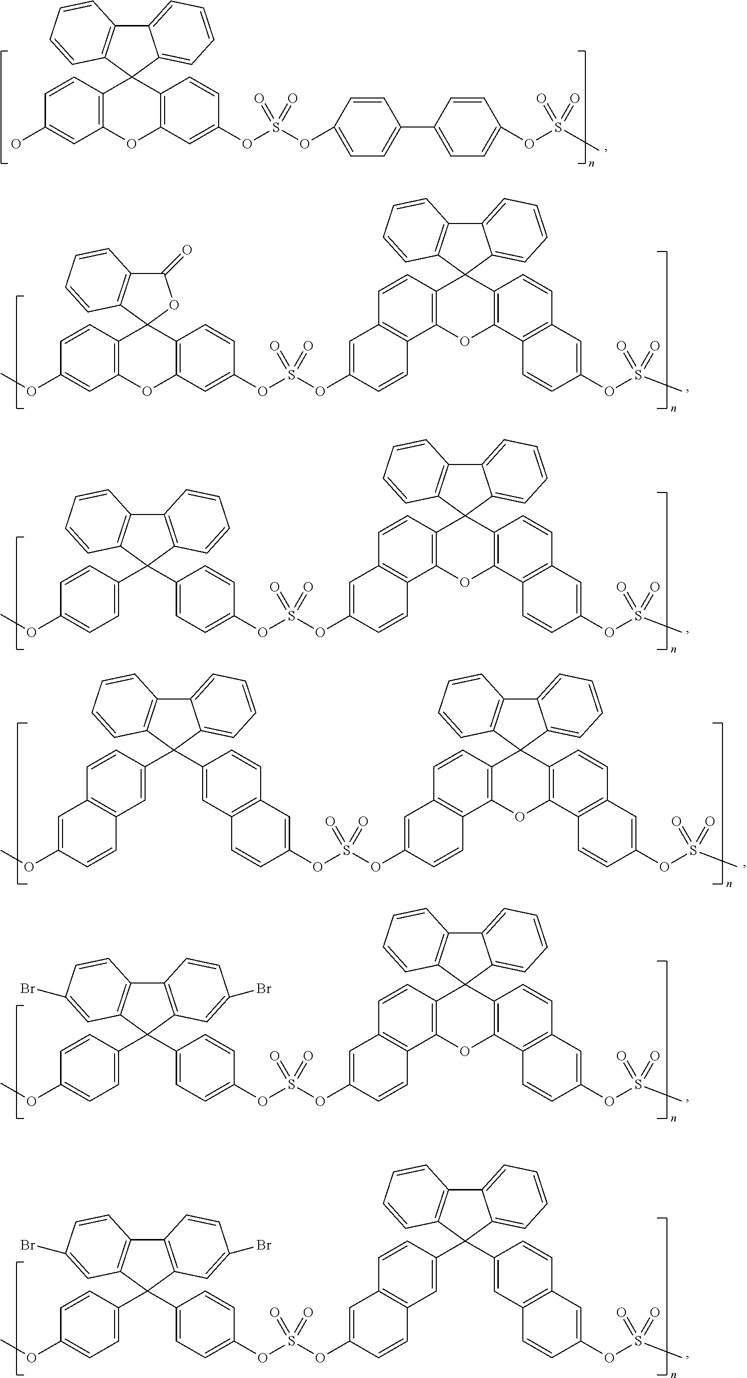

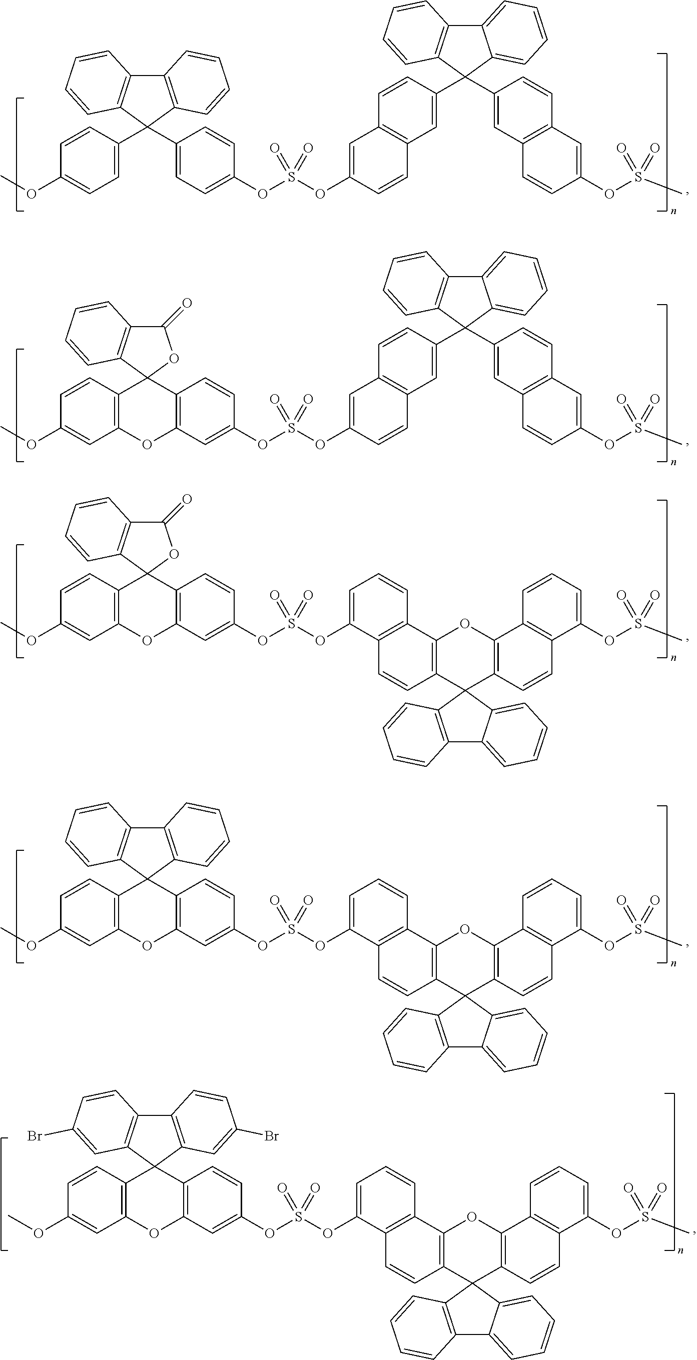

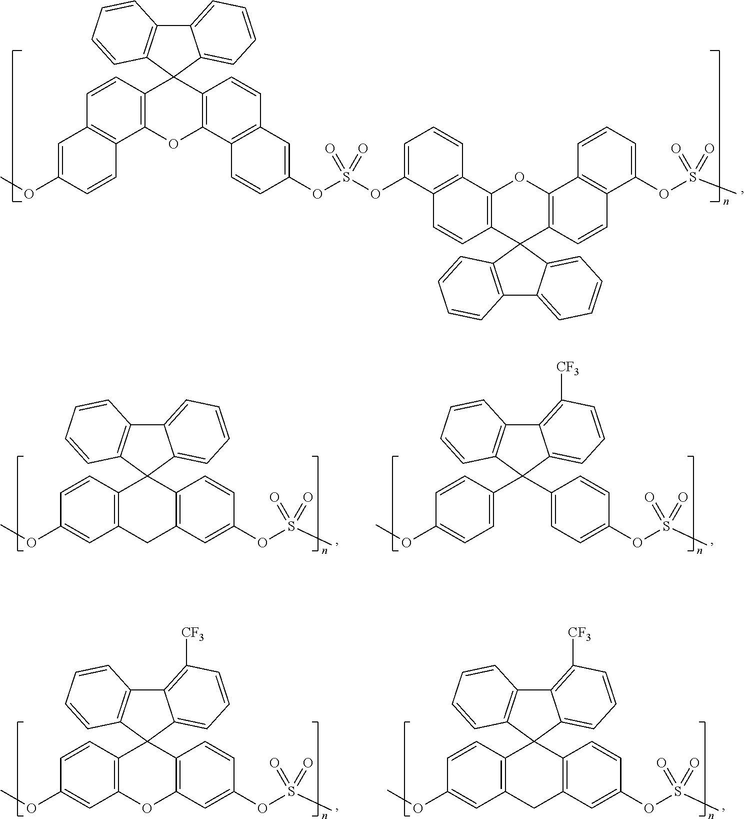

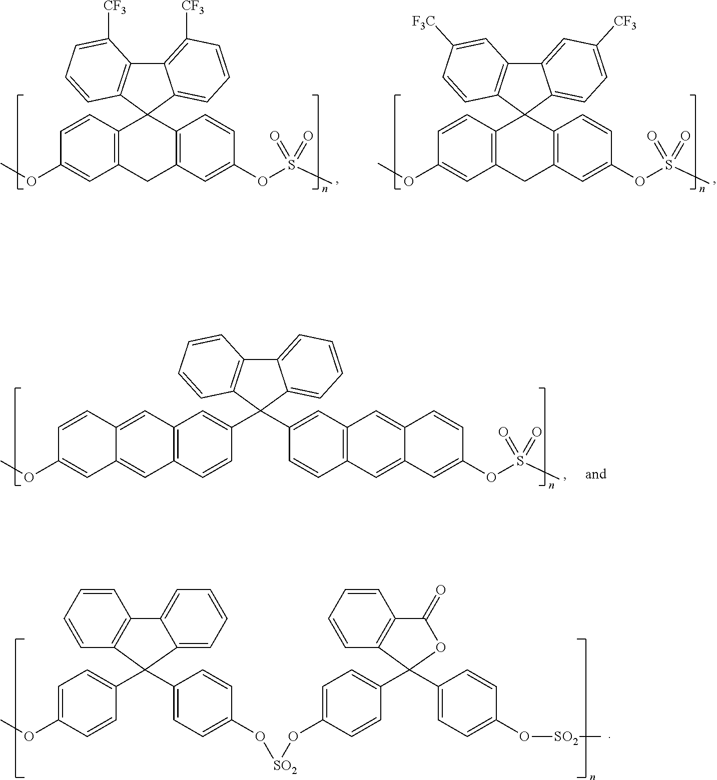

29. The polymer of any one of claims 1 to 28, wherein the polymer has a glass transition temperature (T_{g}) in the range of about 140 to about 330° C.

30. The polymer of any one of claims 1 to 29, wherein the polymer has a glass transition temperature (T_{g}) in the range of about 190 to about 320° C.

31. The polymer of any one of claims 1 to 30, wherein the polymer has a glass transition temperature (T_{g}) of greater than 150° C., and an optical bandgap (E_{g}) of about 3.5 to 4.5 eV.

32. The polymer of any one of claims 1 to 31, wherein the polymer has a polydispersity index (PDI) of about 2.5 or less.

33. The polymer of any one of claims 1 to 32, wherein the polymer has a polydispersity index (PDI) of about 2.2 or less.

34. The polymer of any one of claims 1 to 33, wherein the polymer has a polydispersity index (PDI) of about 2 or less.

35. The polymer of any one of claims 1 to 34, wherein the polymer has a polydispersity index (PDI) of about 1.8 or less.

36. A polymer film free from residual metal catalysts, which comprises a polymer of any one of claims 1 to 35.

37. The polymer film of claim 36, wherein the film has a thickness in the range of about 1 to about 15 μm.
